(19) United States
(12) Patent Application Publication
(10) Pub. No.: US 2019/0222404 A1
(43) Pub. Date: Jul. 18, 2019

(54) SIGNALING TECHNIQUES FOR BANDWIDTH PARTS

(71) Applicant: QUALCOMM Incorporated, San Diego, CA (US)

(72) Inventors: Peter Pui Lok Ang, San Diego, CA (US); Wanshi Chen, San Diego, CA (US); Peter Gaal, San Diego, CA (US); Tao Luo, San Diego, CA (US); Heechoon Lee, San Diego, CA (US); Jing Sun, San Diego, CA (US); Xiao Feng Wang, San Diego, CA (US)

(21) Appl. No.: 16/239,412

(22) Filed: Jan. 3, 2019

Related U.S. Application Data
(60) Provisional application No. 62/657,557, filed on Apr. 13, 2018.
(60) Provisional application No. 62/653,492, filed on Apr. 5, 2018.
(60) Provisional application No. 62/617,168, filed on Jan. 12, 2018.

(51) Int. Cl. H04L 5/00; H04W 72/04

(52) U.S. Cl. CPC H04L 5/0098; H04W 72/0453; H04L 5/0041; H04L 5/0048

(57) ABSTRACT

Techniques are described herein for scheduling communication resources of a bandwidth part (BWP) after a BWP switching event when the frequency range of an active BWP is different than the frequency range of a target BWP. A user equipment (UE) may interpret the resource allocation field in scheduling downlink control information (DCI) that triggers a BWP switching event based on the active BWP. The UE and a base station may be configured to communicate using at least a portion of the resources of the active BWP in the first transmission opportunity after the BWP switching event. In subsequent transmitting opportunities where a scheduling DCI for the target BWP is received by the UE, the UE may interpret the resource allocation field of the new DCI as being based on the target BWP.

### CROSS REFERENCES

The present Application for patent claims the benefit of U.S. Provisional Patent Application No. 62/617,168 by ANG, et al., entitled “SIGNALING TECHNIQUES FOR BANDWIDTH PARTS,” filed Jan. 12, 2018, and to U.S. Provisional Patent Application No. 62/653,492 by ANG, et al., entitled “SIGNALING TECHNIQUES FOR BANDWIDTH PARTS” filed Apr. 5, 2018, and to U.S. Provisional Patent Application No. 62/657,557 by ANG, et al., entitled “SIGNALING TECHNIQUES FOR BANDWIDTH PARTS” filed Apr. 13, 2018, assigned to the assignee hereof, and expressly incorporated by reference herein in their entireties.

### INTRODUCTION

The following relates generally to wireless communication, and more specifically to signaling techniques for bandwidth parts.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

In some wireless communications systems, the size of downlink control information (DCI) may be based on the size of the associated bandwidth part (BWP). Different signaling techniques may be used based on the varying sizes of the DCI.

### SUMMARY

The described techniques relate to improved methods, systems, devices, or apparatuses that support signaling techniques for bandwidth parts. Generally, the described techniques provide for scheduling communication resources (e.g., resource blocks) of a BWP after a BWP switching event when the frequency range of an active BWP is different than the frequency range of a target BWP. A UE may interpret a resource allocation field (e.g., frequency-domain resource allocation field, etc.) in a scheduling DCI that triggers a BWP switching event based on the active BWP. In such cases, the UE and a base station may be configured to communicate using at least a portion of the resources (e.g., resource blocks) of the active BWP in the first transmission opportunity (e.g., first slot) after the BWP switching event. In subsequent transmitting opportunities where a scheduling DCI for the target BWP is received by the UE, the UE may be configured to behave normally.

In addition, the described techniques provide for using a fallback DCI associated with a reference BWP to maintain or recover the link with the base station when the UE cannot successfully decode the non-fallback DCI. The base station may be configured to generate the non-fallback DCI associated with the active BWP and the fallback DCI associated with the reference BWP. The base station may transmit the non-fallback DCI and the fallback DCI to the UE. While communicating with the base station, the UE may monitor for both the non-fallback DCI and the fallback DCI.

A method of wireless communication at a user equipment (UE) is described. The method may include receiving downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, identifying a BWP switching event that causes the UE to change from the active BWP to a target BWP of the carrier based at least in part on information included in the BWP identifier field, identifying communication resources common to both the active BWP and the target BWP of the carrier based at least in part on information in the resource allocation field, and communicating with a base station using a portion of communication resources of the target BWP of the carrier included in the resource allocation field, where the portion of communication resources includes the communication resources common to both the active BWP and the target BWP of the carrier.

An apparatus for wireless communication at a user equipment (UE) is described. The apparatus may include means for receiving downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, means for identifying a BWP switching event that causes the UE to change from the active BWP to a target BWP of the carrier based at least in part on information included in the BWP identifier field, means for identifying communication resources common to both the active BWP and the target BWP of the carrier based at least in part on information in the resource allocation field, and means for communicating with a base station using a portion of communication resources of the target BWP of the carrier included in the resource allocation field, where the portion of communication resources includes the communication resources common to both the active BWP and the target BWP of the carrier.

Another apparatus for wireless communication at a user equipment (UE) is described. The apparatus may include a processor, memory in electronic communication with the processor, and instructions stored in the memory. The instructions may be operable to cause the processor to receive downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, identify a BWP switching event that causes the UE to change from the active BWP to a target BWP of the carrier based at least in part on information included in the BWP identifier field, identify communication resources common to both the active BWP and the target BWP of the carrier based at least in part on information in the resource allocation field, and communicate with a base station using a portion of communication resources of the target BWP of the carrier included in the resource allocation field, where the portion of communication resources includes the communication resources common to both the active BWP and the target BWP of the carrier.

A non-transitory computer-readable medium for wireless communication at a user equipment (UE) is described. The non-transitory computer-readable medium may include instructions operable to cause a processor to receive downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, identify a BWP switching event that causes the UE to change from the active BWP to a target BWP of the carrier based at least in part on information included in the BWP identifier field, identify communication resources common to both the active BWP and the target BWP of the carrier based at least in part on information in the resource allocation field, and communicate with a base station using a portion of communication resources of the target BWP of the carrier included in the resource allocation field, where the portion of communication resources includes the communication resources common to both the active BWP and the target BWP of the carrier.

Some examples of the method, apparatus, and non-transitory computer-readable medium described above may further include processes, features, means, or instructions for determining that the BWP identifier field of the DCI identifies a BWP different than the active BWP of the carrier being used by the UE to communicate, where identifying the BWP switching event may be based at least in part on determining that the BWP identifier field of the DCI identifies the BWP different than the active BWP of the carrier.

Some examples of the method, apparatus, and non-transitory computer-readable medium described above may further include processes, features, means, or instructions for determining that a first frequency range of the active BWP of the carrier at least partially overlaps with a second frequency range of the target BWP of the carrier, where identifying the communication resources common to both the active BWP of the carrier and the target BWP of the carrier may be based at least in part on determining that the first frequency range of the active BWP of the carrier at least partially overlaps with the second frequency range of the target BWP of the carrier.

In some examples of the method, apparatus, and non-transitory computer-readable medium described above, the second frequency range of the target BWP of the carrier may be wider than the first frequency range of the active BWP of the carrier.

In some examples of the method, apparatus, and non-transitory computer-readable medium described above, the first frequency range of the active BWP of the carrier may be nested within the second frequency range of the target BWP of the carrier.

Some examples of the method, apparatus, and non-transitory computer-readable medium described above may further include processes, features, means, or instructions for mapping communication resources included in the resource allocation field for the active BWP of the carrier to communication resources for the target BWP of the carrier, where identifying the communication resources common to both the active BWP of the carrier and the target BWP of the carrier may be based at least in part on mapping the communication resources included in the resource allocation field for the active BWP of the carrier to communication resources for the target BWP of the carrier.

In some examples of the method, apparatus, and non-transitory computer-readable medium described above, the length of the resource allocation field for the active BWP of the carrier may be smaller than a second length of a second resource allocation field for the target BWP of the carrier.

In some examples of the method, apparatus, and non-transitory computer-readable medium described above, the length of the resource allocation field for the active BWP of the carrier may be insufficient to allocate all of the communication resources available in the target BWP of the carrier.

Some examples of the method, apparatus, and non-transitory computer-readable medium described above may further include processes, features, means, or instructions for determining that a first frequency range of the active BWP of the carrier does not overlap with a second frequency range of the target BWP of the carrier. Some examples of the method, apparatus, and non-transitory computer-readable medium described above may further include processes, features, means, or instructions for refraining from transmitting or receiving signals using the communication resources of the DCI based at least in part on determining that the first frequency range of the active BWP of the carrier does not overlap with the second frequency range of the target BWP of the carrier.

Some examples of the method, apparatus, and non-transitory computer-readable medium described above may further include processes, features, means, or instructions for receiving a second DCI that allocates resources for the UE using the target BWP of the carrier based at least in part on communicating with the base station using the portion of the communication resources of the target BWP of the carrier, the second DCI including a second resource allocation field having a second length that may be based at least in part on a size of the target BWP of the carrier being used by the UE, the second length being greater than the length of the resource allocation field in the DCI. Some examples of the method, apparatus, and non-transitory computer-readable medium described above may further include processes, features, means, or instructions for communicating with the base station using all communication resources of the target BWP of the carrier included in the resource allocation field of the second DCI.

In some examples of the method, apparatus, and non-transitory computer-readable medium described above, the DCI may be a non-fallback DCI.

Some examples of the method, apparatus, and non-transitory computer-readable medium described above may further include processes, features, means, or instructions for determining that resources of the target BWP may be nested with resources of the active BWP, where identifying the communication resources common to both the active BWP and the target BWP of the carrier may be based at least in part on determining that the resources of the target BWP may be nested with the resources of the active BWP.

Some examples of the method, apparatus, and non-transitory computer-readable medium described above may further include processes, features, means, or instructions for determining that a first frequency range of the target BWP overlaps entirely with a second frequency range of the target BWP or the second frequency range of the target BWP overlaps entirely with the first frequency range of the active BWP, where determining that the resources are nested is based at least in part on determining that one frequency range overlaps entirely with another frequency range.

Some examples of the method, apparatus, and non-transitory computer-readable medium described above may further include processes, features, means, or instructions for mapping the resources of the active BWP to the resources of the target BWP based at least in part on determining that the resources of the target BWP may be nested with the resources of the active BWP, where identifying the communication resources common to both the active BWP and the target BWP may be based at least in part on mapping the resources.

In some examples of the method, apparatus, and non-transitory computer-readable medium described above, the received DCI that allocates communication resources to the UE allocates the communication resources on a resource block group (RBG)-by-RBG basis such that a single bit in the DCI indicates that more than one resource block (RB) is allocated for a BWP.

A method of wireless communication at a base station is described. The method may include identifying a target bandwidth part (BWP) of a carrier to be used to communicate with a user equipment (UE) different from an active BWP of the carrier being used to communicate with the UE, generating downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, transmitting the DCI to the UE, and communicating with the UE using a portion of communication resources of the target BWP of the carrier included in the resource allocation field, where the portion of communication resources includes communication resources common to both the active BWP of the carrier and the target BWP of the carrier.

An apparatus for wireless communication at a base station is described. The apparatus may include means for identifying a target bandwidth part (BWP) of a carrier to be used to communicate with a user equipment (UE) different from an active BWP of the carrier being used to communicate with the UE, means for generating downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, means for transmitting the DCI to the UE, and means for communicating with the UE using a portion of communication resources of the target BWP of the carrier included in the resource allocation field, where the portion of communication resources includes communication resources common to both the active BWP of the carrier and the target BWP of the carrier.

Another apparatus for wireless communication at a base station is described. The apparatus may include a processor, memory in electronic communication with the processor, and instructions stored in the memory. The instructions may be operable to cause the processor to identify a target bandwidth part (BWP) of a carrier to be used to communicate with a user equipment (UE) different from an active BWP of the carrier being used to communicate with the UE, generate downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, transmit the DCI to the UE, and communicate with the UE using a portion of communication resources of the target BWP of the carrier included in the resource allocation field, wherein the portion of communication resources includes communication resources common to both the active BWP of the carrier and the target BWP of the carrier.

A non-transitory computer-readable medium for wireless communication at a base station is described. The non-transitory computer-readable medium may include instructions operable to cause a processor to identify a target bandwidth part (BWP) of a carrier to be used to communicate with a user equipment (UE) different from an active BWP of the carrier being used to communicate with the UE, generate downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, transmit the DCI to the UE, and communicate with the UE using a portion of communication resources of the target BWP of the carrier included in the resource allocation field, where the portion of communication resources includes communication resources common to both the active BWP of the carrier and the target BWP of the carrier.

Some examples of the method, apparatus, and non-transitory computer-readable medium described above may further include processes, features, means, or instructions for mapping communication resources of the target BWP of the carrier allocated to the UE in the resource allocation field to communication resources of the active BWP of the carrier, where generating the DCI may be based at least in part on may be based at least in part on mapping the communication resources of the target BWP of the carrier allocated to the UE in the resource allocation field to communication resources of the active BWP of the carrier.

Some examples of the method, apparatus, and non-transitory computer-readable medium described above may further include processes, features, means, or instructions for determining that a first frequency range of the active BWP of the carrier at least partially overlaps with a second frequency range of the target BWP of the carrier, where generating the DCI may be based at least in part on determining that the first frequency range of the active BWP of the carrier at least partially overlaps with the second frequency range of the target BWP of the carrier.

In some examples of the method, apparatus, and non-transitory computer-readable medium described above, the second frequency range of the target BWP of the carrier may be wider than the first frequency range of the active BWP of the carrier.

In some examples of the method, apparatus, and non-transitory computer-readable medium described above, the first frequency range of the active BWP of the carrier may be nested within the second frequency range of the target BWP of the carrier.

In some examples of the method, apparatus, and non-transitory computer-readable medium described above, the length of the resource allocation field for the active BWP of the carrier may be smaller than a second length of a second resource allocation field for the target BWP of the carrier.

In some examples of the method, apparatus, and non-transitory computer-readable medium described above, the length of the resource allocation field for the active BWP of the carrier may be insufficient to allocate all of the communication resources available in the target BWP of the carrier.

Some examples of the method, apparatus, and non-transitory computer-readable medium described above may further include processes, features, means, or instructions for determining that a first frequency range of the active BWP of the carrier does not overlap with a second frequency range of the target BWP of the carrier. Some examples of the method, apparatus, and non-transitory computer-readable medium described above may further include processes, features, means, or instructions for populating the resource allocation field with a zero assignment based at least in part on determining that the first frequency range of the active BWP of the carrier does not overlap with the second frequency range of the target BWP of the carrier.

In some examples of the method, apparatus, and non-transitory computer-readable medium described above, the DCI may be a non-fallback DCI.

Some examples of the method, apparatus, and non-transitory computer-readable medium described above may further include processes, features, means, or instructions for identifying communication resources common to both the active BWP and the target BWP. Some examples of the method, apparatus, and non-transitory computer-readable medium described above may further include processes, features, means, or instructions for positioning a physical resource block allocation (PRB) associated with the target BWP within the identified communication resources common to both the active BWP and the target BWP.

Some examples of the method, apparatus, and non-transitory computer-readable medium described above may further include processes, features, means, or instructions for determining that resources of the target BWP may be nested with resources of the active BWP, where identifying the communication resources common to both the active BWP and the target BWP of the carrier may be based at least in part on determining that the resources of the target BWP may be nested with the resources of the active BWP.

Some examples of the method, apparatus, and non-transitory computer-readable medium described above may further include processes, features, means, or instructions for determining that a first frequency range of the target BWP overlaps entirely with a second frequency range of the target BWP or the second frequency range of the target BWP overlaps entirely with the first frequency range of the active BWP, where determining that the resources are nested is based at least in part on determining that one frequency range overlaps entirely with another frequency range.

Some examples of the method, apparatus, and non-transitory computer-readable medium described above may further include processes, features, means, or instructions for mapping the resources of the active BWP to the resources of the target BWP based at least in part on determining that the resources of the target BWP may be nested with the resources of the active BWP, where identifying the communication resources common to both the active BWP and the target BWP may be based at least in part on mapping the resources.

Some examples of the method, apparatus, and non-transitory computer-readable medium described above may further include processes, features, means, or instructions for allocating the communication resources to the target BWP of the UE on a resource block group (RBG)-by-RBG basis, where the a single bit in the DCI indicates that more than one resource block (RB) is allocated for the target BWP.

A method of wireless communication at a user equipment (UE) is described. The method may include monitoring for non-fallback downlink control information (DCI) and fallback DCI for an active bandwidth part (BWP) of a carrier, a length of the fallback DCI being based at least in part on a size of a reference BWP different than the active BWP of the carrier, determining the active BWP of the carrier of the UE is out-of-sync with a base station, identifying communication resources indicated in the fallback DCI based at least in part on determining the active BWP of the carrier of the UE is out-of-sync with the base station, and communicating with the base station using the communication resources indicated in the fallback DCI.

An apparatus for wireless communication at a user equipment (UE) is described. The apparatus may include means for monitoring for non-fallback downlink control information (DCI) and fallback DCI for an active bandwidth part (BWP) of a carrier, a length of the fallback DCI being based at least in part on a size of a reference BWP different than the active BWP of the carrier, means for determining the active BWP of the carrier of the UE is out-of-sync with a base station, means for identifying communication resources indicated in the fallback DCI based at least in part on determining the active BWP of the carrier of the UE is out-of-sync with the base station, and means for communicating with the base station using the communication resources indicated in the fallback DCI.

Another apparatus for wireless communication at a user equipment (UE) is described. The apparatus may include a processor, memory in electronic communication with the processor, and instructions stored in the memory. The instructions may be operable to cause the processor to monitor for non-fallback downlink control information (DCI) and fallback DCI for an active bandwidth part (BWP) of a carrier, a length of the fallback DCI being based at least in part on a size of a reference BWP different than the active BWP of the carrier, determine the active BWP of the carrier of the UE is out-of-sync with a base station, identify communication resources indicated in the fallback DCI based at least in part on determining the active BWP of the carrier of the UE is out-of-sync with the base station, and communicate with the base station using the communication resources indicated in the fallback DCI.

A non-transitory computer-readable medium for wireless communication at a user equipment (UE) is described. The non-transitory computer-readable medium may include instructions operable to cause a processor to monitor for non-fallback downlink control information (DCI) and fallback DCI for an active bandwidth part (BWP) of a carrier, a length of the fallback DCI being based at least in part on a size of a reference BWP different than the active BWP of the carrier, determine the active BWP of the carrier of the UE is out-of-sync with a base station, identify communication resources indicated in the fallback DCI based at least in part on determining the active BWP of the carrier of the UE is out-of-sync with the base station, and communicate with the base station using the communication resources indicated in the fallback DCI.

Some examples of the method, apparatus, and non-transitory computer-readable medium described above may further include processes, features, means, or instructions for determining that the non-fallback DCI failed to be successfully decoded, where determining the active BWP of the carrier of the UE may be out-of-sync with the base station may be based at least in part on determining that the non-fallback DCI failed to be successfully decoded.

Some examples of the method, apparatus, and non-transitory computer-readable medium described above may further include processes, features, means, or instructions for identifying that a control search space (CS S) of the active BWP of the carrier may be identical to a CSS of the reference BWP, where identifying the communication resources indicated in the fallback DCI may be based at least in part on identifying that the CSS of the active BWP of the carrier may be identical to the CSS of the reference BWP. The control search space (CSS) may include communication resources where the UE is configured to look for physical downlink control channel (PDCCH) which carries downlink control information (DCI) as its payload.

Some examples of the method, apparatus, and non-transitory computer-readable medium described above may further include processes, features, means, or instructions for determining that a first frequency range of the reference BWP may be a subset of a second frequency range of the active BWP of the carrier, where identifying the communication resources indicated in the fallback DCI may be based at least in part on determining that the first frequency range of the reference BWP may be the subset of the second frequency range of the active BWP of the carrier.

In some examples of the method, apparatus, and non-transitory computer-readable medium described above, the length of the fallback DCI may be independent of a size of the active BWP of the carrier.

Some examples of the method, apparatus, and non-transitory computer-readable medium described above may further include processes, features, means, or instructions for receiving information from the base station to dynamically configure the reference BWP.

In some examples of the method, apparatus, and non-transitory computer-readable medium described above, the reference BWP may be statically preconfigured.

A method of wireless communication at a base station is described. The method may include generating non-fallback downlink control information (DCI) for an active bandwidth part (BWP) of a carrier, a length of the non-fallback DCI being based at least in part on a size of the active BWP of the carrier, generating fallback DCI for a reference BWP, a length of the fallback DCI being based at least in part on a size of a reference BWP different than the active BWP of the carrier, transmitting the non-fallback DCI and the fallback DCI to a user equipment (UE), and communicating with the UE using the communication resources indicated in the fallback DCI.

An apparatus for wireless communication at a base station is described. The apparatus may include means for generating non-fallback downlink control information (DCI) for an active bandwidth part (BWP) of a carrier, a length of the non-fallback DCI being based at least in part on a size of the active BWP of the carrier, means for generating fallback DCI for a reference BWP, a length of the fallback DCI being based at least in part on a size of a reference BWP different than the active BWP of the carrier, means for transmitting the non-fallback DCI and the fallback DCI to a user equipment (UE), and means for communicating with the UE using the communication resources indicated in the fallback DCI.

Another apparatus for wireless communication at a base station is described. The apparatus may include a processor, memory in electronic communication with the processor, and instructions stored in the memory. The instructions may be operable to cause the processor to generate non-fallback downlink control information (DCI) for an active bandwidth part (BWP) of a carrier, a length of the non-fallback DCI being based at least in part on a size of the active BWP of the carrier, generate fallback DCI for a reference BWP, a length of the fallback DCI being based at least in part on a size of a reference BWP different than the active BWP of the carrier, transmit the non-fallback DCI and the fallback DCI to a user equipment (UE), and communicate with the UE using the communication resources indicated in the fallback DCI.

A non-transitory computer-readable medium for wireless communication at a base station is described. The non-transitory computer-readable medium may include instructions operable to cause a processor to generate non-fallback downlink control information (DCI) for an active bandwidth part (BWP) of a carrier, a length of the non-fallback DCI being based at least in part on a size of the active BWP of the carrier, generate fallback DCI for a reference BWP, a length of the fallback DCI being based at least in part on a size of a reference BWP different than the active BWP of the carrier, transmit the non-fallback DCI and the fallback DCI to a user equipment (UE), and communicate with the UE using the communication resources indicated in the fallback DCI.

Some examples of the method, apparatus, and non-transitory computer-readable medium described above may further include processes, features, means, or instructions for determining that the non-fallback DCI failed to be successfully decoded by the UE based at least in part on communicating with the UE using the communication resources indicated in the fallback DCI.

Some examples of the method, apparatus, and non-transitory computer-readable medium described above may further include processes, features, means, or instructions for identifying that a control search space (CS S) of the active BWP of the carrier may be identical to a CSS of the reference BWP, where generating the fallback DCI may be based at least in part on identifying that the CSS of the active BWP of the carrier may be identical to the CSS of the reference BWP.

Some examples of the method, apparatus, and non-transitory computer-readable medium described above may further include processes, features, means, or instructions for determining that a first frequency range of the reference BWP may be a subset of a second frequency range of the active BWP of the carrier, where generating the fallback DCI may be based at least in part on determining that the first frequency range of the reference BWP may be the subset of the second frequency range of the active BWP of the carrier.

Some examples of the method, apparatus, and non-transitory computer-readable medium described above may further include processes, features, means, or instructions for requesting that the UE inform the base station what may be the active BWP of the carrier being used by the UE based at least in part on communicating with the UE using the communication resources indicated in the fallback DCI. Some examples of the method, apparatus, and non-transitory computer-readable medium described above may further include processes, features, means, or instructions for modifying the active BWP of the carrier of the base station based at least in part on the active BWP of the carrier of the UE.

Some examples of the method, apparatus, and non-transitory computer-readable medium described above may further include processes, features, means, or instructions for allowing a timer associated with the active BWP of the carrier to expire while communicating with the UE using the communication resources indicated in the fallback DCI. Some examples of the method, apparatus, and non-transitory computer-readable medium described above may further include processes, features, means, or instructions for establishing a new BWP with the UE based at least in part on the timer expiring.

In some examples of the method, apparatus, and non-transitory computer-readable medium described above, the length of the fallback DCI may be independent of the size of the active BWP of the carrier.

Some examples of the method, apparatus, and non-transitory computer-readable medium described above may further include processes, features, means, or instructions for identifying the reference BWP. Some examples of the method, apparatus, and non-transitory computer-readable medium described above may further include processes, features, means, or instructions for transmitting information to the UE to dynamically configure the reference BWP.

In some examples of the method, apparatus, and non-transitory computer-readable medium described above, the reference BWP may be statically preconfigured.

A method of wireless communication is described. The method may include receiving downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, identifying a BWP switching event that causes the UE to change from the active BWP to a target BWP of the carrier based at least in part on information included in the BWP identifier field, determining that resources of the target BWP are non-nested with resources of the active BWP based at least in part on identifying the BWP switching event, identifying communication resources of the target BWP associated with a physical resource block (PRB) allocation in the active BWP based at least in part on determining that the resources of the target BWP are non-nested with the resources of the active BWP, and communicating with a base station using the identified communication resources of the target BWP.

An apparatus for wireless communication is described. The apparatus may include means for receiving downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, means for identifying a BWP switching event that causes the UE to change from the active BWP to a target BWP of the carrier based at least in part on information included in the BWP identifier field, means for determining that resources of the target BWP are non-nested with resources of the active BWP based at least in part on identifying the BWP switching event, means for identifying communication resources of the target BWP associated with a physical resource block (PRB) allocation in the active BWP based at least in part on determining that the resources of the target BWP are non-nested with the resources of the active BWP, and means for communicating with a base station using the identified communication resources of the target BWP.

Another apparatus for wireless communication is described. The apparatus may include a processor, memory in electronic communication with the processor, and instructions stored in the memory. The instructions may be operable to cause the processor to receive downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, identify a BWP switching event that causes the UE to change from the active BWP to a target BWP of the carrier based at least in part on information included in the BWP identifier field, determine that resources of the target BWP are non-nested with resources of the active BWP based at least in part on identifying the BWP switching event, identify communication resources of the target BWP associated with a physical resource block (PRB) allocation in the active BWP based at least in part on determining that the resources of the target BWP are non-nested with the resources of the active BWP, and communicate with a base station using the identified communication resources of the target BWP.

A non-transitory computer-readable medium for wireless communication is described. The non-transitory computer-readable medium may include instructions operable to cause a processor to receive downlink control information (DCI) that allocates communication resources to the UE and includes a bandwidth part (BWP) of a carrier identifier field and a resource allocation field, the resource allocation field having a length that is based at least in part on a size of an active BWP of the carrier being used by the UE, identify a BWP switching event that causes the UE to change from the active BWP to a target BWP of the carrier based at least in part on information included in the BWP identifier field, determine that resources of the target BWP are non-nested with resources of the active BWP based at least in part on identifying the BWP switching event, identify communication resources of the target BWP associated with a physical resource block (PRB) allocation in the active BWP based at least in part on determining that the resources of the target BWP are non-nested with the resources of the active BWP, and communicate with a base station using the identified communication resources of the target BWP.

Some examples of the method, apparatus, and non-transitory computer-readable medium described above may further include processes, features, means, or instructions for identifying a reference location of the PRB allocation in the active BWP, where identifying the communication resources of the target BWP associated with the PRB allocation may be based at least in part on identifying the reference location.

Some examples of the method, apparatus, and non-transitory computer-readable medium described above may further include processes, features, means, or instructions for identifying an offset relative to the reference location associated with the target BWP, identifying the communication resources of the target BWP associated with the PRB allocation may be based at least in part on identifying the offset.

In some examples of the method, apparatus, and non-transitory computer-readable medium described above, the reference location may be a lowest frequency resource of the active BWP.

Some examples of the method, apparatus, and non-transitory computer-readable medium described above may further include processes, features, means, or instructions for mapping the resources of the active BWP to the resources of the target BWP based at least in part on determining that the resources of the target BWP may be non-nested with the resources of the active BWP, where identifying the communication resources of the target BWP associated with the PRB allocation may be based at least in part on mapping the resources.

Some examples of the method, apparatus, and non-transitory computer-readable medium described above may further include processes, features, means, or instructions for determining whether a frequency range of the target BWP may be wider or narrower than a frequency range of the active BWP, wherein identifying the communication resources of the target BWP associated with the PRB allocation may be based at least in part on determining whether the frequency range of the target BWP may be wider or narrower than the frequency range of the active BWP.

Some examples of the method, apparatus, and non-transitory computer-readable medium described above may further include processes, features, means, or instructions for truncating information based at least in part on the frequency range of the target BWP being narrower than the frequency range of the active BWP, wherein communicating with the base station using the identified communication resources of the target BWP may be based at least in part on truncating the information. Some examples of the method, apparatus, and non-transitory computer-readable medium described above may further include processes, features, means, or instructions for determining whether a frequency-domain resource allocation field of the target BWP is larger or smaller than a frequency-domain resource allocation field of the active BWP, where identifying the communication resources of the target BWP associated with the PRB allocation is based at least in part on determining whether the frequency-domain resource allocation field of the target BWP is larger or smaller than the frequency-domain resource allocation field of the active BWP. Some examples of the method, apparatus, and non-transitory computer-readable medium described above may further include processes, features, means, or instructions for identifying information based at least in part on a least significant bit of the DCI based at least in part on determining the frequency-domain resource allocation field of the target BWP is smaller than the frequency-domain resource allocation field of the active BWP. Some examples of the method, apparatus, and non-transitory computer-readable medium described above may further include processes, features, means, or instructions for identifying information based at least in part on populating the frequency-domain resource allocation field of the active BWP with a zero padding based at least in part on determining the frequency-domain resource allocation field of the target BWP is larger than the frequency-domain resource allocation field of the active BWP.

Some examples of the method, apparatus, and non-transitory computer-readable medium described above may further include processes, features, means, or instructions for determining that a portion of a frequency range of the target BWP may be exclusive of a frequency range of the active BWP. Some examples of the method, apparatus, and non-transitory computer-readable medium described above may further include processes, features, means, or instructions for determining that the a portion of the frequency range of the active BWP may be exclusive of the frequency range of the target BWP, where determining that the resources of the target BWP may be non-nested with the resources of the active BWP may be based at least in part on the determinations.

A method of wireless communication is described. The method may include identifying a target bandwidth part (BWP) of a carrier to be used to communicate with a user equipment (UE) different from an active BWP of the carrier being used to communicate with the UE, determining that resources of the target BWP are non-nested with resources of the active BWP based at least in part on identifying the BWP switching event, identifying communication resources of the target BWP associated with a physical resource block (PRB) allocation in the active BWP based at least in part on determining that the resources of the target BWP are non-nested with the resources of the active BWP, generating downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, transmitting the DCI to the UE, and communicating with the UE using a portion of communication resources of the target BWP of the carrier included in the resource allocation field.

An apparatus for wireless communication is described. The apparatus may include means for identifying a target bandwidth part (BWP) of a carrier to be used to communicate with a user equipment (UE) different from an active BWP of the carrier being used to communicate with the UE, means for determining that resources of the target BWP are non-nested with resources of the active BWP based at least in part on identifying the BWP switching event, means for identifying communication resources of the target BWP associated with a physical resource block (PRB) allocation in the active BWP based at least in part on determining that the resources of the target BWP are non-nested with the resources of the active BWP, means for generating downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, means for transmitting the DCI to the UE, and means for communicating with the UE using a portion of communication resources of the target BWP of the carrier included in the resource allocation field.

Another apparatus for wireless communication is described. The apparatus may include a processor, memory in electronic communication with the processor, and instructions stored in the memory. The instructions may be operable to cause the processor to identify a target bandwidth part (BWP) of a carrier to be used to communicate with a user equipment (UE) different from an active BWP of the carrier being used to communicate with the UE, determine that resources of the target BWP are non-nested with resources of the active BWP based at least in part on identifying the BWP switching event, identify communication resources of the target BWP associated with a physical resource block (PRB) allocation in the active BWP based at least in part on determining that the resources of the target BWP are non-nested with the resources of the active BWP, generate downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, transmit the DCI to the UE, and communicate with the UE using a portion of communication resources of the target BWP of the carrier included in the resource allocation field.

A non-transitory computer-readable medium for wireless communication is described. The non-transitory computer-readable medium may include instructions operable to cause a processor to identify a target bandwidth part (BWP) of a carrier to be used to communicate with a user equipment (UE) different from an active BWP of the carrier being used to communicate with the UE, determine that resources of the target BWP are non-nested with resources of the active BWP based at least in part on identifying the BWP switching event, identify communication resources of the target BWP associated with a physical resource block (PRB) allocation in the active BWP based at least in part on determining that the resources of the target BWP are non-nested with the resources of the active BWP, generate downlink control information (DCI) that allocates communication resources to the UE and includes a BWP identifier field and a resource allocation field, the resource allocation field indicating communication resources of the target BWP of the carrier to be used by the UE and the resource allocation field having a length that is based at least in part on a size of the active BWP of the carrier being used by the UE, transmit the DCI to the UE, and communicate with the UE using a portion of communication resources of the target BWP of the carrier included in the resource allocation field.

Some examples of the method, apparatus, and non-transitory computer-readable medium described above may further include processes, features, means, or instructions for identifying a reference location of the PRB allocation in the active BWP, where identifying the communication resources of the target BWP associated with the PRB allocation may be based at least in part on identifying the reference location.

Some examples of the method, apparatus, and non-transitory computer-readable medium described above may further include processes, features, means, or instructions for identifying an offset relative to the reference location associated with the target BWP, identifying the communication resources of the target BWP associated with the PRB allocation may be based at least in part on identifying the offset.

In some examples of the method, apparatus, and non-transitory computer-readable medium described above, the reference location may be a lowest frequency of the active BWP.

Some examples of the method, apparatus, and non-transitory computer-readable medium described above may further include processes, features, means, or instructions for mapping the resources of the active BWP to the resources of the target BWP based at least in part on determining that the resources of the target BWP may be non-nested with the resources of the active BWP, where identifying the communication resources of the target BWP associated with the PRB allocation may be based at least in part on mapping the resources.

Some examples of the method, apparatus, and non-transitory computer-readable medium described above may further include processes, features, means, or instructions for determining whether a frequency range of the target BWP may be wider or narrower than a frequency range of the active BWP, where identifying the communication resources of the target BWP associated with the PRB allocation may be based at least in part on determining whether the frequency range of the target BWP may be wider or narrower than the frequency range of the active BWP.

Some examples of the method, apparatus, and non-transitory computer-readable medium described above may further include processes, features, means, or instructions for truncating information based at least in part on the frequency range of the target BWP being narrower than the frequency range of the active BWP, where communicating with the base station using the identified communication resources of the target BWP may be based at least in part on truncating the information.

Some examples of the method, apparatus, and non-transitory computer-readable medium described above may further include processes, features, means, or instructions for determining that a portion of a frequency range of the target BWP may be exclusive of a frequency range of the active BWP. Some examples of the method, apparatus, and non-transitory computer-readable medium described above may further include processes, features, means, or instructions for determining that the a portion of the frequency range of the active BWP may be exclusive of the frequency range of the target BWP, where determining that the resources of the target BWP may be non-nested with the resources of the active BWP may be based at least in part on the determinations.

A method of wireless communication at a UE is described. The method may include receiving DCI that allocates communication resources to the UE and includes a bandwidth part (BWP) identifier field and a resource allocation field, the resource allocation field having a length that is based on a size of an active BWP being used by the UE, identifying a BWP switching event that causes the UE to change from the active BWP to a target BWP based on information included in the BWP identifier field, identifying communication resources of the target BWP associated with a physical resource block (PRB) allocation in the active BWP based on identifying the BWP switching event, and communicating with a base station using the identified communication resources of the target BWP.

An apparatus for wireless communication at a UE is described. The apparatus may include a processor, memory in electronic communication with the processor, and instructions stored in the memory. The instructions may be executable by the processor to cause the apparatus to receive DCI that allocates communication resources to the UE and includes a bandwidth part (BWP) identifier field and a resource allocation field, the resource allocation field having a length that is based on a size of an active BWP being used by the UE, identify a BWP switching event that causes the UE to change from the active BWP to a target BWP based on information included in the BWP identifier field, identify communication resources of the target BWP associated with a physical resource block (PRB) allocation in the active BWP based on identifying the BWP switching event, and communicate with a base station using the identified communication resources of the target BWP.

Another apparatus for wireless communication at a UE is described. The apparatus may include means for receiving DCI that allocates communication resources to the UE and includes a bandwidth part (BWP) identifier field and a resource allocation field, the resource allocation field having a length that is based on a size of an active BWP being used by the UE, identifying a BWP switching event that causes the UE to change from the active BWP to a target BWP based on information included in the BWP identifier field, identifying communication resources of the target BWP associated with a physical resource block (PRB) allocation in the active BWP based on identifying the BWP switching event, and communicating with a base station using the identified communication resources of the target BWP.

A non-transitory computer-readable medium storing code for wireless communication at a UE is described. The code may include instructions executable by a processor to receive DCI that allocates communication resources to the UE and includes a bandwidth part (BWP) identifier field and a resource allocation field, the resource allocation field having a length that is based on a size of an active BWP being used by the UE, identify a BWP switching event that causes the UE to change from the active BWP to a target BWP based on information included in the BWP identifier field, identify communication resources of the target BWP associated with a physical resource block (PRB) allocation in the active BWP based on identifying the BWP switching event, and communicate with a base station using the identified communication resources of the target BWP.

Some examples of the method, apparatuses, and non-transitory computer-readable medium described herein may further include operations, features, means, or instructions for identifying a reference location of the PRB allocation in the active BWP, where identifying the communication resources of the target BWP associated with the PRB allocation may be based on identifying the reference location.

Some examples of the method, apparatuses, and non-transitory computer-readable medium described herein may further include operations, features, means, or instructions for identifying an offset relative to the reference location associated with the target BWP, identifying the communication resources of the target BWP associated with the PRB allocation may be based on identifying the offset.

In some examples of the method, apparatuses, and non-transitory computer-readable medium described herein, the DCI includes an indicator of the offset.

In some examples of the method, apparatuses, and non-transitory computer-readable medium described herein, the offset may be based on a resource block group size, the size of the target BWP, a difference between the active BWP and the target BWP, or any combination thereof.

In some examples of the method, apparatuses, and non-transitory computer-readable medium described herein, the reference location may be a lowest frequency resource of the active BWP.

Some examples of the method, apparatuses, and non-transitory computer-readable medium described herein may further include operations, features, means, or instructions for mapping the resources of the active BWP to the resources of the target BWP based on identifying the BWP switching event, where identifying the communication resources of the target BWP associated with the PRB allocation may be based on mapping the resources.

Some examples of the method, apparatuses, and non-transitory computer-readable medium described herein may further include operations, features, means, or instructions for determining a mapping option that indicates how resources of the active BWP may be mapped to resources of the target BWP during the BWP switching event based on the DCI received from the base station, where mapping the resources may be based on determining the mapping option.

In some examples of the method, apparatuses, and non-transitory computer-readable medium described herein, the DCI includes a mapping field indicating the mapping option.

In some examples of the method, apparatuses, and non-transitory computer-readable medium described herein, a hybrid automation repeat request (HARQ) process identifier field of the DCI includes an indication of the mapping option.

In some examples of the method, apparatuses, and non-transitory computer-readable medium described herein, the mapping option includes a modulo operation.

Some examples of the method, apparatuses, and non-transitory computer-readable medium described herein may further include operations, features, means, or instructions for determining whether a frequency range of the target BWP may be wider or narrower than a frequency range of the active BWP, where identifying the communication resources of the target BWP associated with the PRB allocation may be based on determining whether the frequency range of the target BWP may be wider or narrower than the frequency range of the active BWP.

Some examples of the method, apparatuses, and non-transitory computer-readable medium described herein may further include operations, features, means, or instructions for configuring the UE to determine whether a frequency-domain resource allocation field of the target BWP is larger or smaller than a frequency-domain resource allocation field of the active BWP, where identifying the communication resources of the target BWP associated with the PRB allocation is based at least in part on determining whether the frequency-domain resource allocation field of the target BWP is larger or smaller than the frequency-domain resource allocation field of the active BWP. Some examples of the method, apparatuses, and non-transitory computer-readable medium described herein may further include operations, features, means, or instructions for configuring the UE to identify information based at least in part on a least significant bit of the DCI based at least in part on determining the frequency-domain resource allocation field of the target BWP is smaller than the frequency-domain resource allocation field of the active BWP. Some examples of the method, apparatus, and non-transitory computer-readable medium described above may further include processes for configuring the UE to populate the frequency-domain resource allocation field of the active BWP with a zero padding based at least in part on determining the frequency-domain resource allocation field of the target BWP is larger than the frequency-domain resource allocation field of the active BWP.

Some examples of the method, apparatuses, and non-transitory computer-readable medium described herein may further include operations, features, means, or instructions for truncating information based on the frequency range of the target BWP being narrower than the frequency range of the active BWP, where communicating with the base station using the identified communication resources of the target BWP may be based on truncating the information.

A method of wireless communication at a base station is described. The method may include identifying a target bandwidth part (BWP) of a carrier to be used to communicate with a UE different from an active BWP of the carrier being used to communicate with the UE, identifying communication resources of the target BWP associated with a physical resource block (PRB) allocation in the active BWP based on identifying the BWP switching event, generating DCI that allocates communication resources to the UE and includes a BWP identifier field and a resource allocation field, the resource allocation field indicating communication resources of the target BWP of the carrier to be used by the UE and the resource allocation field having a length that is based on a size of the active BWP of the carrier being used by the UE, transmitting the DCI to the UE, and communicating with the UE using a portion of communication resources of the target BWP of the carrier included in the resource allocation field.

An apparatus for wireless communication at a base station is described. The apparatus may include a processor, memory in electronic communication with the processor, and instructions stored in the memory. The instructions may be executable by the processor to cause the apparatus to identify a target bandwidth part (BWP) of a carrier to be used to communicate with a UE different from an active BWP of the carrier being used to communicate with the UE, identify communication resources of the target BWP associated with a physical resource block (PRB) allocation in the active BWP based on identifying the BWP switching event, generate DCI that allocates communication resources to the UE and includes a BWP identifier field and a resource allocation field, the resource allocation field indicating communication resources of the target BWP of the carrier to be used by the UE and the resource allocation field having a length that is based on a size of the active BWP of the carrier being used by the UE, transmit the DCI to the UE, and communicate with the UE using a portion of communication resources of the target BWP of the carrier included in the resource allocation field.

Another apparatus for wireless communication at a base station is described. The apparatus may include means for identifying a target bandwidth part (BWP) of a carrier to be used to communicate with a UE different from an active BWP of the carrier being used to communicate with the UE, identifying communication resources of the target BWP associated with a physical resource block (PRB) allocation in the active BWP based on identifying the BWP switching event, generating DCI that allocates communication resources to the UE and includes a BWP identifier field and a resource allocation field, the resource allocation field indicating communication resources of the target BWP of the carrier to be used by the UE and the resource allocation field having a length that is based on a size of the active BWP of the carrier being used by the UE, transmitting the DCI to the UE, and communicating with the UE using a portion of communication resources of the target BWP of the carrier included in the resource allocation field.

A non-transitory computer-readable medium storing code for wireless communication at a base station is described. The code may include instructions executable by a processor to identify a target bandwidth part (BWP) of a carrier to be used to communicate with a UE different from an active BWP of the carrier being used to communicate with the UE, identify communication resources of the target BWP associated with a physical resource block (PRB) allocation in the active BWP based on identifying the BWP switching event, generate DCI that allocates communication resources to the UE and includes a BWP identifier field and a resource allocation field, the resource allocation field indicating communication resources of the target BWP of the carrier to be used by the UE and the resource allocation field having a length that is based on a size of the active BWP of the carrier being used by the UE, transmit the DCI to the UE, and communicate with the UE using a portion of communication resources of the target BWP of the carrier included in the resource allocation field.

Some examples of the method, apparatuses, and non-transitory computer-readable medium described herein may further include operations, features, means, or instructions for identifying a reference location of the PRB allocation in the active BWP, where identifying the communication resources of the target BWP associated with the PRB allocation may be based on identifying the reference location.

Some examples of the method, apparatuses, and non-transitory computer-readable medium described herein may further include operations, features, means, or instructions for identifying an offset relative to the reference location associated with the target BWP, identifying the communication resources of the target BWP associated with the PRB allocation may be based on identifying the offset.

In some examples of the method, apparatuses, and non-transitory computer-readable medium described herein, the DCI includes an indicator of the offset.

In some examples of the method, apparatuses, and non-transitory computer-readable medium described herein, the offset may be based on a resource block group size, the size of the target BWP, a difference between the active BWP and the target BWP, or any combination thereof.

In some examples of the method, apparatuses, and non-transitory computer-readable medium described herein, the reference location may be a lowest frequency of the active BWP.

Some examples of the method, apparatuses, and non-transitory computer-readable medium described herein may further include operations, features, means, or instructions for mapping the resources of the active BWP to the resources of the target BWP based on identifying the BWP switching event, where identifying the communication resources of the target BWP associated with the PRB allocation may be based on mapping the resources.

Some examples of the method, apparatuses, and non-transitory computer-readable medium described herein may further include operations, features, means, or instructions for determining a mapping option that indicates how resources of the active BWP may be mapped to resources of the target BWP during the BWP switching event based on the DCI received from the base station, where mapping the resources may be based on determining the mapping option.

In some examples of the method, apparatuses, and non-transitory computer-readable medium described herein, the DCI includes a mapping field indicating the mapping option.

In some examples of the method, apparatuses, and non-transitory computer-readable medium described herein, a hybrid automation repeat request (HARQ) process identifier field of the DCI includes an indication of the mapping option.

In some examples of the method, apparatuses, and non-transitory computer-readable medium described herein, the mapping option includes a modulo operation.

Some examples of the method, apparatuses, and non-transitory computer-readable medium described herein may further include operations, features, means, or instructions for determining whether a frequency range of the target BWP may be wider or narrower than a frequency range of the active BWP, where identifying the communication resources of the target BWP associated with the PRB allocation may be based on determining whether the frequency range of the target BWP may be wider or narrower than the frequency range of the active BWP.

Some examples of the method, apparatuses, and non-transitory computer-readable medium described herein may further include operations, features, means, or instructions for truncating information based on the frequency range of the target BWP being narrower than the frequency range of the active BWP, where communicating with the base station using the identified communication resources of the target BWP may be based on truncating the information.

### BRIEF DESCRIPTION OF THE DRAWINGS

FIG. 1 illustrates an example of a system for wireless communication that supports signaling techniques for bandwidth parts in accordance with aspects of the present disclosure.

FIG. 2 illustrates an example of a wireless communications system that supports signaling techniques for bandwidth parts in accordance with aspects of the present disclosure.

FIG. 3 illustrates examples of message structures that support signaling techniques for bandwidth parts in accordance with aspects of the present disclosure.

FIG. 4 illustrates examples of BWP switching events that support signaling techniques for bandwidth parts in accordance with aspects of the present disclosure.

FIG. 5 illustrates an example of a communication scheme that supports signaling techniques for bandwidth parts in accordance with aspects of the present disclosure.

FIGS. 6A and 6B illustrate examples of BWP structures that support signaling techniques for bandwidth parts in accordance with aspects of the present disclosure.

FIGS. 7A and 7B illustrate examples of a process flow that support signaling techniques for bandwidth parts in accordance with aspects of the present disclosure.

FIG. 8 illustrates examples of diagrams that support signaling techniques for bandwidth parts in accordance with aspects of the present disclosure.

FIGS. 9 through 11 show block diagrams of a device that supports signaling techniques for bandwidth parts in accordance with aspects of the present disclosure.

FIG. 12 illustrates a block diagram of a system including a UE that supports signaling techniques for bandwidth parts in accordance with aspects of the present disclosure.

FIGS. 13 through 15 show block diagrams of a device that supports signaling techniques for bandwidth parts in accordance with aspects of the present disclosure.

FIG. 16 illustrates a block diagram of a system including a base station that supports signaling techniques for bandwidth parts in accordance with aspects of the present disclosure.

FIGS. 17 through 25 illustrate methods for signaling techniques for bandwidth parts in accordance with aspects of the present disclosure.

### DETAILED DESCRIPTION

In some wireless communications systems, the size (e.g., bit length) of downlink control information (DCI) may be based on the size (e.g., bandwidth) of the associated bandwidth part (BWP). Variations in the sizes of the DCI may introduce issues related to BWP switching events and using fallback DCI.

Techniques are described herein for scheduling communication resources (e.g., resource blocks) of a BWP after a BWP switching event when the frequency range of an active BWP is different than the frequency range of a target BWP. A UE may interpret the resource allocation field in a scheduling DCI that triggers a BWP switching event based on the active BWP and not the target BWP indicated in the BWP identifier field. In such cases, the UE and a base station may be configured to communicate using at least a portion of the resources (e.g., resource blocks) of the active BWP in the first transmission opportunity (e.g., first slot) after the BWP switching event. In subsequent transmitting opportunities where a scheduling DCI for the target BWP is received by the UE, the UE may be configured to behave normally.

In addition, techniques are provided for using a fallback DCI associated with a reference BWP to maintain or recover the link with the base station when the UE cannot successfully decode the non-fallback DCI. The base station may be configured to generate the non-fallback DCI associated with the active BWP and the fallback DCI associated with the reference BWP. The base station may transmit the non-fallback DCI and the fallback DCI to the UE. While communicating with the base station, the UE may monitor for both the non-fallback DCI and the fallback DCI.

Aspects of the disclosure are initially described in the context of a wireless communications system. Aspects of the disclosure are further illustrated by and described with reference to apparatus diagrams, system diagrams, and flowcharts that relate to signaling techniques for bandwidth parts.

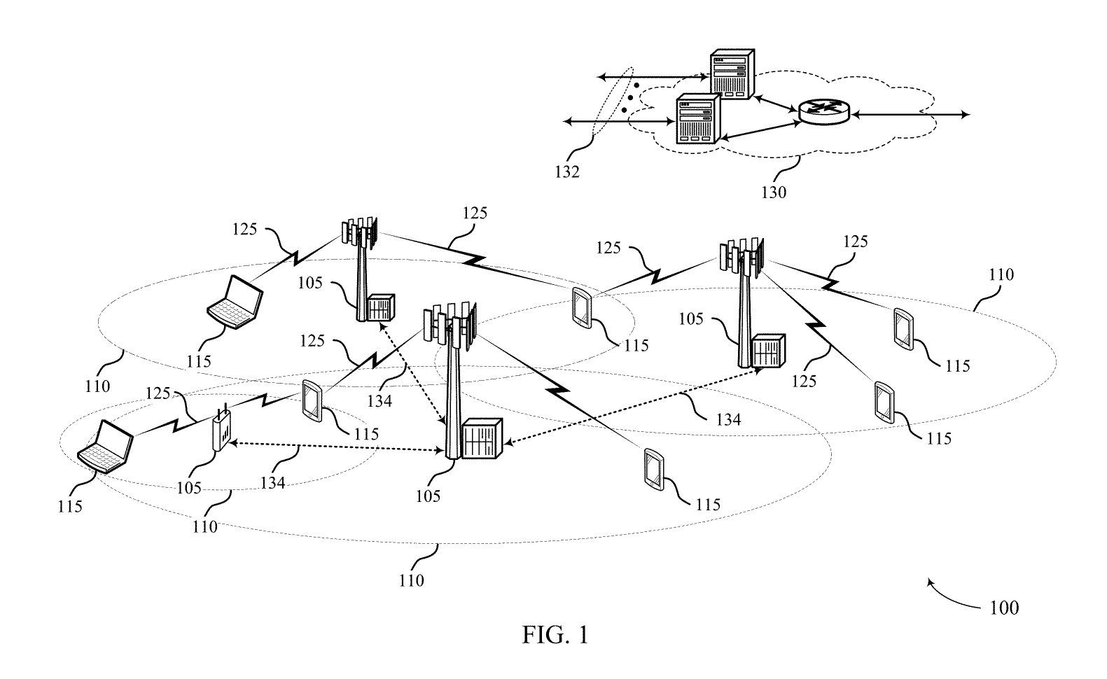

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an Si or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ= 1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or control search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may include one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

The base stations 105 and the UEs 115 may be configured to communicate using BWPs and DCI that varies in size based on the size of the BWPs. The varying size of the DCI may create complications during BWP switching events and when using fallback DCI. To address these issues, techniques for generating and interpreting resource allocation information in the DCI during BWP switching events is described. In addition, techniques for providing a size invariant fallback DCI associated with a reference BWP are also described.

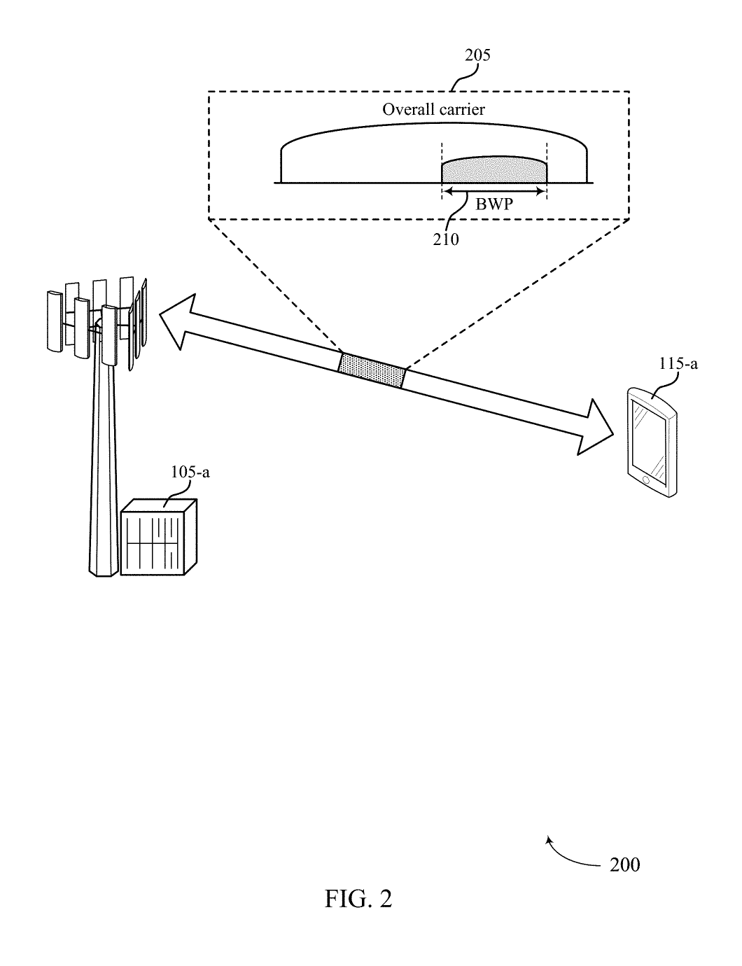

FIG. 2 illustrates an example of a wireless communications system 200 that supports signaling techniques for bandwidth parts in accordance with various aspects of the present disclosure. In some examples, the wireless communications system 200 may implement aspects of wireless communications system 100. The wireless communications system 200 may include a base station 105-a and a UE 115-a that may communicate information using a carrier 205. The wireless communications system 200 may be configured to use one or more bandwidth parts 210, or BWPs 210, to communicate information in the overall carrier 205.

A BWP 210 may be a group of contiguous physical resource blocks (PRBs). The bandwidth of the BWP 210 may be equal to or smaller than a maximum bandwidth capability supported by a UE 115-a or the bandwidth of the overall carrier 205. In some cases, the bandwidth of the BWP 210 may be at least as large as a bandwidth of a synchronization signal (SS) block.

In some cases, the BWP 210 may be a dynamically-configured (or semi-statically configured) portion of the overall carrier 205. The BWP 210 may include a number of dynamically (or semi-statically) configurable parameters. Examples of such parameters may include frequency location (e.g., center frequency), bandwidth (e.g., number of PRBs), numerology (e.g., sub-carrier spacing and/or cyclic prefix type), or a combination thereof. The parameters of the BWP 210 may be communicated using DCI, a medium access control (MAC) control element (CE), radio resource control (RRC) signaling, and/or a time pattern (e.g., in a discontinuous reception situation). The granularity of certain parameters may be the size of one PRB (e.g., bandwidth granularity may be 1 PRB and frequency location granularity may be 1 PRB).

A BWP 210 may be configured for downlink and for uplink. BWPs 210 may be configured independently for each cell (e.g., primary cells and/or secondary cells). In such cases, if an SCell is deactivated, the BWPs of that cell may also be deactivated. In some cases, the UE 115-a may be configured to communicate using one or more downlink BWPs and/or one or more uplink BWPs at the same time. In some cases, there is at most one active downlink BWP and at most one active uplink BWP at a given time for a serving cell. A primary serving cell (PCell) may be the cell that handles the RRC connection between the UE 115-a and the base station 105-a and an SCell may be any other serving cells established between the UE 115-a and the base station 105-a.

BWPs 210 may be used in both paired spectrum and unpaired spectrum. In paired spectrum, a first frequency spectrum band may be allocated (e.g., dedicated) to downlink communications and a second frequency spectrum band may be allocated (e.g., dedicated) to uplink communications. Paired spectrum may use FDD systems to establish two-way communications between nodes. In unpaired spectrum, the same frequency spectrum band may be used for both uplink and downlink communications. Unpaired spectrum may use TDD systems to establish two-way communications between nodes. In some cases, for paired spectrum, a maximum number of BWP configurations may be four downlink BWPs and four uplink BWPs. In some cases, for unpaired spectrum, a maximum number of BWP configurations may be four downlink/uplink BWP pairs. In some cases, for FDD, the BWPs for downlink and the BWPs for uplink may be configured independently on a per-component carrier (CC) basis. In some cases, for TDD, a joint set of downlink BWPs and uplink BWPs may be configured on a per-CC basis.

In some cases, an active BWP 210 of the UE 115-a does not span a frequency spectrum band larger than a bandwidth of a CC of the UE 115-a. The configuration for a downlink BWP may include at least one control resource set (CORESET). In some cases, at least one configured downlink BWP may include a CORESET with a control search space (CSS) in a primary component carrier (PCC). In some cases, in a PCell, for the UE 115-a, a CSS may be configured in each BWP 210. In some cases, each configured downlink BWP includes at least one CORESET with a UE-specific search space (UE-SS) for the case of single active BWP at a given time. In some cases, if the active downlink BWP does not include a CSS, then UE 115-a may not monitor the CSS. The CSS may include communication resources where the UE is configured to look for physical downlink control channel (PDCCH) which carries downlink control information (DCI) as its payload.

Upon establishing an RRC connection, the UE 115-a or the base station 105-a may activate a default configuration of one or more BWPs 210 (e.g., a downlink BWP and an uplink BWP). The UE 115-a and the base station 105-a may use those default BWPs 210 until the BWPs 210 are explicitly configured or reconfigured.

The wireless communications system 200 may also support a BWP switching event. In some cases, the UE 115-a (or the base station 105-a) may be configured to use one BWP 210 of a carrier 205 at a time. In such cases, if the UE 115-a (or the base station 105-a) wants to use a different BWP for the carrier 205, the UE 115-a (or the base station 105-a) may have to reconfigure its BWP 210. As part of a BWP switching event, the UE 115-a (or the base station 105-a) may switch the active BWP to a target BWP within a given serving cell. A BWP switching event may be signaled using DCI. In some cases, a downlink BWP 210 may be switched using a downlink scheduling DCI and an uplink BWP 210 may be switched using an uplink scheduling DCI. In some cases, either downlink BWPs or uplink BWPs may be switched using either downlink DCI or uplink DCI. In some cases, the wireless communications system 200 may support a timer for timer-based active BWP switching. In such a time-based configuration, the BWP 210 may switch from an active BWP 210 to a default BWP 210 based on the timer expiring.

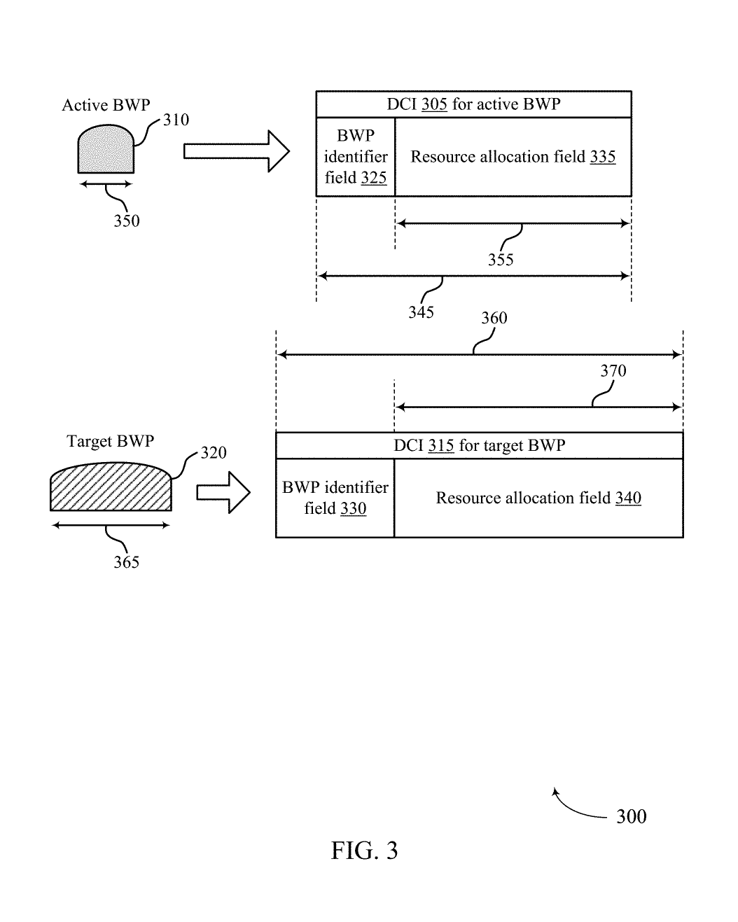

In some cases, it may be desirable to limit the size of a DCI for the UE 115-a to monitor so as to avoid a number of blind decoding by the UE 115-a. Since an overall size of a DCI may be affected by resource allocation (RA) field size, it may be helpful to consider options for determining the RA field size. For example, the RA field size may be dependent on a bandwidth of a currently active BWP, or may be based on a maximum bandwidth of configured BWPs, e.g., for a serving cell. In cases where the RA field size is based on the maximum bandwidth of the configured BWPs, there may be a disparity between bandwidth of the smallest BWP and bandwidth of the largest BWP. For example, Type 0 RA (e.g., as shown in Table 1 below) may use 17 bits for signaling resource allocation for the largest BWP (e.g., including 270 RBs) and 13 bits for the narrowest BWP (e.g., including 25 RBs). As such, if the RA field size is based on the maximum bandwidth of the configured BWPs, then 17 bits may be used for even the narrowest BWP which could have used only 13 bits for signaling the resource allocation. Thus, there may be a potential wastage (e.g., 4 bits) especially if BWP switching is not frequent. As such, the present disclosure includes techniques for determining DCI size for a BWP switch triggering DCI (e.g., non-fallback DCI), for a fallback DCI, or for enhanced Type 1 allocation scheme. FIG. 3 illustrates examples of message structures 300 that support signaling techniques for bandwidth parts in accordance with various aspects of the present disclosure. In some examples, the message structures 300 may implement aspects of the wireless communications systems 100 and 200. The message structures 300 may be different sizes based on the frequency range of the associated BWP. The message structures 300 include DCI 305 for an active BWP 310 and a DCI 315 for a target BWP 320. The DCIs 305 and 315 may be generated and transmitted by a base station 105 and received and processed by a UE 115.

The DCIs 305 and 315 may include a BWP identifier field 325 and 330 and a resource allocation field 335 and 340, among other fields. The BWP identifier field 325 may be configured to indicate a BWP identifier for the active BWP 310. The BWP identifier field 330 may be configured to indicate a BWP identifier for the target BWP 320. The resource allocation field 335 may be configured to indicate the communication resources allocated for use by the UE 115 (for either uplink or downlink depending on what is being signaled) in the BWP included in the BWP identifier field 325 (e.g., the active BWP 310). The resource allocation field 340 may be configured to indicate the communication resources allocated for use by the UE 115 (for either uplink or downlink depending on what is being signaled) in the BWP included in the BWP identifier field 330 (e.g., the target BWP 320). In some cases, the resource allocation fields 335 and 340 may indicate resource blocks of the BWP allocated to the UE 115. For example, the resource allocation fields 335 and 340 may indicate a starting resource block and a length of resource blocks.

In some cases, the resource allocation fields 335 and 340 may allocate resources based on a plurality of allocation schemes (e.g., a type 0 allocation scheme or a type 1 allocation scheme). In some wireless communications systems, the type 1 allocation scheme may not allocate communication resources based on grouping techniques. Rather, the type 1 allocation scheme may allocate each resource individually. For example, in LTE, RB-level may always be used to allocate resources. In such rigid schemes, the larger the bandwidth of the allocated resources, the greater number of bits in the resource allocation field of the scheduling message. This may result in large disparities between the sizes of resource allocation fields.

To equalize a size of the resource allocation field between allocations of different bandwidths, the resources may be allocated with varying resource granularities. For example, for allocating larger BWPs, the resource allocation field may allocate resources in larger increments than RB-level allocation. For example, resources may be allocated based on resource block groups (RBG) to reduce the number of bits of the resource allocation fields 335 and 340 when communicating information about type 1 allocation schemes. One drawback of such an approach may be that the granularity of resource allocation may be reduced. In some cases, to determine the resource groupings or the granularity of the resource groupings for type 1 allocation schemes, the size of the resource allocation field for the largest BWP and the size of the resource allocation field for the smallest BWP may be computed, rounded to the nearest integer, rounded to the nearest power of 2, or a combination thereof. Such a technique may reduce the number of bits of the resource allocation fields 335 and 340 for type 1 allocations of the largest BWPs. In some cases, a ratio of bandwidth of a large BWP to bandwidth of a small BWP may be computed, rounded to the nearest integer (or power of 2), and use that ratio as a granularity level for the large BWP. Such enhanced Type 1 RA allocation scheme may be applied to cases in which the size of RA field is based on a maximum bandwidth of configured BWPs (e.g., for a serving cell), and may reduce a maximum number of bits taken by the RA field with a larger (or wider) bandwidth, so that less bits are wasted for signaling resource allocation for BWP with a smaller (or narrower) bandwidth. In some cases where a smaller RA field associated with a narrower BWP is used to signal resource allocation for a wider BWP, instead of limiting to the frequency range of the narrower BWP for resource allocation, RBG can be defined to be larger than 1, so that RA can allocate resource over a full bandwidth of the wider BWP. In some cases, the enhanced Type 1 RA allocation scheme may enhance direct mapping techniques, e.g., strict direct mapping of physical resource blocks (e.g., mapping the same physical resource blocks with respect to frequency location), translated in frequency mapping, or direct mapping with an expanded granularity.

A length of the DCI 305 and 315 may be based on a frequency range (e.g., bandwidth) of the respective BWP. For example, a length 345 of the DCI 305 may be based on a frequency range 350 of the active BWP 310. More specifically, a length 355 of the resource allocation field 335 may be based on the frequency range 350 of the active BWP 310. Similarly, a length 360 of the DCI 315 may be based on a frequency range 365 of the target BWP 320 and a length 370 of the resource allocation field 340 may be based on the frequency range 365 of the target BWP 320. In some cases, the larger the frequency range of the BWP, the larger the size of the associated DCI. Length and size of the DCI may refer to a number of bits in the message, the communication resources consumed by the message, or a time taken to transmit the message. In some cases, a length or size of a DCI may be given in Table 1. The length or size of the DCI may be based on the carrier bandwidth, the BWP size, and the type of the resource allocation (RA).

TABLE 1

| | | Type 0 RA | | |
|---|---|---|---|---|
| Carrier BW (MHz/N_{RB}) | BWP size (N_{BWP-RB}) | P | $⌈ \frac{{N}_{BWP - RB}}{P} ⌉$ | Type 1 RA |
| 50/270 | 270 | 16 | 17 | 16 |
| | 52 | 4 | 13 | 11 |
| | 25 | 2 | 13 | 9 |

In some examples, a BWP switching event may be signaled using the DCI 305. For example, a UE 115 using the active BWP 310 of the carrier may receive a DCI 305 that allocates the UE 115 resources for communication. The DCI 305 may be based on the active BWP 310 because that is what the UE 115 is search for in its decoding processes. If the BWP identifier field 325 includes an identifier for the active BWP 310, then no switching event occurs. However, if the BWP identifier field 325 includes an identifier for a BWP different than the active BWP 310 (e.g., the target BWP 320), the UE 115 may know that a BWP switching event is to occur. The BWP switching event may cause the UE 115 and/or the base station 105 to transition from using the active BWP 310 to using the target BWP 320 identified in the BWP identifier field 325.

The frequency range 365 (e.g., size) of the target BWP 320 may be different than the frequency range 350 (e.g., size) of the active BWP 310. By extension the length 345 of the DCI 305 for the active BWP 310 may be different than the length 360 of the DCI 315 for the target BWP 320. During a BWP switching event such a difference in DCI lengths may cause problems when scheduling the first transmission opportunity for the new BWP (e.g., the target BWP 320) after the BWP switching event.

When the UE 115 detects a BWP switching event, the DCI 305 may include information related to a time or deadline when the UE 115 is expected to be switched to the new BWP (e.g., the target BWP). Upon receiving the DCI 305 that indicates the BWP switching event, the UE 115 may reconfigure its radio resources to the new BWP. In some cases, however, the resource allocation field 335 may be inadequate or insufficient (e.g., too small) to include all of the information needed for the target BWP 320. For example, if the resource allocation field 335 is smaller than the resource allocation field 340 for the target BWP 320, the resource allocation field 335 may omit certain information that is needed to allocate the resources (e.g., resource blocks) for the target BWP 320. This issue tends to exist during the first case of a BWP switching event. After the BWP switching event occurs, the base station 105 may transmit a DCI 315 for the target BWP 320 and the resource allocation field 340 may be appropriately sized for the target BWP 320.

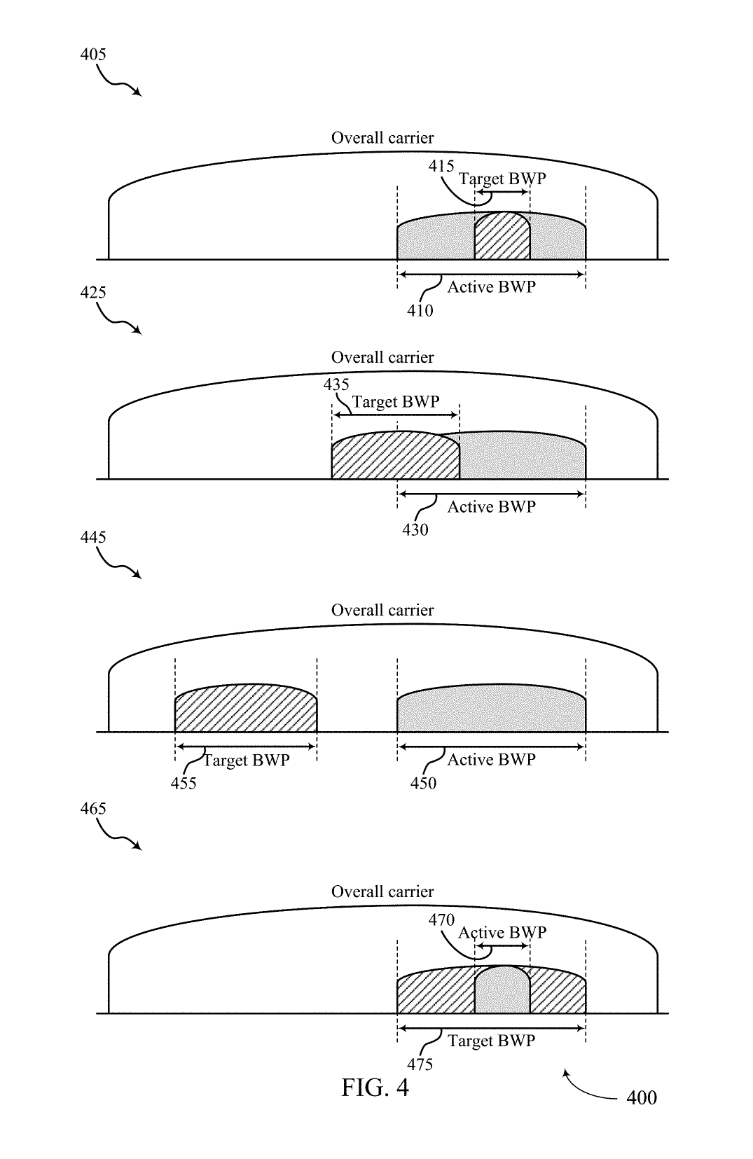

FIG. 4 illustrates examples of BWP switching events 400 that support signaling techniques for bandwidth parts in accordance with various aspects of the present disclosure. In some examples, the BWP switching events 400 may implement aspects of the wireless communications systems 100 and 200. The BWP switching events 400 illustrate some, but not all, examples of types of BWP switching events that may occur in a wireless communications system.

A first BWP switching event 405 shows a switching event where the BWP is switched from an active BWP 410 to a target BWP 415. In the first BWP switching event 405, the target BWP 415 may be a subset of the active BWP 410. When the target BWP 415 is a subset of the active BWP 410, the resource allocation field of the active BWP 410 may be sufficient to address all of the resources in the target BWP 415. In some cases, a base station 105 may be configured to map the information in the resource allocation field based on this. For example, the information in the resource allocation field may be for resources in the target BWP 415, but the information may be formatted to be read and interpreted in a field designed for the active BWP 410.

A second BWP switching event 425 shows a switching event where the BWP is switched from an active BWP 430 to a target BWP 435. In the second BWP switching event 425, the target BWP 435 may at least partially overlap with the active BWP 430. In some cases, when receiving a DCI associated with the active BWP 430, the UE 115 may be configured to interpret the information in the DCI based on the active BWP 430. In some instances, the information in the resource allocation field may be for the target BWP 435. In such cases, the UE 115 may interpret the information as if it was for the active BWP 430. The UE 115 and/or base station 105 may be configured to identify the partially overlapping resources between the active BWP 430 and the target BWP 435 and use those resources to communicate during the first communication after the BWP switching event.

A third BWP switching event 445 shows a switching event where the BWP is switched from an active BWP 450 to a target BWP 455. In the third BWP switching event 445, the target BWP 455 may include PRBs that are mutually exclusive from the PRBs of the active BWP 450. In these cases, the UE 115 and the base station 105 may not be able to communicate using the first transmission opportunity after the BWP switching event. For example, the UE 115 may interpret the resource allocation in the resource allocation field based on the active BWP 450 and when the UE 115 goes to listen and/or transmit using those resources, the base station 105 may not be transmitting and/or listening on those resources. In such cases, the UE 115 and the base station 105 may wait and receive DCI after the BWP switching event is complete, where the DCI is for the target BWP 455.

A fourth BWP switching event 465 shows a switching event where the BWP is switched from an active BWP 470 to a target BWP 475. In the fourth BWP switching event 465, the active BWP 470 may be a subset of the target BWP 475. When this occurs the DCI (and the resource allocation field) for the active BWP 470 may be too small to indicate all of the information needed to allocate resources for the target BWP 475.

Techniques are described herein for scheduling communication resources (e.g., resource blocks) of a BWP after a BWP switching event when the frequency range of the active BWP 470 is different than the frequency range of the target BWP 475. The size of downlink control information and/or resource allocation fields in the DCI may be based on the frequency range of the active BWP 470. The UE 115 may interpret the resource allocation field in a scheduling DCI that triggers a BWP switching event based on the active BWP 470 and not the target BWP 475 indicated in the BWP identifier field. In such cases, UE 115 and the base station 105 may be configured to communicate using at least a portion of the resources (e.g., resource blocks) of the active BWP 470 in the first transmission opportunity (e.g., first slot) after the BWP switching event. In subsequent transmitting opportunities where a scheduling DCI for the target BWP 475 is received by the UE 115, the UE 115 may be configured to behave normally.

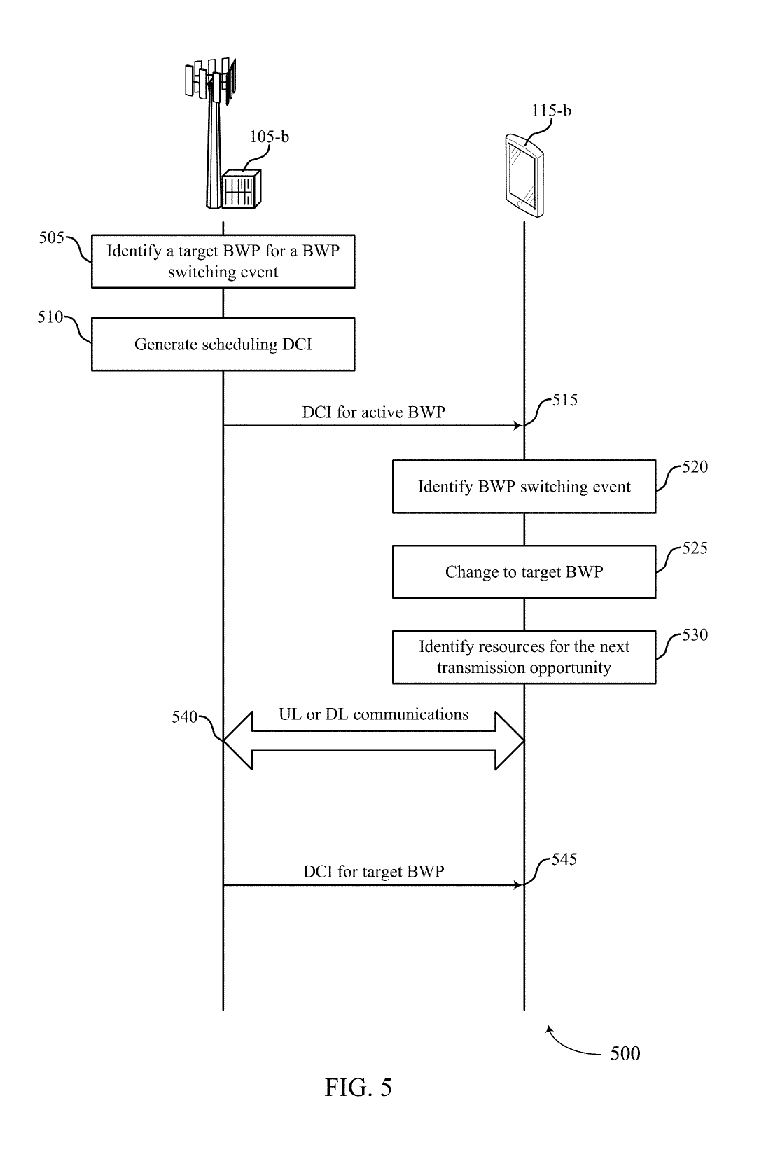

FIG. 5 illustrates an example of a communication scheme 500 that supports signaling techniques for bandwidth parts in accordance with various aspects of the present disclosure. In some examples, the communication scheme 500 may implement aspects of the wireless communications systems 100 and 200. The communication scheme 500 may illustrate techniques for handling BWP switching events when DCI sizes are based on an active BWP and not a target BWP. The communication scheme 500 may include functions and/or communications between a base station 105-b and a UE 115-b. The communication scheme 500 may be used in connection with any of the message structures described with reference to FIG. 3.

At block 505, the base station 105-b may identify a target BWP for a BWP switching event or an SCell activation event. In either case, the base station 105-b may use the techniques described herein to perform either event. A BWP switching event may include changing a currently configured BWP (downlink or uplink) from an active BWP to a target BWP. An SCell activation may include activating a secondary servicing cell. In both events, downlink control information may be used to signal an identifier related to the event (e.g., BWP identifier(s) or SCell identifier(s)).

At block 510, the base station 105-b may generate a scheduling DCI (either uplink or downlink) based on identifying the BWP switching event. To signal to the UE 115-b the BWP switching event, the base station 105-b may include an identifier for the target BWP in the DCI 515. If the identifier in the DCI 515 is different than the currently active BWP, the UE 115 may know that this is a BWP switching event. In some cases, the DCI 515 may be sized based on a frequency range (e.g., bandwidth) of the active BWP. Consequently, BWPs of different sizes may have different sizes of DCI. Under certain conditions, the DCI 515 for the active BWP may be inadequate to communicate the resource allocation for the target BWP. In such situations, the base station 105-b may be configured to map the communication resources allocated for the target BWP to the resource allocation field for the active BWP. This mapping may be used so that the UE 115-b and the base station 105-b may be configured to communicate using at least a portion of the resources of the target BWP. In some cases, the base station 105-b may determine the frequency ranges of the active BWP and the target BWP. The base station 105-b may also determine whether the frequency ranges of the two BWPs overlap in any way or if the frequency range of one of the BWPs is a subset of the other BWP. Using this information, the base station 105-b may either map the resources of the target BWP to the active BWP or may perform other procedures to account for the BWP switching event.

The base station 105-b may be configured to communicate the DCI 515 for the active BWP that includes an identifier for the target BWP in the BWP identifier field and a resource allocation for the target BWP in the resource allocation field. The DCI 515 may be an example of a message, signal, and/or transmission communicated from the base station 105-b to the UE 115-b. The DCI 515 may be an example of an uplink scheduling DCI or a downlink scheduling DCI. The DCI 515 may be configured to grant resources to be used by the UE 115-b either in uplink or downlink. The DCI 515 may be an example of a non-fallback DCI.

At block 520, the UE 115-b may identify the BWP switching event based on receiving the DCI 515. In some cases, the UE 115-b may identify the switching event based on identifying a target BWP in the BWP identifier field of the DCI 515 that is different than the active BWP. At block 525, the UE 115-b may change to the target BWP based on identifying the BWP switching event.

At block 530, the UE 115-b may identify communication resources for the transmission opportunity indicated in the DCI 515. Because the DCI 515 is sized and configured for the active BWP and not the target BWP, the UE 115-b, in some cases, may interpret the resource allocation field of the DCI 515 based on the active BWP and not the target BWP. To communicate with the base station 105-b during the transmission opportunity indicated in the DCI 515, the UE 115-b may identify communication resources common to both the active BWP and the target BWP. The UE 115-b may use the common communication resources to communicate with the base station 105-b during the next transmission opportunity. Similarly, the base station 105-b may also identify common resources and communicate accordingly. The UE 115-b may map communication resources in the resource allocation field that are specified for the target BWP to communication resources for the active BWP, in some cases.

In some cases, the UE 115-b may check a variety of conditions when decoding the DCI 515 as part of a BWP switching event. For example, the UE 115-b may determine whether frequency ranges of the active BWP and the target BWP partially overlap, are nested (e.g., a subset of each), or are mutually exclusive. To be nested, the frequency range of the active BWP may be a subset of the frequency range of the target BWP or the frequency range of the target BWP may be a subset of the frequency range of the active BWP. To be non-nested, the frequency range of the active BWP does not overlap with the frequency range of the target BWP or that the frequency range of the active BWP partially overlaps with the frequency range of the target BWP. If the frequency ranges are nested, the UE 115-b may be configured to interpret the resource allocation field based on the active BWP and not the target BWP. If the frequency ranges are mutually exclusive, the UE 115-b may be configured to refrain from communicating using the resources in the resource allocation field during the transmission opportunity indicated in the DCI 515.

The base station 105-b and the UE 115-b may exchange communications 540 based on establishing the target BWP as the new BWP. The communications 540 may be either uplink communications or downlink communications based on whether the DCI allocates uplink or downlink resources.

After the beam switching event occurs, the next DCI 545 may be DCI configured for the target BWP. As such, the DCI 545 may be appropriately sized for the target BWP, now the currently configured BWP, and the techniques for interpreting the resource allocations may not be implemented. Instead, the UE 115-b may identify the communication resources for the target BWP based on the resource allocation field of the DCI 545 that is specifically sized for the target BWP.

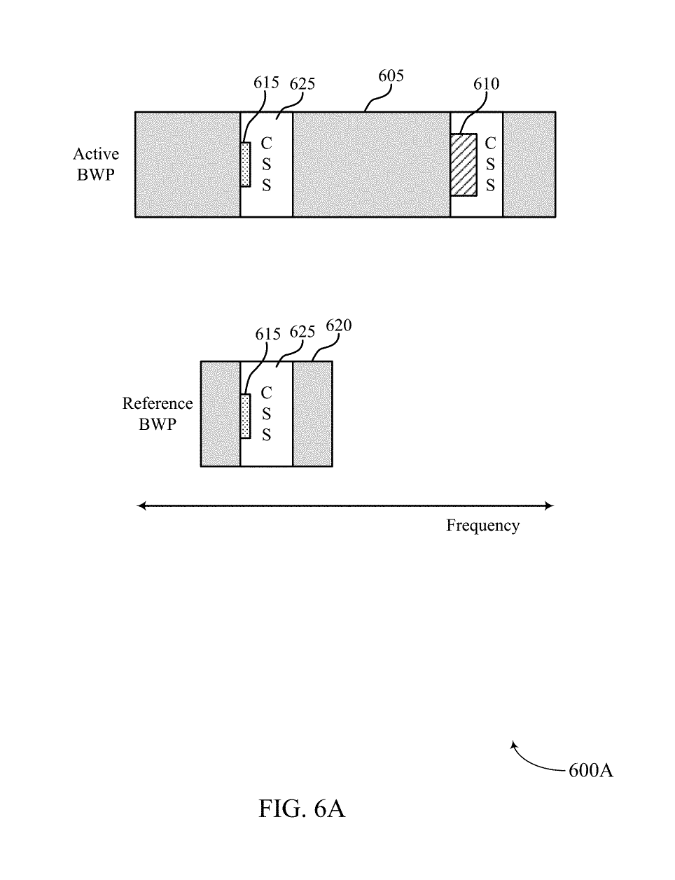

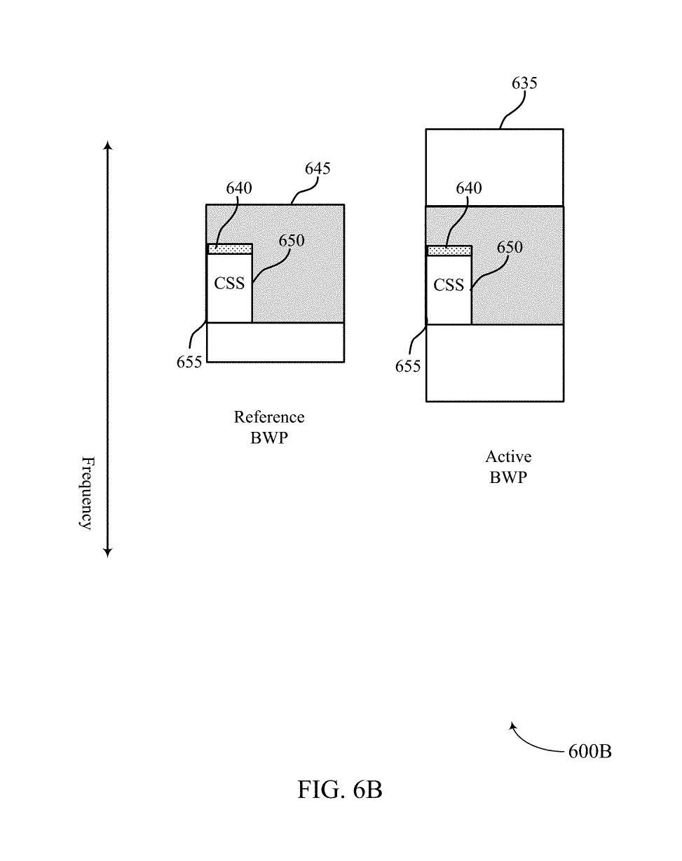

FIG. 6A illustrates examples of BWP structures 600A that support signaling techniques for bandwidth parts in accordance with various aspects of the present disclosure. In some examples, the BWP structures 600A may implement aspects of the wireless communications systems 100 and 200. The BWP structures 600A illustrate using a fallback DCI to prevent and/or mitigate the BWP of a UE 115 from falling out-of-sync with the BWP of a base station 105, or vice versa.

The UE 115 and the base station 105 may be configured to communicate using an active BWP 605. To communicate using the active BWP 605, the base station 105 may communicate one or more non-fallback DCIs 610 (e.g., DCI format 1_1, DCI format 0_1) to allocate resources to different communications with the UE 115. In some circumstances, the BWP being used by the base station 105 may become mismatched from the BWP being used by the UE 115. In such circumstances, the UE 115 will not be able to successfully decode the non-fallback DCI 610 transmitted by the base station 105. In some cases, a timer may be configured where, if the UE 115 cannot successfully decode a non-fallback DCI within the timer, the base station 105 and the UE 115 will revert to a preconfigured default BWP and reestablish the communication link. Using such a timer may waste communication resources.

Techniques are provided for using a fallback DCI (e.g., DCI format 1_0, DCI format 0_0) 615 associated with a reference BWP 620 to maintain or recover the link with the base station 105 when the UE 115 cannot successfully decode the non-fallback DCI 610. The base station 105 may be configured to generate the non-fallback DCI 610 associated with the active BWP 605 and the fallback DCI 615 associated with the reference BWP 620. The base station 105 may transmit the non-fallback DCI 610 and the fallback DCI 615 to the UE 115. The fallback DCI 615 may be positioned in a control search space (CSS) 625 of both the active BWP 605 and the reference BWP 620. While communicating with the base station 105, the UE 115 may monitor for both the non-fallback DCI 610 and the fallback DCI 615. To monitor for fallback DCI 615, the UE 115 may identify that a CSS of the active BWP 605 is identical to a CSS of the reference BWP 620.

In some cases, a size of a DCI (whether fallback or non-fallback) may be based on the frequency range of its associated BWP. If the size of the fallback DCI 615 is constantly changing, it may be an inefficient use of resources to monitor for the fallback DCI 615 and the non-fallback DCI 610. To make such concurrent monitoring efficient, the fallback DCI 615 may be associated with a reference BWP 620. The fallback DCI 615 (and by extension the reference BWP 620) may have fixed sizes. The size of the fallback DCI 615 (or the size of the resource allocation field of the fallback DCI) may be based on the frequency range of the reference BWP 620. In some cases, the size of the fallback DCI 615 is independent of the frequency range of the active BWP 605. In some cases, the size of the fallback DCI 615 is invariant relative to the size of the active BWP 605, in part because the fallback DCI 615 is associated with the reference BWP 620 and not the active BWP 605.

Upon failing to successfully decode the non-fallback DCI 610, the UE 115 may decode/examine the fallback DCI 615. The UE 115 may identify communication resources indicated in the fallback DCI 615. The UE 115 may also communicate with the base station 105 using communication resources indicated in the resource allocation field of the fallback DCI 615. Upon receiving a communication using the communication resources of the fallback DCI 615, the base station 105 may determine that its BWP is out-of-sync with the BWP of the UE 115. The base station 105 may also determine that the UE 115 failed to successfully decode the non-fallback DCI 610 based on receiving the communications over the resources of the fallback DCI 615.

After communicating using the communication resources of the fallback DCI 615, the base station 105 may perform one or more procedures to re-establish the link using the active BWP 605 and the non-fallback DCI 610. In some examples, the base station 105 may discover what BWP the UE 115 is using and then configure its own BWP to match the BWP of the UE. In such examples, the base station 105 may transmit a request to the UE 115 asking the UE 115 to inform the base station 105 what active BWP it is currently using. Upon receiving a response from the UE 115, the base station 105 may modify its active BWP of the carrier to match the active BWP of the UE 115. In another example, the base station 105 may allow a timer associated with the non-fallback DCI to expire. The timer is reset when a non-fallback DCI is successfully decoded. If the non-fallback DCI is not successfully decoded within the duration established by the timer, both the base station 105 and the UE 115 may revert to a preconfigured default BWP. After reverting back to the default BWP, the base station 105 and the UE 115 may reestablish a link with in-sync BWPs. While waiting for the timer to expire, the base station 105 and the UE 115 may continue to communicate using the communication resources in the fallback DCI 615. In many cases, the communication resources of the fallback DCI 615 may be more limited than the communication resources in the non-fallback DCI 610. However, being able to maintain at least some of a link using the fallback DCI 615 may be preferable to a radio link failure event or other similar event when the BWPs get out of sync. In some examples, the base station 105 and the UE 115 may implement combinations of the two examples.

For such a system using a fallback DCI 615 to work properly a number of conditions may be satisfied. For example, the size of the fallback DCI 615 (and the size of the resource allocation field of the fallback DCI 615) may be invariant and/or independent of the active BWP 605. As such, the fallback DCI 615 may be based on the reference BWP 620. In some examples, the fallback DCI 615 may be supported when the frequency range of the reference BWP 620 is a subset of the frequency range of the active BWP 605 (e.g., the reference BWP 620 is nested within the active BWP 605). In some examples, the fallback DCI 615 may be supported when the CSS of the active BWP 605 is exactly the same as the CSS of the reference BWP 620. Such a condition may require that the CORESET containing the CSS be exactly the same as well. In some examples, the fallback DCI 615 may be supported when both the reference BWP 620 is a subset of the active BWP 605 and the CSSs for the two BWPs 605 and 620 are exactly the same.

In some cases, the base station 105 and/or the UE 115 may identify that the CSS of the active BWP 605 is identical to the CSS of the reference BWP 620. In some cases, the base station 105 and/or the UE 115 may determine that the frequency range of the reference BWP 620 is a subset of the frequency range of the active BWP 605. The base station 105 may generate and/or transmit the fallback DCI 615 based on one or both of these conditions being met. The UE 115 may monitor for the fallback DCI 615 based on one or both of these conditions being met.

The reference BWP 620 may be configured in a number of different ways. In some cases, the reference BWP 620 may be a preconfigured default BWP that is statically configured or semi-statically configured. In such a situation, the base station 105 and the UE 115 may not need to communicate information about the reference BWP 620. In some cases, the reference BWP 620 may be a dynamically configured BWP. In such cases, the base station 105 identify a reference BWP 620 and transmit that information to the UE 115. In some cases, the reference BWP 620 may be configured as the maximum bandwidth among all configured BWPs. In such cases, however, the resulting fallback DCI may be sized such that it wastes some communication resources.

FIG. 6B illustrates examples of BWP structures 600B that support signaling techniques for bandwidth parts in accordance with various aspects of the present disclosure. In some examples, the BWP structures 600B may implement aspects of the wireless communications systems 100 and 200. The BWP structures 600B illustrate that a fallback DCI in a CSS may be shared between an active BWP and a reference BWP and a frequency-domain resource allocation field size of the BWPs may be determined based at least in part on a reference point (e.g., a lowest frequency resource) associated with the BWPs.

The UE 115 and the base station 105 may be configured to communicate using an active BWP 635. To communicate using the active BWP 635, the base station 105 may use a fallback DCI (e.g., DCI format 1_0, DCI format 0_0) 640 associated with a reference BWP 645 to maintain or recover a link with the base station 105. The base station 105 may transmit the fallback DCI 640 to the UE 115. The fallback DCI 640 may be positioned in a control search space (CSS) 650 of both the active BWP 635 and the reference BWP 645. For example, the fallback DCI 640 and the CSS 650 including the fallback DCI 640 may be positioned at a lowest frequency resource (e.g., of the CORESET 0 bandwidth) of the active BWP 635 and the reference BWP 645. In some cases, the fallback DCI 640 may be shared (e.g., common) between the active BWP 635 and the reference BWP 645 if the active BWP 635 and the reference BWP 645 share the same CSS 650. In some cases, a size of frequency-domain resource allocation field of the active BWP 635 may be determined based on the reference BWP 645. In some cases, a reference location 655 may be a feature common to both the active BWP 635 and the reference BWP 645, and may be the lowest frequency resource (e.g., of the CORESET 0 bandwidth). In some aspects, the reference BWP 645 may be an initial downlink BWP, which may be same as CORESET 0 bandwidth unless the initial downlink BWP is reconfigured in a system information (e.g., SIB1). In some aspects, a resource block (RB) numbering may start from a lowest RB in the CORESET. In some cases, PRB addressing with a fallback DCI for downlink may be common regardless of which BWP is active.

While communicating with the base station 105, the UE 115 may monitor for the fallback DCI 640. To monitor for fallback DCI 640, the UE 115 may identify that the size of the fallback DCI 640 is invariant and/or independent of the active BWP 635, and a CSS of the active BWP 635 is identical to a CSS of the reference BWP 645. After communicating using the communication resources of the fallback DCI 640, the base station 105 may perform one or more procedures to re-establish a link using the active BWP 635 and a non-fallback DCI. The reference BWP 645 may be preconfigured (e.g., a default BWP) or dynamically configured.

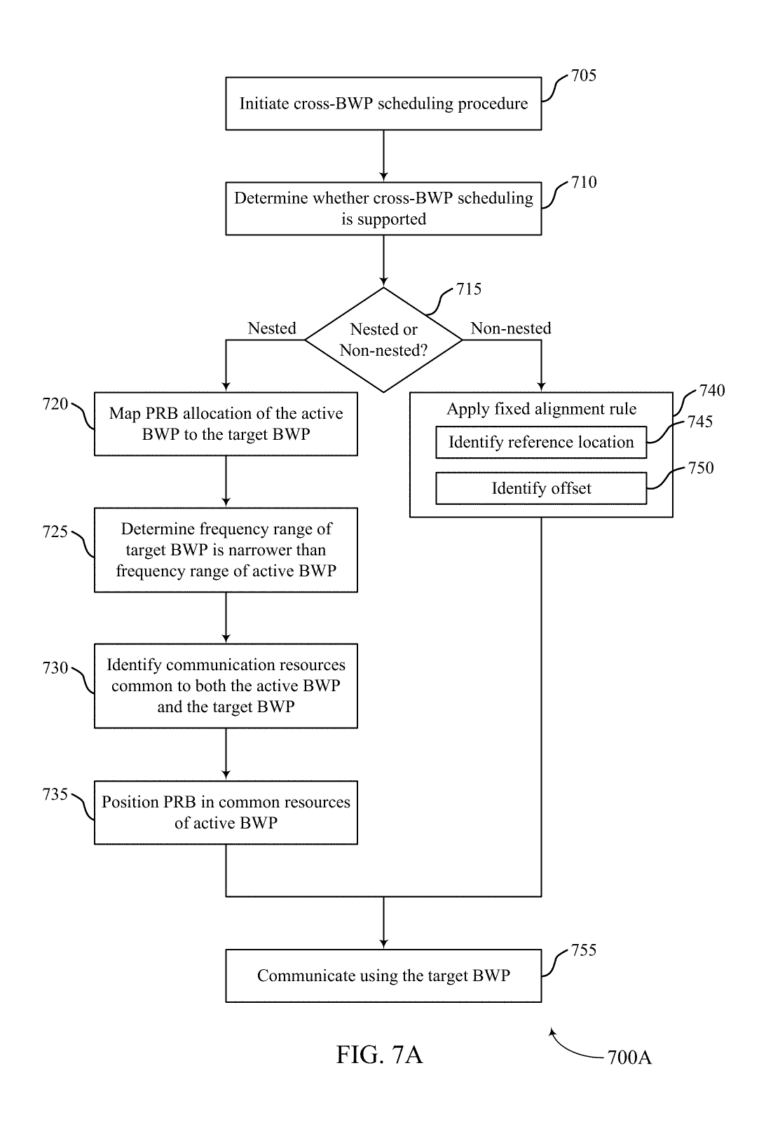

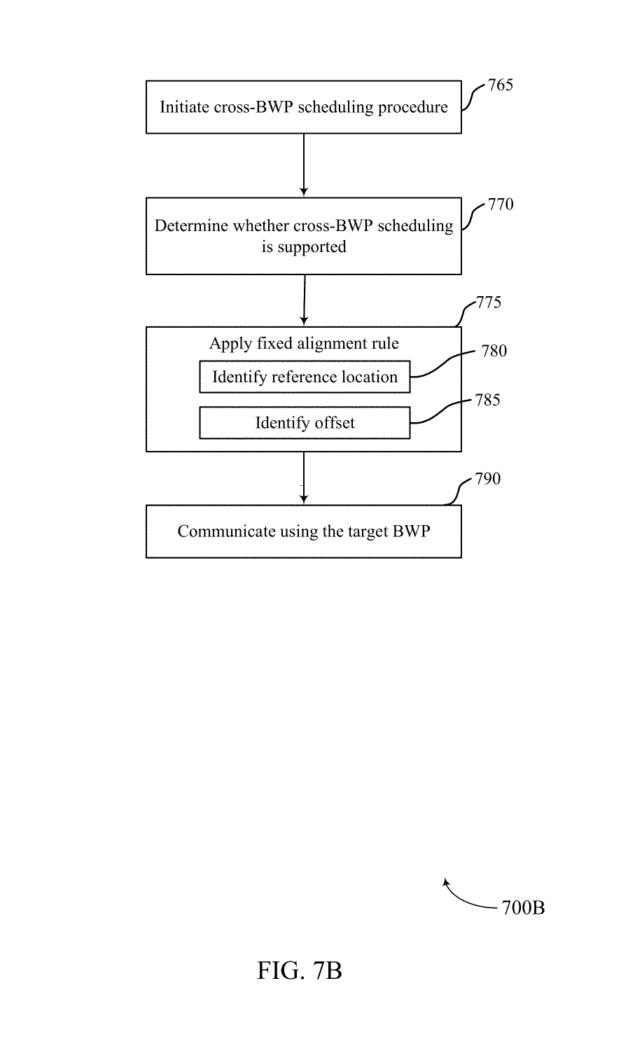

FIG. 7A illustrates an example of a process flow 700A that supports signaling techniques for bandwidth parts in accordance with various aspects of the present disclosure. In some examples, the process flow 700A may implement aspects of the wireless communications systems 100 and 200. The process flow 700A may illustrate techniques for handling BWP switching events when DCI sizes are based on an active BWP and not a target BWP. The process flow 700A may include functions performed by a base station 105, a UE 115, or both. The process flow may be used in connection with any of the message structures described with reference to FIG. 3.

At block 705, a base station 105 or a UE 115 may initiate a cross-BWP scheduling procedure. The cross-BWP scheduling procedure may be configured to allow for BWP switching when there is a mismatch between the frequency-domain resources of an active BWP (e.g., a current BWP) and the frequency-domain resources of a target BWP (e.g., a new BWP). In a cross-BWP scheduling, DCI may be interpreted based on the active BWP. For example, the UE 115 may interpret a DCI including a resource allocation field (e.g., frequency-domain resource allocation field) in a scheduling DCI that triggers a BWP switching event based on the active BWP. For example, the UE 115 may determine that a size of frequency-domain resource allocation field (e.g., a number of bits included in the frequency-domain resource allocation field) of the currently active BWP is larger or smaller than the frequency-domain resource allocation field size indicated by a BWP identifier for a target BWP. In some cases, the frequency-domain resource allocation field size of the active BWP may be larger or smaller than the frequency-domain resource allocation field size indicated for the target BWP, and thus, the frequency-domain resource allocation field sizes of the active BWP and the target BWP may be equalized. For example, if frequency-domain resource allocation field size of the active BWP is larger than the frequency-domain resource allocation field size indicated for the target BWP, the frequency-domain resource allocation field size for the target BWP may be interpreted based on the least significant bit of the frequency-domain resource allocation field of the DCI. A physical resource block allocation of the active BWP may be mapped to the target BWP.

At block 710, a base station 105 or a UE 115 may determine whether cross-BWP scheduling is supported. In some cases, this determination may be based on the combination of BWPs involved in a BWP switching event. Some fields and/or resources mapped to the active BWP may be non-transformable to the target BWP. For example, certain fields may be non-transformable if their sizes are configured differently for BWPs involved in a BWP switching event. In some cases, non-transformable fields may be padded to some common size that is transformable. In some cases, if the frequency-domain resource allocation field size of the active BWP is smaller than the frequency-domain resource allocation field size indicated for the target BWP, the frequency-domain resource allocation field of the active BWP may be populated with a zero padding (e.g., padded by adding one or more zero bits) until the frequency-domain resource allocation field sizes of the active BWP and the target BWP become equal, and the content of the frequency-domain resource allocation field of the target BWP may be determined.

In some cases, the base station 105 may transmit a message to the UE 115 that includes a BWP DCI having a null-assignment based on determining that cross-BWP scheduling is not supported. The base station 105 may transmit another message that includes scheduling DCI (e.g., uplink or downlink) after transmitting the message. In the second message, the base station 105 may schedule resources for the target BWP directly.

At block 715, the base station 105 or the UE 115 may determine whether the resources of the target BWP are nested or non-nested with the resources of the active BWP, or vice-versa. To make this determination, the base station 105 or the UE 115 may identify a frequency range of the target BWP and a frequency range of the active BWP. To determine if such frequency ranges are nested or not, the base station 105 or the UE 115 may compare the frequency ranges to determine if there is partial overlap of one or both, no overlap between them, or a total overlap of one of the BWPs. To be nested, the frequency range of the active BWP may be a subset of the frequency range of the target BWP or the frequency range of the target BWP may be a subset of the frequency range of the active BWP. Nested BWPs also include BWPs that have the same bandwidth and are completely overlapping. To be non-nested, the frequency range of the active BWP does not overlap with the frequency range of the target BWP or that the frequency range of the active BWP partially overlaps with the frequency range of the target BWP. How allocated resources are mapped from the active BWP to the target BWP may be based on whether the BWPs are nested or non-nested. Blocks 720-735 describe functions for nested BWPs and blocks 740-755 describe functions for non-nested BWPs. Alternatively, the base station 105 and the UE 115 may skip determining whether the target BWP is nested or non-nested with the active BWP, for example, as illustrated in FIG. 7B. In such cases, the base station 105 and/or the UE 115 may assume a non-nested operation even if the target BWP and the active BWP may be nested. In such cases, the resource allocation field content may be interpreted based on the active BWP and applied to the target BWP based on some mapping rule.

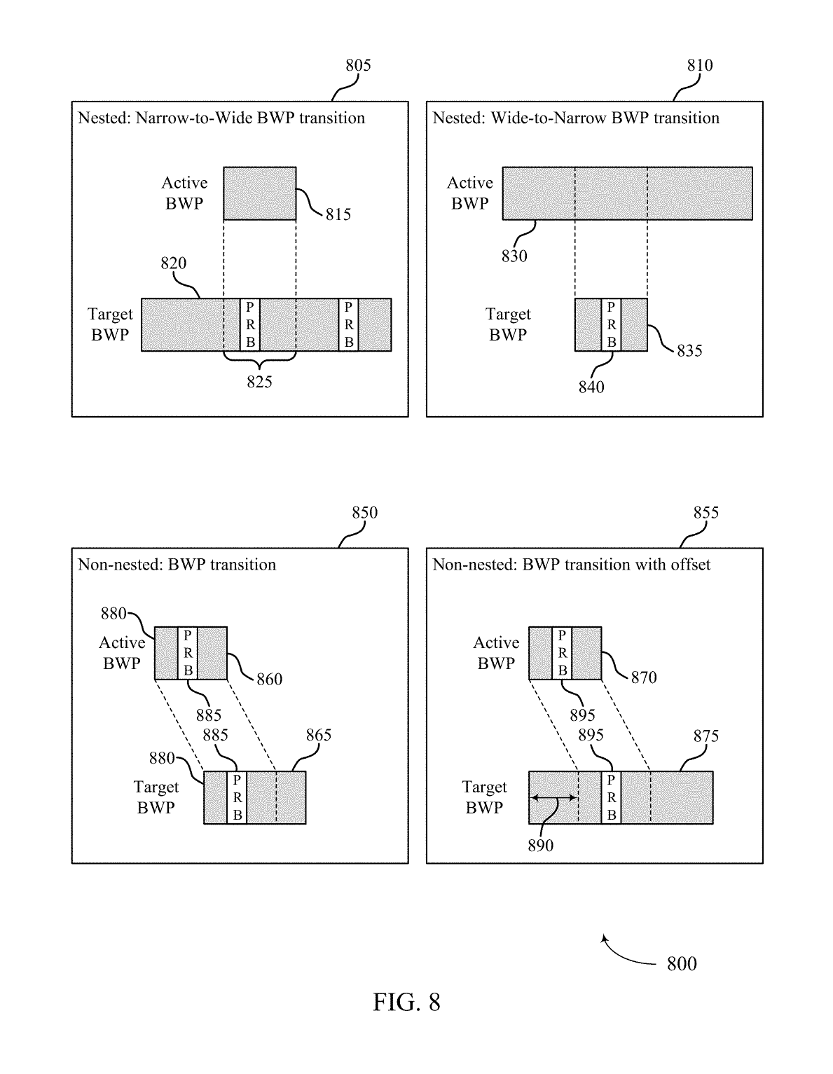

The techniques described for mapping between resources may include three options for mappings. A first option may include mapping a PRB of the active BWP to the same frequency location in the target BWP (e.g., diagrams 805 and 810 of FIG. 8). A second option may include mapping a PRB of the active BWP to a shifted frequency of the target BWP (e.g., diagrams 850 and 855 of FIG. 8). A third option may include mapping the resources of the active BWP to the target BWP with expanded granularity. The third option may be useful when the target BWP has a larger bandwidth or larger frequency range than the active BWP. In some cases, the expanded granularity may be used in conjunction with the first option or the second option. In some cases, the base station 105 and/or the UE 115 may select a mapping option for the BWP switching event. The mapping option may be specified in the communication specification, or it may be indicated in the same DCI carrying the resource allocation, or a combination of both (e.g. a subset of options is specified and the selection among them is indicated in DCI). In some cases, an indicator in the DCI may select one of the options, or the indicator may be based on some existing DCI field(s). For example, the HARQ process ID field of the DCI may be used to select one of the supported mapping options as follows. If there are two mapping options, a modulo 2 operation may be applied to the HARQ process ID field content and the outcome may be used to select one of the two mapping options. The HARQ process ID field may be used to communicate mapping options because, in some cases, not all of the supported 16 HARQ process IDs may be used for HARQ operation. The unused values of the HARQ process ID field may be leveraged for mapping option selection as described.

At block 720, the base station 105 or the UE 115 may map a PRB allocation of the active BWP to the target BWP. The resource allocation field may be interpreted based on the active BWP and the PRB allocation may be directly mapped to the target BWP. For example, as shown in diagram 805 and diagram 810 of FIG. 8. Specifically, diagram 805 shows an example where a narrower active BWP 815 is mapped to a wider target BWP 820. Range 825 shows the portion of the target BWP 820 that are schedulable based on control information for the active BWP 815. Here, resources common to both the active BWP 815 and the target BWP 820 are usable by the target BWP 820 based on messages received for the active BWP 815. Diagram 810 shows an example where a wider active BWP 830 is mapped to a narrower target BWP 835. Again, resources common to both the active BWP 830 and the target BWP 835 are usable by the target BWP 835 based on messages received for the active BWP 830.

At block 725, the base station 105 or the UE 115 may determine that a frequency range of the target BWP is narrower than the frequency range of the active BWP. Such a determination may not affect the mapping, but such a determination may change how a base station 105 allocates resources for the target BWP within a message intended for the active BWP.

For example, at block 730, the base station 105 or the UE 115 may determine that the frequency range of the BWP is narrower than the frequency range of the active BWP. Such a determination may be represented by the diagram 810 of FIG. 8.

At block 735, the base station 105 may identify communication resources common to both the active BWP 830 and the target BWP 835. The base station 105 may be configured to schedule the PRB 840 within the frequency range of the target BWP 835 even though the resource allocation is to be interpreted based on the active BWP 830. As such, at block 735, the base station 105 may position the PRB allocation in resources common to both the active BWP 830 and the target BWP 835. This is applicable to both Type 1 and/or Type 0 resource allocations.

Handling nested BWPs in such a manner may provide power savings. Basing the interpretation of a resource allocation on the active BWP offers an advantage that communication resources that overlap with a target BWP are schedulable by a BWP-switch-triggering DCI. As such, after a BWP-switching event, the overlapping portions of the target BWP may be scheduling before CQI for the target BWP is available. After CQI for the target BWP is available, the entire target BWP may be schedulable.

For cases where the BWPs in a BWP switching event are non-nested, or for cases where the nested case shall be bypassed and treated as non-nested for algorithm simplification, at block 740, the base station 105 or the UE 115 may apply one or more fixed alignment rules for mapping the resources of the active BWP indicated in the resource allocation message to the target BWP. Diagram 850 and diagram 855 of FIG. 8 show two examples of fixed alignment rules that may be applied during a BWP switching event for non-nested BWPs. For example, diagram 850 shows an example where an active BWP 860 is mapped to a target BWP 865 with no offset. Diagram 855 shows an example where an active BWP 870 is mapped to a target BWP 875 with an offset.

In some cases, at block 745, the base station 105 or the UE 115 may identify a reference location 880 of a PRB 885 within the active BWP 860. The reference location 880 may be configured as a feature common to both the active BWP 860 and the target BWP 865. For example, the reference location 880 may be a lowest frequency resource of the active BWP 860. If the base station 105 or the UE 115 knows the location of the PRB 885 relative to the reference location 880, the base station 105 or the UE 115 may be able to identify the PRB 885 for the target BWP 865 based on the reference location 880 and known relative distance that the PRB 885 is from the reference location 880. The base station 105 may use the reference location 880 to position the PRB 885 correctly and the UE 115 may use the reference location 880 to determine where the PRB 885 should be in the target BWP 865. In some examples using a fallback DCI, a reference location associated with the fallback DCI may be a lowest frequency resource (e.g., of the CORESET 0 bandwidth) of an active BWP as illustrated in 6B.

In some cases, at block 750, the base station 105 or the UE 115 may identify an offset 890 of the PRB 895 within the target BWP 875 relative to the location of the PRB 895 within the active BWP 870. The offset 890 may represent a displacement of the reference location 880 or the PRB 895 within the target BWP 875 relative to their respective locations within the active BWP 870. For example, the offset 890 may indicate that the lowest resource of the active BWP 870 be mapped to some other resource (other than the lowest resource) of the target BWP 875. For instance, the lowest resource of the active BWP 870 may be mapped to the lowest resource of the target BWP 875 plus three resources (e.g., the offset). In some cases, the offset 890 may be indicated in the DCI carrying the resource allocation. An indicator in the DCI may be used, or the indicator may be based on some existing DCI field(s). For example, the HARQ process ID field may be used to select one of the supported offsets, which can be predefined in the specifications or based on configurations. For example, the following offsets (in number of PRBs) may be supported: {0, 4, 8, 12}. A modulo 4 operation may be applied to HARQ process ID to select one of the four offsets. The granularity of the supported offsets may depend on any one of, and not limited to, the RBG size, the size of the target BWP, the relative difference between the target BWP and the active BWP, or any combination thereof.

At block 750, the base station 105 or the UE 115 may communicate using the target BWP. Once CQI is obtained for the target BWP, the base station 105 or the UE 115 may be able to exchange messages (e.g., scheduling messages) that directly relate to the target BWP.

FIG. 7B illustrates an example of a process flow 700B that supports signaling techniques for bandwidth parts in accordance with various aspects of the present disclosure. In some examples, the process flow 700B may implement aspects of the wireless communications systems 100 and 200. The process flow 700B may illustrate techniques for handling BWP switching events when DCI sizes (e.g., a size of information field included in a DCI, the information field including, e.g., a frequency-domain resource allocation field) are based on an active BWP. The process flow 700B may include functions performed by a base station 105, a UE 115, or both. The process flow may be used in connection with any of the message structures described with reference to FIG. 3.

At block 765, a base station 105 or a UE 115 may initiate a cross-BWP scheduling procedure. The cross-BWP scheduling procedure may be configured to allow for BWP switching when there is a mismatch between frequency-domain resources (e.g., a size of a frequency-domain resource allocation field) of an active BWP (e.g., a current BWP) and frequency-domain resources (e.g., a size of a frequency-domain resource allocation field indicated for a target BWP) of the target BWP (e.g., a new BWP). In a cross-BWP scheduling, DCI may be interpreted based on the active BWP. A physical resource block allocation of the active BWP may be mapped to the target BWP.

At block 770, a base station 105 or a UE 115 may determine whether cross-BWP scheduling is supported. In some cases, this determination may be based on the combination of BWPs involved in a BWP switching event.

At block 775, the base station 105 or the UE 115 may apply one or more fixed alignment rules for mapping the resources of the active BWP indicated in the resource allocation message to the target BWP. Diagram 850 and diagram 855 of FIG. 8 show two examples of fixed alignment rules that may be applied during a BWP switching event for non-nested BWPs. For example, diagram 850 shows an example where an active BWP 860 is mapped to a target BWP 865 with no offset. Diagram 855 shows an example where an active BWP 870 is mapped to a target BWP 875 with an offset.

In some cases, at block 780, the base station 105 or the UE 115 may identify a reference location 880 of a PRB 885 within the active BWP 860. The reference location 880 may be configured as a feature common to both the active BWP 860 and the target BWP 865. For example, the reference location 880 may be a lowest frequency resource of the active BWP 860. If the base station 105 or the UE 115 knows the location of the PRB 885 relative to the reference location 880, the base station 105 or the UE 115 may be able to identify the PRB 885 for the target BWP 865 based on the reference location 880 and known relative distance that the PRB 885 is from the reference location 880. The base station 105 may use the reference location 880 to position the PRB 885 correctly and the UE 115 may use the reference location 880 to determine where the PRB 885 should be in the target BWP 865.

In some cases, at block 785, the base station 105 or the UE 115 may identify an offset 890 of the PRB 895 within the target BWP 875 relative to the location of the PRB 895 within the active BWP 870. The offset 890 may represent a displacement of the reference location 880 or the PRB 895 within the target BWP 875 relative to their respective locations within the active BWP 870.

At block 790, the base station 105 or the UE 115 may communicate using the target BWP. Once CQI is obtained for the target BWP, the base station 105 or the UE 115 may be able to exchange messages (e.g., scheduling messages) that directly relate to the target BWP.

FIG. 8 illustrates an example of diagrams 800 that support signaling techniques for bandwidth parts in accordance with various aspects of the present disclosure. In some examples, the diagrams 800 may implement aspects of the wireless communications systems 100 and 200. The diagrams 800 may illustrate different types of BWP switching events and how mappings of different BWPs may be handled during the BWP switching event. For example, the diagrams 800 may include diagrams 805 and 810 for BWP switching events between nested BWPs and diagrams 850 and 855 for BWP switching events between non-nested BWPs.

The diagram 805 may show an example of a BWP switching event between a narrower active BWP 815 and wider target BWP 820. The diagram 810 may show an example of a BWP switching event between a wider active BWP 830 and a narrower target BWP 835. The diagram 850 may show an example of a BWP switching event for a non-nested active BWP 860 to a target BWP 865 without using an offset. The diagram 855 may show an example of a BWP switching event for a non-nested active BWP 870 with a target BWP 875 using an offset 890. Specific details about these BWP switching events are described with reference to FIG. 7.

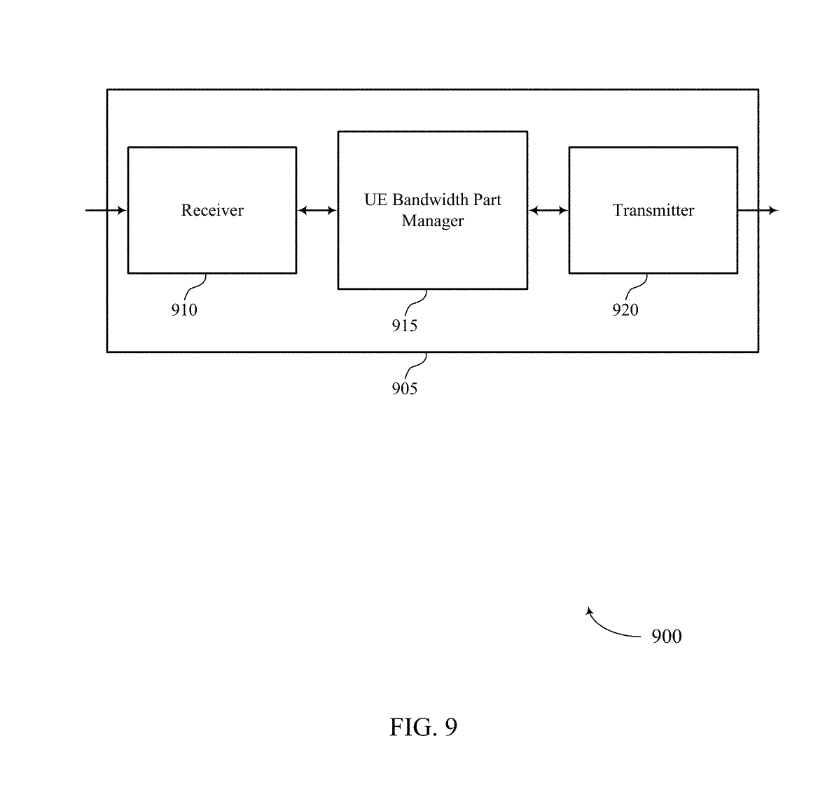

FIG. 9 shows a block diagram 900 of a wireless device 905 that supports signaling techniques for bandwidth parts in accordance with aspects of the present disclosure. Wireless device 905 may be an example of aspects of a user equipment (UE) 115 as described herein. Wireless device 905 may include receiver 910, UE bandwidth part manager 915, and transmitter 920. Wireless device 905 may also include a processor. Each of these components may be in communication with one another (e.g., via one or more buses).

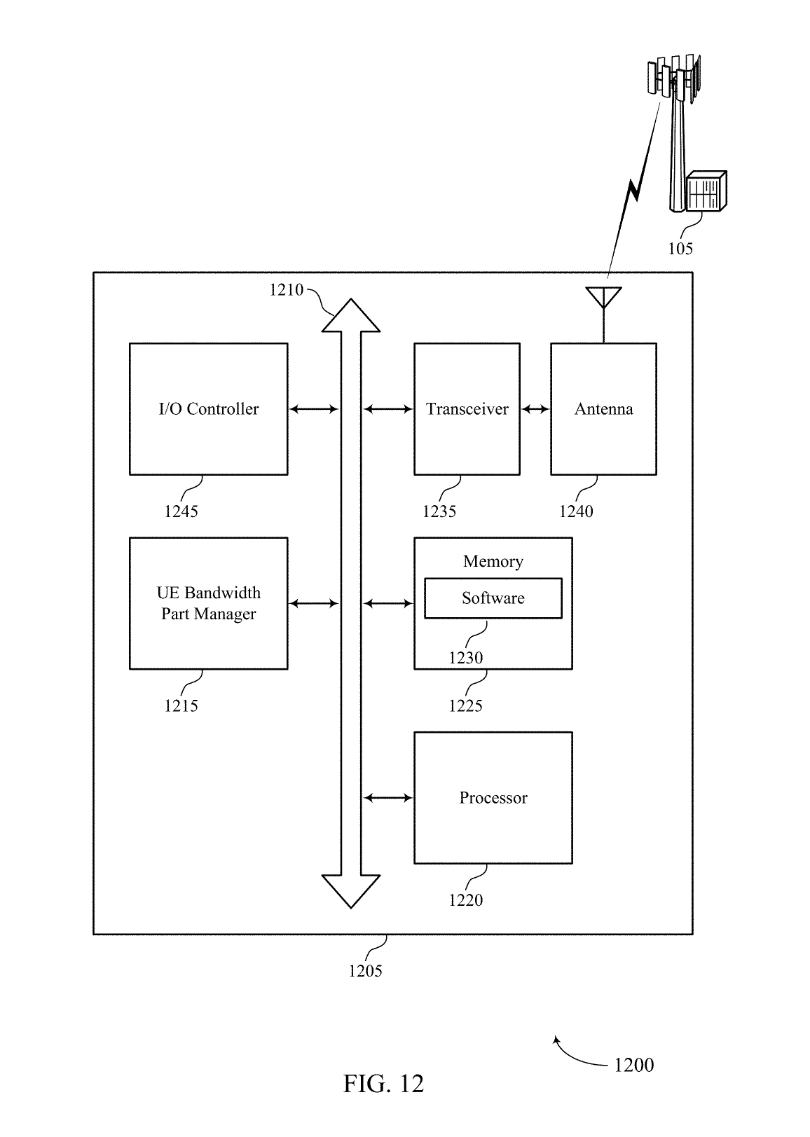

Receiver 910 may receive information such as packets, user data, or control information associated with various information channels (e.g., control channels, data channels, and information related to signaling techniques for bandwidth parts, etc.). Information may be passed on to other components of the device 905. The receiver 910 may be an example of aspects of the transceiver 1235 described with reference to FIG. 12. The receiver 910 may utilize a single antenna or a set of antennas.

UE bandwidth part manager 915 may be an example of aspects of the UE bandwidth part manager 1215 described with reference to FIG. 12.

UE bandwidth part manager 915 and/or at least some of its various sub-components may be implemented in hardware, software executed by a processor, firmware, or any combination thereof. If implemented in software executed by a processor, the functions of the UE bandwidth part manager 915 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The UE bandwidth part manager 915 and/or at least some of its various sub-components may be physically located at various positions, including being distributed such that portions of functions are implemented at different physical locations by one or more physical devices. In some examples, UE bandwidth part manager 915 and/or at least some of its various sub-components may be a separate and distinct component in accordance with various aspects of the present disclosure. In other examples, UE bandwidth part manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE bandwidth part manager 915 may receive downlink control information (DCI) that allocates communication resources to the UE 115 and includes a bandwidth part (BWP) of a carrier identifier field and a resource allocation field, the resource allocation field having a length that is based on a size of an active BWP of the carrier being used by the UE 115, identify a BWP switching event that causes the UE 115 to change from the active BWP to a target BWP of the carrier based on information included in the BWP identifier field, identify communication resources common to both the active BWP and the target BWP of the carrier based on information in the resource allocation field, and communicate with a base station 105 using a portion of communication resources of the target BWP of the carrier included in the resource allocation field, where the portion of communication resources includes the communication resources common to both the active BWP and the target BWP of the carrier. In some examples, the UE bandwidth part manager 915 may determine whether a frequency-domain resource allocation field of the target BWP is larger or smaller than a frequency-domain resource allocation field of the active BWP, where identifying the communication resources of the target BWP associated with the PRB allocation is based at least in part on determining whether the frequency-domain resource allocation field of the target BWP is larger or smaller than the frequency-domain resource allocation field of the active BWP. In some examples, the UE bandwidth part manager 915 may identify information based at least in part on a least significant bit of the DCI based at least in part on determining the frequency-domain resource allocation field of the target BWP is smaller than the frequency-domain resource allocation field of the active BWP. In some examples, the UE bandwidth part manager 915 may populate the frequency-domain resource allocation field of the active BWP with a zero padding based at least in part on determining the frequency-domain resource allocation field of the target BWP is larger than the frequency-domain resource allocation field of the active BWP.

The UE bandwidth part manager 915 may also monitor for non-fallback DCI and fallback DCI for an active bandwidth part (BWP) of a carrier, a length of the fallback DCI being based on a size of a reference BWP different than the active BWP of the carrier, determine the active BWP of the carrier of the UE 115 is out-of-sync with a base station, identify communication resources indicated in the fallback DCI based on determining the active BWP of the carrier of the UE 115 is out-of-sync with the base station, and communicate with the base station 105 using the communication resources indicated in the fallback DCI.

The UE bandwidth part manager 915 may receive DCI that allocates communication resources to the 115 and includes a bandwidth part (BWP) identifier field and a resource allocation field, the resource allocation field having a length that is based on a size of an active BWP being used by the UE 115, communicate with a base station 105 using the identified communication resources of the target BWP, identify a BWP switching event that causes the UE 115 to change from the active BWP to a target BWP based on information included in the BWP identifier field, and identify communication resources of the target BWP associated with a physical resource block (PRB) allocation in the active BWP based on identifying the BWP switching event.

Transmitter 920 may transmit signals generated by other components of the device 905. In some examples, the transmitter 920 may be collocated with a receiver 910 in a transceiver module. For example, the transmitter 920 may be an example of aspects of the transceiver 1235 described with reference to FIG. 12. The transmitter 920 may utilize a single antenna or a set of antennas.

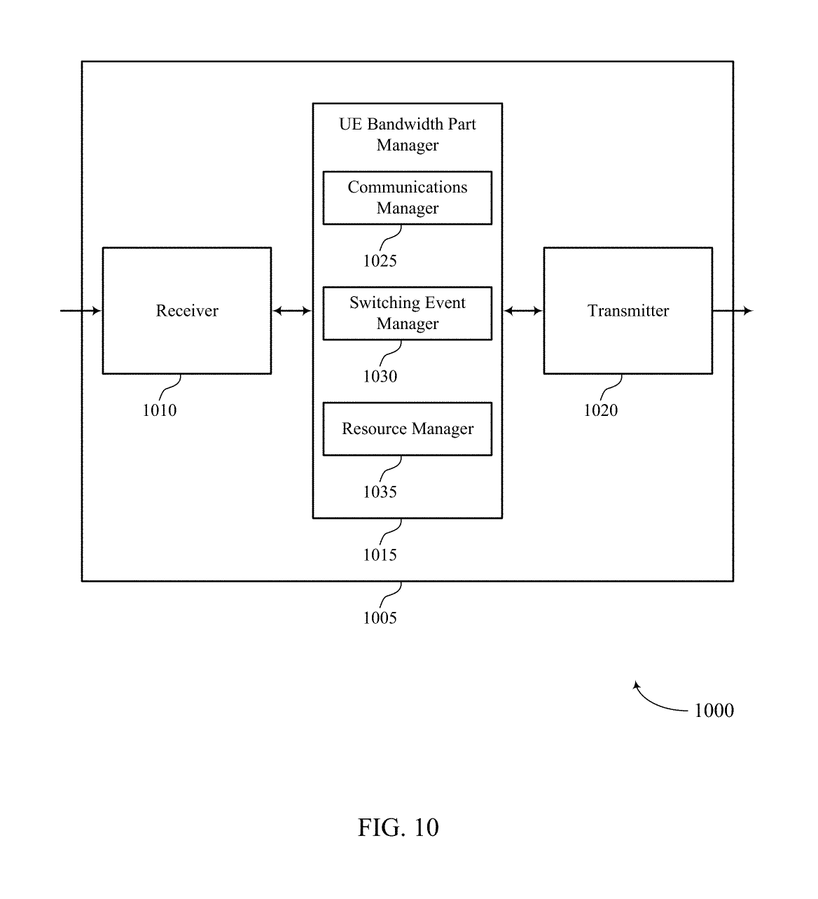

FIG. 10 shows a block diagram 1000 of a wireless device 1005 that supports signaling techniques for bandwidth parts in accordance with aspects of the present disclosure. Wireless device 1005 may be an example of aspects of a wireless device 905 or a UE 115 as described with reference to FIG. 9. Wireless device 1005 may include receiver 1010, UE bandwidth part manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to signaling techniques for bandwidth parts, etc.). Information may be passed on to other components of the device 1005. The receiver 1010 may be an example of aspects of the transceiver 1235 described with reference to FIG. 12. The receiver 1010 may utilize a single antenna or a set of antennas.

UE bandwidth part manager 1015 may be an example of aspects of the UE bandwidth part manager 1215 described with reference to FIG. 12. UE bandwidth part manager 1015 may also include communications manager 1025, switching event manager 1030, and resource manager 1035.

Communications manager 1025 may receive DCI that allocates communication resources to the UE 115 and includes a bandwidth part (BWP) of a carrier identifier field and a resource allocation field, the resource allocation field having a length that is based on a size of an active BWP of the carrier being used by the UE 115, communicate with a base station 105 using a portion of communication resources of the target BWP of the carrier included in the resource allocation field, where the portion of communication resources includes the communication resources common to both the active BWP and the target BWP of the carrier, receive a second DCI that allocates resources for the UE 115 using the target BWP of the carrier based on communicating with the base station 105 using the portion of the communication resources of the target BWP of the carrier, the second DCI including a second resource allocation field having a second length that is based on a size of the target BWP of the carrier being used by the UE 115, the second length being greater than the length of the resource allocation field in the DCI, communicate with the base station 105 using all communication resources of the target BWP of the carrier included in the resource allocation field of the second DCI, monitor for non-fallback DCI and fallback DCI for an active bandwidth part (BWP) of a carrier, a length of the fallback DCI being based on a size of a reference BWP different than the active BWP of the carrier, communicate with the base station 105 using the communication resources indicated in the fallback DCI, and receive information from the base station 105 to dynamically configure the reference BWP.

Communications manager 1025 may receive DCI that allocates communication resources to the UE 115 and includes a bandwidth part (BWP) of a carrier identifier field and a resource allocation field, the resource allocation field having a length that is based on a size of an active BWP of the carrier being used by the UE 115 and communicate with a base station 105 using the identified communication resources of the target BWP.

The communications manager 1025 may receive DCI that allocates communication resources to the UE 115 and includes a bandwidth part (BWP) identifier field and a resource allocation field, the resource allocation field having a length that is based on a size of an active BWP being used by the UE 115 and communicate with a base station 105 using the identified communication resources of the target BWP.

Switching event manager 1030 may identify a BWP switching event that causes the UE 115 to change from the active BWP to a target BWP of the carrier based on information included in the BWP identifier field.

Switching event manager 1030 may identify a BWP switching event that causes the UE 115 to change from the active BWP to a target BWP of the carrier based on information included in the BWP identifier field and determine that resources of the target BWP are non-nested with resources of the active BWP based on identifying the BWP switching event.

The switching event manager 1030 may identify a BWP switching event that causes the UE 115 to change from the active BWP to a target BWP based on information included in the BWP identifier field.

Resource manager 1035 may identify communication resources common to both the active BWP and the target BWP of the carrier based on information in the resource allocation field, determine the active BWP of the carrier of the UE 115 is out-of-sync with a base station, and identify communication resources indicated in the fallback DCI based on determining the active BWP of the carrier of the UE 115 is out-of-sync with the base station. In some cases, the length of the resource allocation field for the active BWP of the carrier is smaller than a second length of a second resource allocation field for the target BWP of the carrier. In some cases, the length of the resource allocation field for the active BWP of the carrier is insufficient to allocate all of the communication resources available in the target BWP of the carrier. In some cases, the DCI is a non-fallback DCI. In some cases, the length of the fallback DCI is independent of a size of the active BWP of the carrier. In some cases, the reference BWP is statically preconfigured.

Resource manager 1035 may identify communication resources of the target BWP associated with a physical resource block (PRB) allocation in the active BWP based on determining that the resources of the target BWP are non-nested with the resources of the active BWP.

The resource manager 1035 may identify communication resources of the target BWP associated with a physical resource block (PRB) allocation in the active BWP based on identifying the BWP switching event.

Transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1235 described with reference to FIG. 12. The transmitter 1020 may utilize a single antenna or a set of antennas.

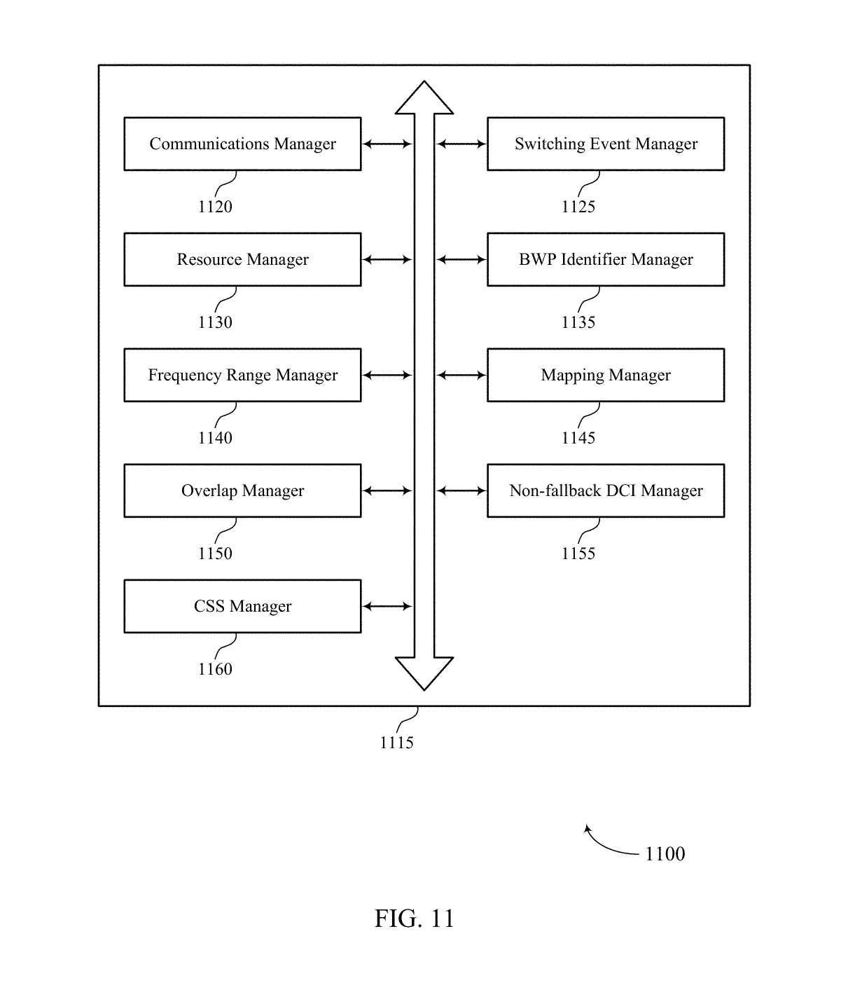

FIG. 11 shows a block diagram 1100 of a UE bandwidth part manager 1115 that supports signaling techniques for bandwidth parts in accordance with aspects of the present disclosure. The UE bandwidth part manager 1115 may be an example of aspects of a UE bandwidth part manager 915, a UE bandwidth part manager 1015, or a UE bandwidth part manager 1215 described with reference to FIGS. 9, 10, and 12. The UE bandwidth part manager 1115 may include communications manager 1120, switching event manager 1125, resource manager 1130, BWP identifier manager 1135, frequency range manager 1140, mapping manager 1145, overlap manager 1150, non-fallback DCI manager 1155, and CSS manager 1160. Each of these modules may communicate, directly or indirectly, with one another (e.g., via one or more buses).

Communications manager 1120 may receive DCI that allocates communication resources to the UE 115 and includes a bandwidth part (BWP) of a carrier identifier field and a resource allocation field, the resource allocation field having a length that is based on a size of an active BWP of the carrier being used by the UE 115, communicate with a base station 105 using a portion of communication resources of the target BWP of the carrier included in the resource allocation field, where the portion of communication resources includes the communication resources common to both the active BWP and the target BWP of the carrier, receive a second DCI that allocates resources for the UE 115 using the target BWP of the carrier based on communicating with the base station 105 using the portion of the communication resources of the target BWP of the carrier, the second DCI including a second resource allocation field having a second length that is based on a size of the target BWP of the carrier being used by the UE 115, the second length being greater than the length of the resource allocation field in the DCI, communicate with the base station 105 using all communication resources of the target BWP of the carrier included in the resource allocation field of the second DCI, monitor for non-fallback DCI and fallback DCI for an active bandwidth part (BWP) of a carrier, a length of the fallback DCI being based on a size of a reference BWP different than the active BWP of the carrier, communicate with the base station 105 using the communication resources indicated in the fallback DCI, and receive information from the base station 105 to dynamically configure the reference BWP.

Communications manager 1120 may receive DCI that allocates communication resources to the UE 115 and includes a bandwidth part (BWP) of a carrier identifier field and a resource allocation field, the resource allocation field having a length that is based on a size of an active BWP of the carrier being used by the UE 115 and communicate with a base station 105 using the identified communication resources of the target BWP.

The communications manager 1120 may receive DCI that allocates communication resources to the UE 115 and includes a bandwidth part (BWP) identifier field and a resource allocation field, the resource allocation field having a length that is based on a size of an active BWP being used by the UE 115. In some examples, the communications manager 1120 may communicate with a base station 105 using the identified communication resources of the target BWP.

Switching event manager 1125 may identify a BWP switching event that causes the UE 115 to change from the active BWP to a target BWP of the carrier based on information included in the BWP identifier field. Switching event manager 1125 may identify a BWP switching event that causes the UE 115 to change from the active BWP to a target BWP of the carrier based on information included in the BWP identifier field and determine that resources of the target BWP are non-nested with resources of the active BWP based on identifying the BWP switching event.

The switching event manager 1125 may identify a BWP switching event that causes the UE 115 to change from the active BWP to a target BWP based on information included in the BWP identifier field.

Resource manager 1130 may identify communication resources common to both the active BWP and the target BWP of the carrier based on information in the resource allocation field, determine the active BWP of the carrier of the UE 115 is out-of-sync with a base station, and identify communication resources indicated in the fallback DCI based on determining the active BWP of the carrier of the UE 115 is out-of-sync with the base station. In some cases, the length of the resource allocation field for the active BWP of the carrier is smaller than a second length of a second resource allocation field for the target BWP of the carrier. In some cases, the length of the resource allocation field for the active BWP of the carrier is insufficient to allocate all of the communication resources available in the target BWP of the carrier. In some cases, the DCI is a non-fallback DCI. In some cases, the length of the fallback DCI is independent of a size of the active BWP of the carrier. In some cases, the reference BWP is statically preconfigured.

Resource manager 1130 may identify communication resources of the target BWP associated with a physical resource block (PRB) allocation in the active BWP based on determining that the resources of the target BWP are non-nested with the resources of the active BWP. In some cases, the received DCI that allocates communication resources to the UE 115 allocates the communication resources on a resource block group (RBG)-by-RBG basis such that a single bit in the DCI indicates that more than one resource block (RB) is allocated for a BWP.

The resource manager 1130 may identify communication resources of the target BWP associated with a physical resource block (PRB) allocation in the active BWP based on identifying the BWP switching event.

BWP identifier manager 1135 may determine that the BWP identifier field of the DCI identifies a BWP different than the active BWP of the carrier being used by the UE 115 to communicate, where identifying the BWP switching event is based on determining that the BWP identifier field of the DCI identifies the BWP different than the active BWP of the carrier.

Frequency range manager 1140 may determine that a first frequency range of the active BWP of the carrier at least partially overlaps with a second frequency range of the target BWP of the carrier, where identifying the communication resources common to both the active BWP of the carrier and the target BWP of the carrier is based on determining that the first frequency range of the active BWP of the carrier at least partially overlaps with the second frequency range of the target BWP of the carrier and determine that a first frequency range of the reference BWP is a subset of a second frequency range of the active BWP of the carrier, where identifying the communication resources indicated in the fallback DCI is based on determining that the first frequency range of the reference BWP is the subset of the second frequency range of the active BWP of the carrier. In some cases, the second frequency range of the target BWP of the carrier is wider than the first frequency range of the active BWP of the carrier. In some cases, the first frequency range of the active BWP of the carrier is nested within the second frequency range of the target BWP of the carrier.

Frequency range manager 1140 may determine that a portion of a frequency range of the target BWP is exclusive of a frequency range of the active BWP and determine that the a portion of the frequency range of the active BWP is exclusive of the frequency range of the target BWP, where determining that the resources of the target BWP are non-nested with the resources of the active BWP is based on the determinations.

The frequency range manager 1140 may determine whether a frequency range of the target BWP is wider or narrower than a frequency range of the active BWP, where identifying the communication resources of the target BWP associated with the PRB allocation is based on determining whether the frequency range of the target BWP is wider or narrower than the frequency range of the active BWP.

Mapping manager 1145 may map communication resources included in the resource allocation field for the active BWP of the carrier to communication resources for the target BWP of the carrier, where identifying the communication resources common to both the active BWP of the carrier and the target BWP of the carrier is based on mapping the communication resources included in the resource allocation field for the active BWP of the carrier to communication resources for the target BWP of the carrier.

Mapping manager 1145 may identify a reference location of the PRB allocation in the active BWP, where identifying the communication resources of the target BWP associated with the PRB allocation is based on identifying the reference location, identify an offset relative to the reference location associated with the target BWP, identifying the communication resources of the target BWP associated with the PRB allocation is based on identifying the offset, map the resources of the active BWP to the resources of the target BWP based on determining that the resources of the target BWP are non-nested with the resources of the active BWP, where identifying the communication resources of the target BWP associated with the PRB allocation is based on mapping the resources, and map the resources of the active BWP to the resources of the target BWP based on determining that the resources of the target BWP are nested with the resources of the active BWP, where identifying the communication resources common to both the active BWP and the target BWP is based on mapping the resources. In some cases, the reference location is a lowest frequency resource of the active BWP.

The mapping manager 1145 may identify a reference location of the PRB allocation in the active BWP, where identifying the communication resources of the target BWP associated with the PRB allocation is based on identifying the reference location. In some examples, the mapping manager 1145 may identify an offset relative to the reference location associated with the target BWP, identifying the communication resources of the target BWP associated with the PRB allocation is based on identifying the offset.

In some examples, the mapping manager 1145 may map the resources of the active BWP to the resources of the target BWP based on identifying the BWP switching event, where identifying the communication resources of the target BWP associated with the PRB allocation is based on mapping the resources.

In some examples, the mapping manager 1145 may determine a mapping option that indicates how resources of the active BWP are mapped to resources of the target BWP during the BWP switching event based on the DCI received from the base station, where mapping the resources is based on determining the mapping option. In some cases, the DCI includes an indicator of the offset. In some cases, the offset may be based on a resource block group size, the size of the target BWP, a difference between the active BWP and the target BWP, or any combination thereof. In some cases, the reference location is a lowest frequency resource of the active BWP. In some cases, the DCI includes a mapping field indicating the mapping option. In some cases, a hybrid automation repeat request (HARQ) process identifier field of the DCI includes an indication of the mapping option. In some cases, the mapping option includes a modulo operation.

Overlap manager 1150 may determine that a first frequency range of the active BWP of the carrier does not overlap with a second frequency range of the target BWP of the carrier and refrain from transmitting or receiving signals using the communication resources of the DCI based on determining that the first frequency range of the active BWP of the carrier does not overlap with the second frequency range of the target BWP of the carrier.

Overlap manager 1150 may determine whether a frequency range of the target BWP is wider or narrower than a frequency range of the active BWP, where identifying the communication resources of the target BWP associated with the PRB allocation is based on determining whether the frequency range of the target BWP is wider or narrower than the frequency range of the active BWP, truncate information based on the frequency range of the target BWP being narrower than the frequency range of the active BWP, where communicating with the base station 105 using the identified communication resources of the target BWP is based on truncating the information, determine that resources of the target BWP are nested with resources of the active BWP, where identifying the communication resources common to both the active BWP and the target BWP of the carrier is based on determining that the resources of the target BWP are nested with the resources of the active BWP, and determine that a first frequency range of the target BWP overlaps entirely with a second frequency range of the target BWP or the second frequency range of the target BWP overlaps entirely with the first frequency range of the active BWP, where determining that the resources are nested is based at least in part on determining that one frequency range overlaps entirely with another frequency range.

The overlap manager 1150 may truncate information based on the frequency range of the target BWP being narrower than the frequency range of the active BWP, where communicating with the base station 105 using the identified communication resources of the target BWP is based on truncating the information.

Non-fallback DCI manager 1155 may determine that the non-fallback DCI failed to be successfully decoded, where determining the active BWP of the carrier of the UE 115 is out-of-sync with the base station 105 is based on determining that the non-fallback DCI failed to be successfully decoded.

CSS manager 1160 may identify that a control search space (CSS) of the active BWP of the carrier is identical to a CSS of the reference BWP, where identifying the communication resources indicated in the fallback DCI is based on identifying that the CSS of the active BWP of the carrier is identical to the CSS of the reference BWP.

FIG. 12 shows a diagram of a system 1200 including a device 1205 that supports signaling techniques for bandwidth parts in accordance with aspects of the present disclosure. Device 1205 may be an example of or include the components of wireless device 905, wireless device 1005, or a UE 115 as described above, e.g., with reference to FIGS. 9 and 10. Device 1205 may include components for bi-directional voice and data communications including components for transmitting and receiving communications, including UE bandwidth part manager 1215, processor 1220, memory 1225, software 1230, transceiver 1235, antenna 1240, and I/O controller 1245. These components may be in electronic communication via one or more buses (e.g., bus 1210). Device 1205 may communicate wirelessly with one or more base stations 105.

Processor 1220 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting signaling techniques for bandwidth parts).

Memory 1225 may include random access memory (RAM) and read only memory (ROM). The memory 1225 may store computer-readable, computer-executable software 1230 including instructions that, when executed, cause the processor to perform various functions described herein. In some cases, the memory 1225 may contain, among other things, a basic input/output system (BIOS) which may control basic hardware or software operation such as the interaction with peripheral components or devices.

Software 1230 may include code to implement aspects of the present disclosure, including code to support signaling techniques for bandwidth parts. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device 1205 may include a single antenna 1240. However, in some cases the device 1205 may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

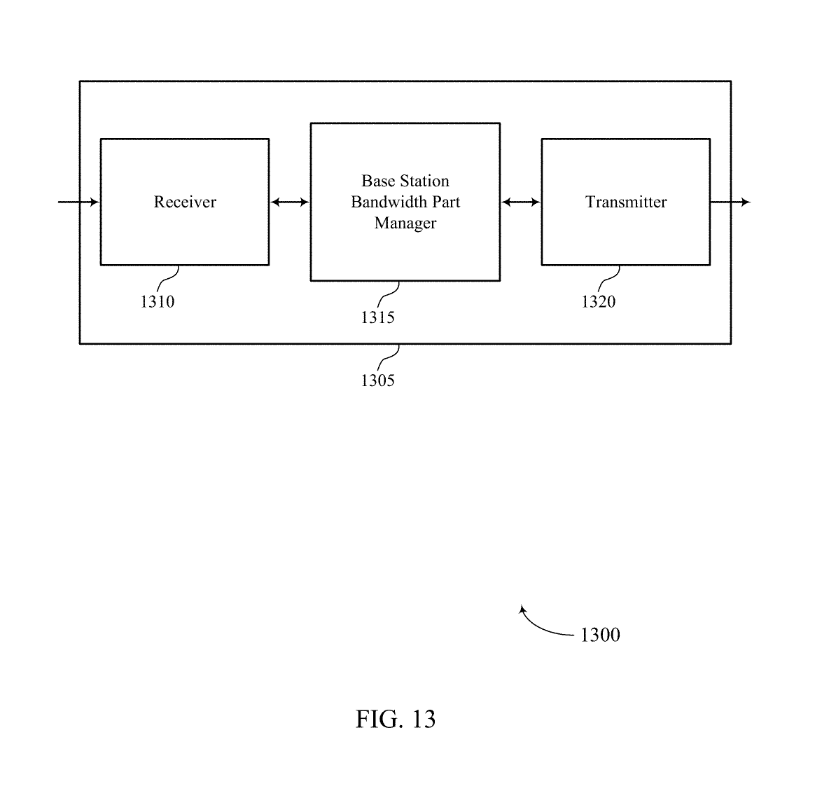

FIG. 13 shows a block diagram 1300 of a wireless device 1305 that supports signaling techniques for bandwidth parts in accordance with aspects of the present disclosure. Wireless device 1305 may be an example of aspects of a base station 105 as described herein. Wireless device 1305 may include receiver 1310, base station bandwidth part manager 1315, and transmitter 1320. Wireless device 1305 may also include a processor. Each of these components may be in communication with one another (e.g., via one or more buses).

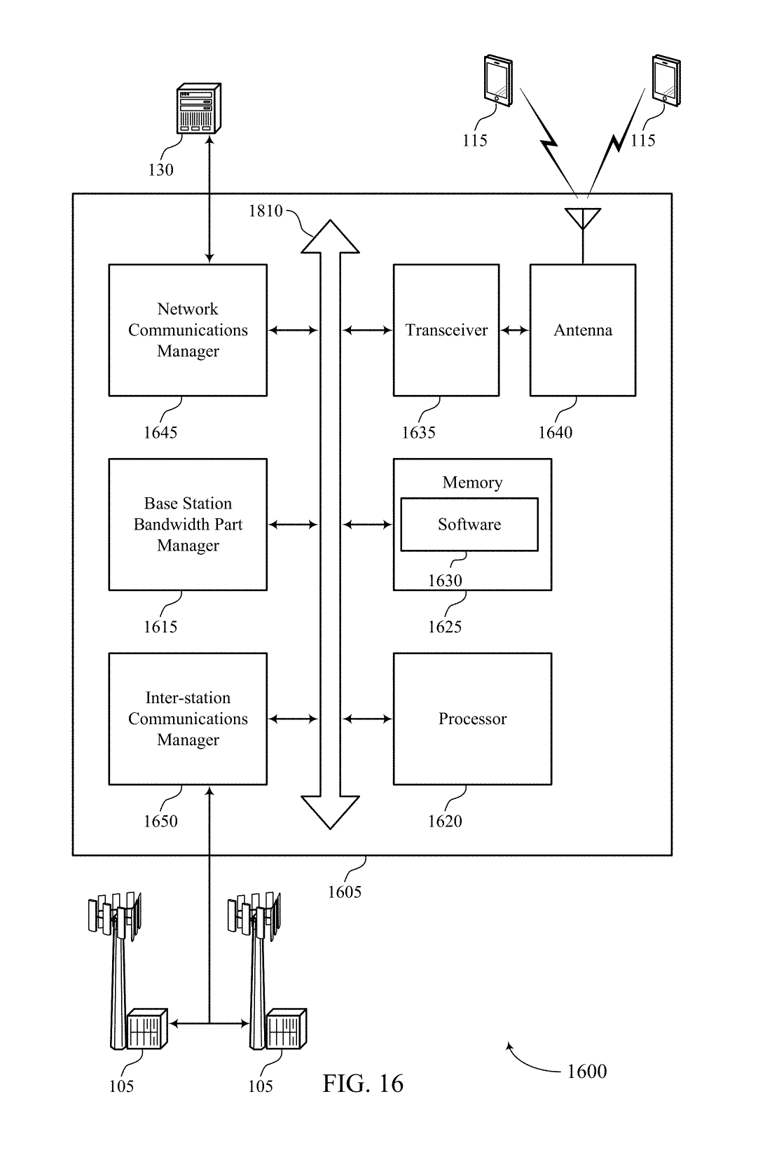

Receiver 1310 may receive information such as packets, user data, or control information associated with various information channels (e.g., control channels, data channels, and information related to signaling techniques for bandwidth parts, etc.). Information may be passed on to other components of the device. The receiver 1310 may be an example of aspects of the transceiver 1635 described with reference to FIG. 16. The receiver 1310 may utilize a single antenna or a set of antennas.

Base station bandwidth part manager 1315 may be an example of aspects of the base station bandwidth part manager 1615 described with reference to FIG. 16.

Base station bandwidth part manager 1315 and/or at least some of its various sub-components may be implemented in hardware, software executed by a processor, firmware, or any combination thereof. If implemented in software executed by a processor, the functions of the base station bandwidth part manager 1315 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The base station bandwidth part manager 1315 and/or at least some of its various sub-components may be physically located at various positions, including being distributed such that portions of functions are implemented at different physical locations by one or more physical devices. In some examples, base station bandwidth part manager 1315 and/or at least some of its various sub-components may be a separate and distinct component in accordance with various aspects of the present disclosure. In other examples, base station bandwidth part manager 1315 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Base station bandwidth part manager 1315 may identify a target bandwidth part (BWP) of a carrier to be used to communicate with a UE 115 different from an active BWP of the carrier being used to communicate with the UE 115, generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115, transmit the DCI to the UE 115, and communicate with the UE 115 using a portion of communication resources of the target BWP of the carrier included in the resource allocation field, where the portion of communication resources includes communication resources common to both the active BWP of the carrier and the target BWP of the carrier. The base station bandwidth part manager 1315 may also generate non-fallback DCI for an active bandwidth part (BWP) of a carrier, a length of the non-fallback DCI being based on a size of the active BWP of the carrier, generate fallback DCI for a reference BWP, a length of the fallback DCI being based on a size of a reference BWP different than the active BWP of the carrier, transmit the non-fallback DCI and the fallback DCI to a UE 115, and communicate with the UE 115 using the communication resources indicated in the fallback DCI. In some examples, the base station bandwidth part manager 1315 may configure the UE 115 to determine whether a frequency-domain resource allocation field of the target BWP is larger or smaller than a frequency-domain resource allocation field of the active BWP, where identifying the communication resources of the target BWP associated with the PRB allocation is based at least in part on determining whether the frequency-domain resource allocation field of the target BWP is larger or smaller than the frequency-domain resource allocation field of the active BWP. In some examples, the base station bandwidth part manager 1315 may configure the UE 115 to identify information based at least in part on a least significant bit of the DCI based at least in part determining that the frequency-domain resource allocation field of the target BWP is smaller than the frequency-domain resource allocation field of the active BWP. In some cases, the base station bandwidth part manager 1315 may configure the UE 115 to populate the frequency-domain resource allocation field of the active BWP with a zero padding (e.g., padding with one or more zero bits) based at least in part on determining that the frequency-domain resource allocation field of the target BWP is larger than the frequency-domain resource allocation field of the active BWP.

The base station bandwidth part manager 1315 may identify a target bandwidth part (BWP) of a carrier to be used to communicate with a UE 115 different from an active BWP of the carrier being used to communicate with the UE 115, identify communication resources of the target BWP associated with a physical resource block (PRB) allocation in the active BWP based on identifying the BWP switching event, generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115, transmit the DCI to the UE 115, and communicate with the UE 115 using a portion of communication resources of the target BWP of the carrier included in the resource allocation field.

Transmitter 1320 may transmit signals generated by other components of the device 1305. In some examples, the transmitter 1320 may be collocated with a receiver 1310 in a transceiver module. For example, the transmitter 1320 may be an example of aspects of the transceiver 1635 described with reference to FIG. 16. The transmitter 1320 may utilize a single antenna or a set of antennas.

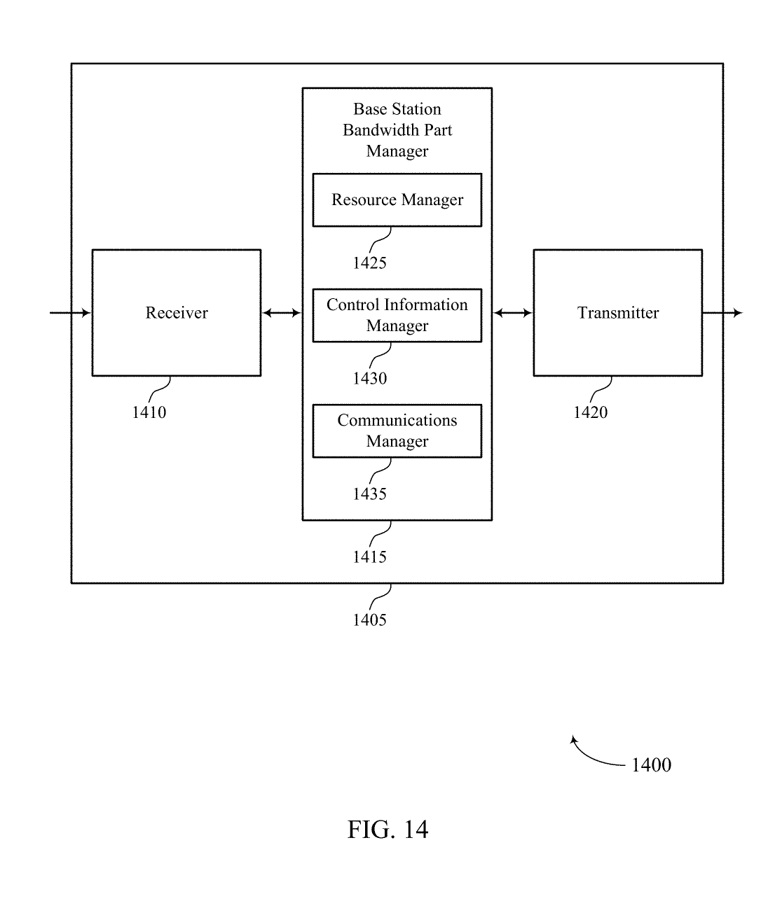

FIG. 14 shows a block diagram 1400 of a wireless device 1405 that supports signaling techniques for bandwidth parts in accordance with aspects of the present disclosure. Wireless device 1405 may be an example of aspects of a wireless device 1305 or a base station 105 as described with reference to FIG. 13. Wireless device 1405 may include receiver 1410, base station bandwidth part manager 1415, and transmitter 1420. Wireless device 1405 may also include a processor. Each of these components may be in communication with one another (e.g., via one or more buses).

Receiver 1410 may receive information such as packets, user data, or control information associated with various information channels (e.g., control channels, data channels, and information related to signaling techniques for bandwidth parts, etc.). Information may be passed on to other components of the device 1405. The receiver 1410 may be an example of aspects of the transceiver 1635 described with reference to FIG. 16. The receiver 1410 may utilize a single antenna or a set of antennas.

Base station bandwidth part manager 1415 may be an example of aspects of the base station bandwidth part manager 1615 described with reference to FIG. 16. Base station bandwidth part manager 1415 may also include resource manager 1425, control information manager 1430, and communications manager 1435.

Resource manager 1425 may identify a target bandwidth part (BWP) of a carrier to be used to communicate with a UE 115 different from an active BWP of the carrier being used to communicate with the UE 115. In some cases, the length of the resource allocation field for the active BWP of the carrier is smaller than a second length of a second resource allocation field for the target BWP of the carrier. In some cases, the length of the resource allocation field for the active BWP of the carrier is insufficient to allocate all of the communication resources available in the target BWP of the carrier. In some cases, the DCI is a non-fallback DCI.

Resource manager 1425 may identify a target bandwidth part (BWP) of a carrier to be used to communicate with a UE 115 different from an active BWP of the carrier being used to communicate with the UE 115, determine that resources of the target BWP are non-nested with resources of the active BWP based on identifying the BWP switching event, and identify communication resources of the target BWP associated with a physical resource block (PRB) allocation in the active BWP based on determining that the resources of the target BWP are non-nested with the resources of the active BWP.

The resource manager 1425 may identify a target bandwidth part (BWP) of a carrier to be used to communicate with a UE 115 different from an active BWP of the carrier being used to communicate with the UE 115 and identify communication resources of the target BWP associated with a physical resource block (PRB) allocation in the active BWP based on identifying the BWP switching event.

Control information manager 1430 may generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115, generate non-fallback DCI for an active bandwidth part (BWP) of a carrier, a length of the non-fallback DCI being based on a size of the active BWP of the carrier, and generate fallback DCI for a reference BWP, a length of the fallback DCI being based on a size of a reference BWP different than the active BWP of the carrier. In some cases, the length of the fallback DCI is independent of the size of the active BWP of the carrier.

Control information manager 1430 may generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115.

The control information manager 1430 may generate DCI that allocates communication resources to the UE 115 and includes a BWP identifier field and a resource allocation field, the resource allocation field indicating communication resources of the target BWP of the carrier to be used by the UE and the resource allocation field having a length that is based on a size of the active BWP of the carrier being used by the UE 115.

Communications manager 1435 may transmit the DCI to the UE 115, communicate with the UE 115 using a portion of communication resources of the target BWP of the carrier included in the resource allocation field, where the portion of communication resources includes communication resources common to both the active BWP of the carrier and the target BWP of the carrier, transmit the non-fallback DCI and the fallback DCI to a UE 115, and communicate with the UE 115 using the communication resources indicated in the fallback DCI.

Communications manager 1435 may transmit the DCI to the UE 115 and communicate with the UE 115 using a portion of communication resources of the target BWP of the carrier included in the resource allocation field.

The communications manager 1435 may transmit the DCI to the UE 115 and communicate with the UE 115 using a portion of communication resources of the target BWP of the carrier included in the resource allocation field.

Transmitter 1420 may transmit signals generated by other components of the device 1405. In some examples, the transmitter 1420 may be collocated with a receiver 1410 in a transceiver module. For example, the transmitter 1420 may be an example of aspects of the transceiver 1635 described with reference to FIG. 16. The transmitter 1420 may utilize a single antenna or a set of antennas.

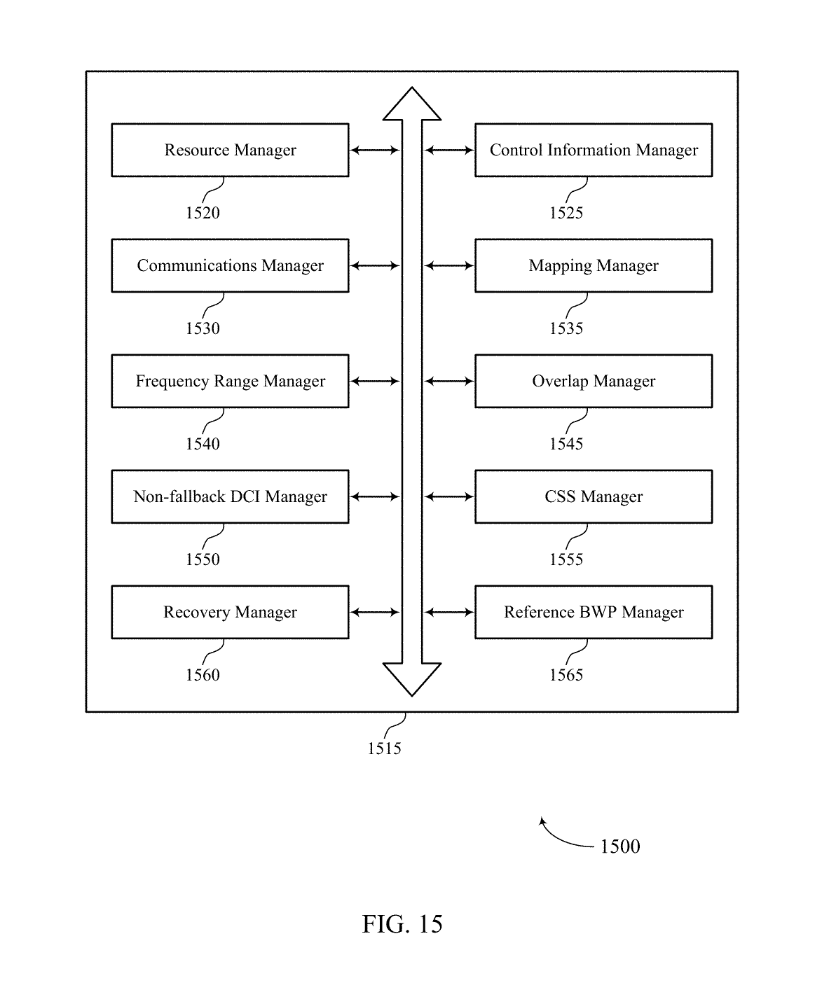

FIG. 15 shows a block diagram 1500 of a base station bandwidth part manager 1515 that supports signaling techniques for bandwidth parts in accordance with aspects of the present disclosure. The base station bandwidth part manager 1515 may be an example of aspects of a base station bandwidth part manager described with reference to FIGS. 13, 14, and 16. The base station bandwidth part manager 1515 may include resource manager 1520, control information manager 1525, communications manager 1530, mapping manager 1535, frequency range manager 1540, overlap manager 1545, non-fallback DCI manager 1550, CSS manager 1555, recovery manager 1560, and reference BWP manager 1565. Each of these modules may communicate, directly or indirectly, with one another (e.g., via one or more buses).

Resource manager 1520 may identify a target bandwidth part (BWP) of a carrier to be used to communicate with a UE 115 different from an active BWP of the carrier being used to communicate with the UE 115. In some cases, the length of the resource allocation field for the active BWP of the carrier is smaller than a second length of a second resource allocation field for the target BWP of the carrier. In some cases, the length of the resource allocation field for the active BWP of the carrier is insufficient to allocate all of the communication resources available in the target BWP of the carrier. In some cases, the DCI is a non-fallback DCI.

Resource manager 1520 may identify a target bandwidth part (BWP) of a carrier to be used to communicate with a UE 115 different from an active BWP of the carrier being used to communicate with the UE 115, determine that resources of the target BWP are non-nested with resources of the active BWP based on identifying the BWP switching event, and identify communication resources of the target BWP associated with a physical resource block (PRB) allocation in the active BWP based on determining that the resources of the target BWP are non-nested with the resources of the active BWP. Resource manager 1520 may allocate the communication resources to the target BWP of the UE 115 on a resource block group (RBG)-by-RBG basis, where the a single bit in the DCI indicates that more than one resource block (RB) is allocated for the target BWP.

The resource manager 1520 may identify a target bandwidth part (BWP) of a carrier to be used to communicate with a UE 115 different from an active BWP of the carrier being used to communicate with the UE 115. In some examples, the resource manager 1520 may identify communication resources of the target BWP associated with a physical resource block (PRB) allocation in the active BWP based on identifying the BWP switching event.

Control information manager 1525 may generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115, generate non-fallback DCI for an active bandwidth part (BWP) of a carrier, a length of the non-fallback DCI being based on a size of the active BWP of the carrier, and generate fallback DCI for a reference BWP, a length of the fallback DCI being based on a size of a reference BWP different than the active BWP of the carrier. In some cases, the length of the fallback DCI is independent of the size of the active BWP of the carrier.

Control information manager 1525 may generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115.

The control information manager 1525 may generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115.

Communications manager 1530 may transmit the DCI to the UE 115, communicate with the UE 115 using a portion of communication resources of the target BWP of the carrier included in the resource allocation field, where the portion of communication resources includes communication resources common to both the active BWP of the carrier and the target BWP of the carrier, transmit the non-fallback DCI and the fallback DCI to a UE 115, and communicate with the UE using the communication resources indicated in the fallback DCI.

Communications manager 1530 may transmit the DCI to the UE 115 and communicate with the UE 115 using a portion of communication resources of the target BWP of the carrier included in the resource allocation field.

The communications manager 1530 may transmit the DCI to the UE 115. In some examples, the communications manager 1530 may communicate with the UE 115 using a portion of communication resources of the target BWP of the carrier included in the resource allocation field.

Mapping manager 1535 may map communication resources of the target BWP of the carrier allocated to the UE 115 in the resource allocation field to communication resources of the active BWP of the carrier, where generating the DCI is based on mapping the communication resources of the target BWP of the carrier allocated to the UE 115 in the resource allocation field to communication resources of the active BWP of the carrier.

Mapping manager 1535 may identify a reference location of the PRB allocation in the active BWP, where identifying the communication resources of the target BWP associated with the PRB allocation is based on identifying the reference location, identify an offset relative to the reference location associated with the target BWP, identifying the communication resources of the target BWP associated with the PRB allocation is based on identifying the offset, map the resources of the active BWP to the resources of the target BWP based on determining that the resources of the target BWP are non-nested with the resources of the active BWP, where identifying the communication resources of the target BWP associated with the PRB allocation is based on mapping the resources, and map the resources of the active BWP to the resources of the target BWP based on determining that the resources of the target BWP are nested with the resources of the active BWP, where identifying the communication resources common to both the active BWP and the target BWP is based on mapping the resources. In some cases, the reference location is a lowest frequency of the active BWP.

The mapping manager 1535 may identify a reference location of the PRB allocation in the active BWP, where identifying the communication resources of the target BWP associated with the PRB allocation is based on identifying the reference location. In some examples, the mapping manager 1535 may identify an offset relative to the reference location associated with the target BWP, identifying the communication resources of the target BWP associated with the PRB allocation is based on identifying the offset. In some examples, the mapping manager 1535 may map the resources of the active BWP to the resources of the target BWP based on identifying the BWP switching event, where identifying the communication resources of the target BWP associated with the PRB allocation is based on mapping the resources.

In some examples, the mapping manager 1535 may determine a mapping option that indicates how resources of the active BWP are mapped to resources of the target BWP during the BWP switching event based on the DCI received from the base station, where mapping the resources is based on determining the mapping option. In some cases, the DCI includes an indicator of the offset. In some cases, the offset may be based on a resource block group size, the size of the target BWP, a difference between the active BWP and the target BWP, or any combination thereof. In some cases, the reference location is a lowest frequency of the active BWP. In some cases, the DCI includes a mapping field indicating the mapping option. In some cases, a hybrid automation repeat request (HARQ) process identifier field of the DCI includes an indication of the mapping option. In some cases, the mapping option includes a modulo operation.

Frequency range manager 1540 may determine that a first frequency range of the active BWP of the carrier at least partially overlaps with a second frequency range of the target BWP of the carrier, where generating the DCI is based on determining that the first frequency range of the active BWP of the carrier at least partially overlaps with the second frequency range of the target BWP of the carrier and determine that a first frequency range of the reference BWP is a subset of a second frequency range of the active BWP of the carrier, where generating the fallback DCI is based on determining that the first frequency range of the reference BWP is the subset of the second frequency range of the active BWP of the carrier. In some cases, the second frequency range of the target BWP of the carrier is wider than the first frequency range of the active BWP of the carrier. In some cases, the first frequency range of the active BWP of the carrier is nested within the second frequency range of the target BWP of the carrier.

Frequency range manager 1540 may determine that a portion of a frequency range of the target BWP is exclusive of a frequency range of the active BWP and determine that the a portion of the frequency range of the active BWP is exclusive of the frequency range of the target BWP, where determining that the resources of the target BWP are non-nested with the resources of the active BWP is based on the determinations.

The frequency range manager 1540 may determine whether a frequency range of the target BWP is wider or narrower than a frequency range of the active BWP, where identifying the communication resources of the target BWP associated with the PRB allocation is based on determining whether the frequency range of the target BWP is wider or narrower than the frequency range of the active BWP.

Overlap manager 1545 may determine that a first frequency range (e.g., size of frequency-domain resource allocation field, a bit field size, etc.) of the active BWP of the carrier does not overlap with a second frequency range of the target BWP of the carrier and populate the resource allocation field with a zero assignment based on determining that the first frequency range of the active BWP of the carrier does not overlap with the second frequency range of the target BWP of the carrier.

Overlap manager 1545 may determine whether a frequency range of the target BWP is wider or narrower than a frequency range of the active BWP, where identifying the communication resources of the target BWP associated with the PRB allocation is based on determining whether the frequency range of the target BWP is wider or narrower than the frequency range of the active BWP, truncate information based on the frequency range of the target BWP being narrower than the frequency range of the active BWP, where communicating with the base station 105 using the identified communication resources of the target BWP is based on truncating the information, identify communication resources common to both the active BWP and the target BWP, position a physical resource block allocation (PRB) associated with the target BWP within the identified communication resources common to both the active BWP and the target BWP, determine that resources of the target BWP are nested with resources of the active BWP, where identifying the communication resources common to both the active BWP and the target BWP of the carrier is based on determining that the resources of the target BWP are nested with the resources of the active BWP, and determine that a first frequency range of the target BWP overlaps entirely with a second frequency range of the target BWP or the second frequency range of the target BWP overlaps entirely with the first frequency range of the active BWP, where determining that the resources are nested is based at least in part on determining that one frequency range overlaps entirely with another frequency range.

The overlap manager 1545 may truncate information based on the frequency range (e.g., size of frequency-domain resource allocation field, a bit field size, etc.) of the target BWP being narrower than the frequency range (e.g., size of frequency-domain resource allocation field, a bit field size, etc.) of the active BWP, where communicating with the base station 105 using the identified communication resources of the target BWP is based on truncating the information. For example, if a size of a bit field of the active BWP is larger than a size of a bit field indicated for the target BWP by, e.g., a BWP indicator, then the overlap manager 1545 may identify information based on a least significant bit of the DCI.

Non-fallback DCI manager 1550 may determine that the non-fallback DCI failed to be successfully decoded by the UE 115 based on communicating with the UE 115 using the communication resources indicated in the fallback DCI.

CSS manager 1555 may identify that a control search space (CSS) of the active BWP of the carrier is identical to a CSS of the reference BWP, where generating the fallback DCI is based on identifying that the CSS of the active BWP of the carrier is identical to the CSS of the reference BWP.

Recovery manager 1560 may request that the UE 115 inform the base station 105 what is the active BWP of the carrier being used by the UE 115 based on communicating with the UE 115 using the communication resources indicated in the fallback DCI, modify the active BWP of the carrier of the base station 105 based on the active BWP of the carrier of the UE 115, allow a timer associated with the active BWP of the carrier to expire while communicating with the UE 115 using the communication resources indicated in the fallback DCI, and establish a new BWP with the UE 115 based on the timer expiring.

Reference BWP manager 1565 may identify the reference BWP and transmit information to the UE 115 to dynamically configure the reference BWP. In some cases, the reference BWP is statically preconfigured.

FIG. 16 shows a diagram of a system 1600 including a device 1605 that supports signaling techniques for bandwidth parts in accordance with aspects of the present disclosure. Device 1605 may be an example of or include the components of base station 105 as described above, e.g., with reference to FIG. 1. Device 1605 may include components for bi-directional voice and data communications including components for transmitting and receiving communications, including base station bandwidth part manager 1615, processor 1620, memory 1625, software 1630, transceiver 1635, antenna 1640, network communications manager 1645, and inter-station communications manager 1650. These components may be in electronic communication via one or more buses (e.g., bus 1610). Device 1605 may communicate wirelessly with one or more UEs 115.

Processor 1620 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1620 may be configured to operate a memory array using a memory controller. In other cases, a memory controller may be integrated into processor 1620. Processor 1620 may be configured to execute computer-readable instructions stored in a memory to perform various functions (e.g., functions or tasks supporting signaling techniques for bandwidth parts).

Memory 1625 may include RAM and ROM. The memory 1625 may store computer-readable, computer-executable software 1630 including instructions that, when executed, cause the processor to perform various functions described herein. In some cases, the memory 1625 may contain, among other things, a BIOS which may control basic hardware or software operation such as the interaction with peripheral components or devices.

Software 1630 may include code to implement aspects of the present disclosure, including code to support signaling techniques for bandwidth parts. Software 1630 may be stored in a non-transitory computer-readable medium such as system memory or other memory. In some cases, the software 1630 may not be directly executable by the processor but may cause a computer (e.g., when compiled and executed) to perform functions described herein.

Transceiver 1635 may communicate bi-directionally, via one or more antennas, wired, or wireless links as described above. For example, the transceiver 1635 may represent a wireless transceiver and may communicate bi-directionally with another wireless transceiver. The transceiver 1635 may also include a modem to modulate the packets and provide the modulated packets to the antennas for transmission, and to demodulate packets received from the antennas.

In some cases, the wireless device 1605 may include a single antenna 1640. However, in some cases the device 1605 may have more than one antenna 1640, which may be capable of concurrently transmitting or receiving multiple wireless transmissions.

Network communications manager 1645 may manage communications with the core network (e.g., via one or more wired backhaul links). For example, the network communications manager 1645 may manage the transfer of data communications for client devices, such as one or more UEs 115.

Inter-station communications manager 1650 may manage communications with other base station 105, and may include a controller or scheduler for controlling communications with UEs 115 in cooperation with other base stations 105. For example, the inter-station communications manager 1650 may coordinate scheduling for transmissions to UEs 115 for various interference mitigation techniques such as beamforming or joint transmission. In some examples, inter-station communications manager 1650 may provide an X2 interface within an Long Term Evolution (LTE)/LTE-A wireless communication network technology to provide communication between base stations 105.

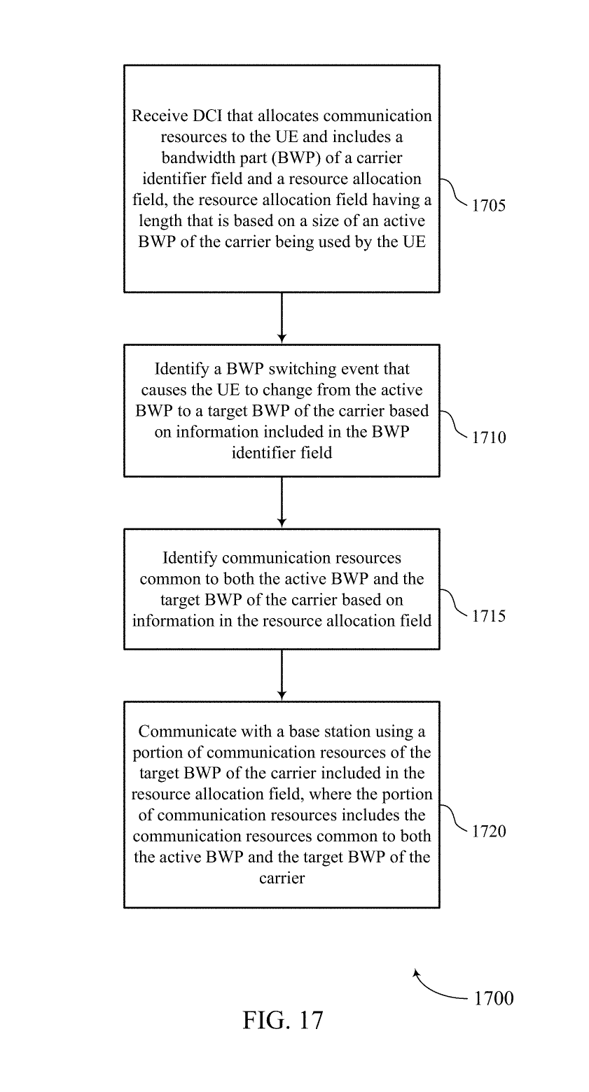

FIG. 17 shows a flowchart illustrating a method 1700 for signaling techniques for bandwidth parts in accordance with aspects of the present disclosure. The operations of method 1700 may be implemented by a UE 115 or its components as described herein. For example, the operations of method 1700 may be performed by a UE bandwidth part manager as described with reference to FIGS. 9 through 12. In some examples, a UE 115 may execute a set of codes to control the functional elements of the device to perform the functions described below. Additionally or alternatively, the UE 115 may perform aspects of the functions described below using special-purpose hardware.

At 1705, the UE 115 may receive downlink control information (DCI) that allocates communication resources to the UE 115 and includes a bandwidth part (BWP) of a carrier identifier field and a resource allocation field, the resource allocation field having a length that is based at least in part on a size of an active BWP of the carrier being used by the UE 115. The operations of 1705 may be performed according to the methods described herein. In certain examples, aspects of the operations of 1705 may be performed by a communications manager as described with reference to FIGS. 9 through 12.

At 1710, the UE 115 may identify a BWP switching event that causes the UE 115 to change from the active BWP to a target BWP of the carrier based at least in part on information included in the BWP identifier field. The operations of 1710 may be performed according to the methods described herein. In certain examples, aspects of the operations of 1710 may be performed by a switching event manager as described with reference to FIGS. 9 through 12.

At 1715, the UE 115 may identify communication resources common to both the active BWP and the target BWP of the carrier based at least in part on information in the resource allocation field. The operations of 1715 may be performed according to the methods described herein. In certain examples, aspects of the operations of 1715 may be performed by a resource manager as described with reference to FIGS. 9 through 12.

At 1720, the UE 115 may communicate with a base station 105 using a portion of communication resources of the target BWP of the carrier included in the resource allocation field, where the portion of communication resources includes the communication resources common to both the active BWP and the target BWP of the carrier. The operations of 1720 may be performed according to the methods described herein. In certain examples, aspects of the operations of 1720 may be performed by a communications manager as described with reference to FIGS. 9 through 12.

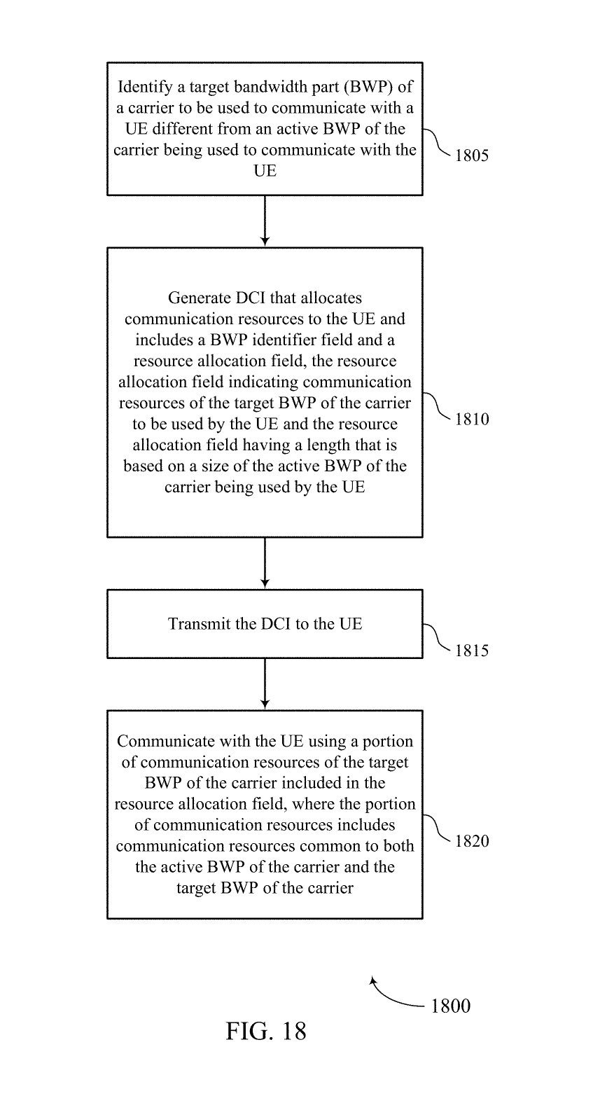

FIG. 18 shows a flowchart illustrating a method 1800 for signaling techniques for bandwidth parts in accordance with aspects of the present disclosure. The operations of method 1800 may be implemented by a base station 105 or its components as described herein. For example, the operations of method 1800 may be performed by a base station bandwidth part manager as described with reference to FIGS. 13 through 16. In some examples, a base station 105 may execute a set of codes to control the functional elements of the device to perform the functions described below. Additionally or alternatively, the base station 105 may perform aspects of the functions described below using special-purpose hardware.

At 1805, the base station 105 may identify a target bandwidth part (BWP) of a carrier to be used to communicate with a user equipment (UE) 115 different from an active BWP of the carrier being used to communicate with the UE 115. The operations of 1805 may be performed according to the methods described herein. In certain examples, aspects of the operations of 1805 may be performed by a resource manager as described with reference to FIGS. 13 through 16.

At 1810, the base station 105 may generate downlink control information (DCI) that allocates communication resources to the UE 115 and includes a BWP identifier field and a resource allocation field, the resource allocation field indicating communication resources of the target BWP of the carrier to be used by the UE 115 and the resource allocation field having a length that is based at least in part on a size of the active BWP of the carrier being used by the UE 115. The operations of 1810 may be performed according to the methods described herein. In certain examples, aspects of the operations of 1810 may be performed by a control information manager as described with reference to FIGS. 13 through 16.

At 1815, the base station 105 may transmit the DCI to the UE 115. The operations of 1815 may be performed according to the methods described herein. In certain examples, aspects of the operations of 1815 may be performed by a communications manager as described with reference to FIGS. 13 through 16.

At 1820, the base station 105 may communicate with the UE 115 using a portion of communication resources of the target BWP of the carrier included in the resource allocation field, where the portion of communication resources includes communication resources common to both the active BWP of the carrier and the target BWP of the carrier. The operations of 1820 may be performed according to the methods described herein. In certain examples, aspects of the operations of 1820 may be performed by a communications manager as described with reference to FIGS. 13 through 16.

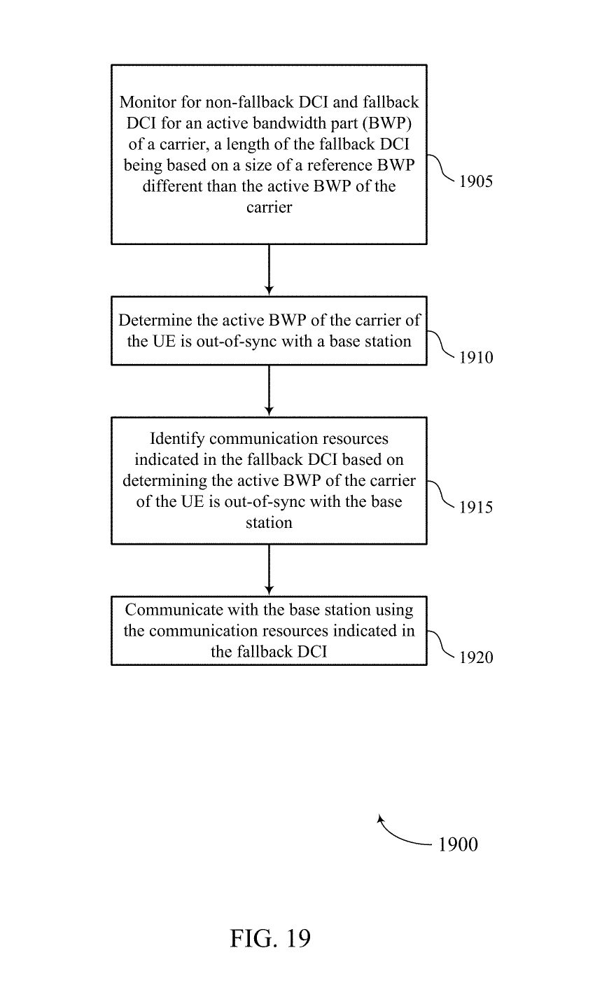

FIG. 19 shows a flowchart illustrating a method 1900 for signaling techniques for bandwidth parts in accordance with aspects of the present disclosure. The operations of method 1900 may be implemented by a UE 115 or its components as described herein. For example, the operations of method 1900 may be performed by a UE bandwidth part manager as described with reference to FIGS. 9 through 12. In some examples, a UE 115 may execute a set of codes to control the functional elements of the device to perform the functions described below. Additionally or alternatively, the UE 115 may perform aspects of the functions described below using special-purpose hardware.

At 1905, the UE 115 may monitor for non-fallback downlink control information (DCI) and fallback DCI for an active bandwidth part (BWP) of a carrier, a length of the fallback DCI being based at least in part on a size of a reference BWP different than the active BWP of the carrier. The operations of 1905 may be performed according to the methods described herein. In certain examples, aspects of the operations of 1905 may be performed by a communications manager as described with reference to FIGS. 9 through 12.

At 1910, the UE 115 may determine the active BWP of the carrier of the UE 115 is out-of-sync with a base station. The operations of 1910 may be performed according to the methods described herein. In certain examples, aspects of the operations of 1910 may be performed by a resource manager as described with reference to FIGS. 9 through 12.

At 1915, the UE 115 may identify communication resources indicated in the fallback DCI based at least in part on determining the active BWP of the carrier of the UE 115 is out-of-sync with the base station. The operations of 1915 may be performed according to the methods described herein. In certain examples, aspects of the operations of 1915 may be performed by a resource manager as described with reference to FIGS. 9 through 12.

At 1920, the UE 115 may communicate with the base station 105 using the communication resources indicated in the fallback DCI. The operations of 1920 may be performed according to the methods described herein. In certain examples, aspects of the operations of 1920 may be performed by a communications manager as described with reference to FIGS. 9 through 12.

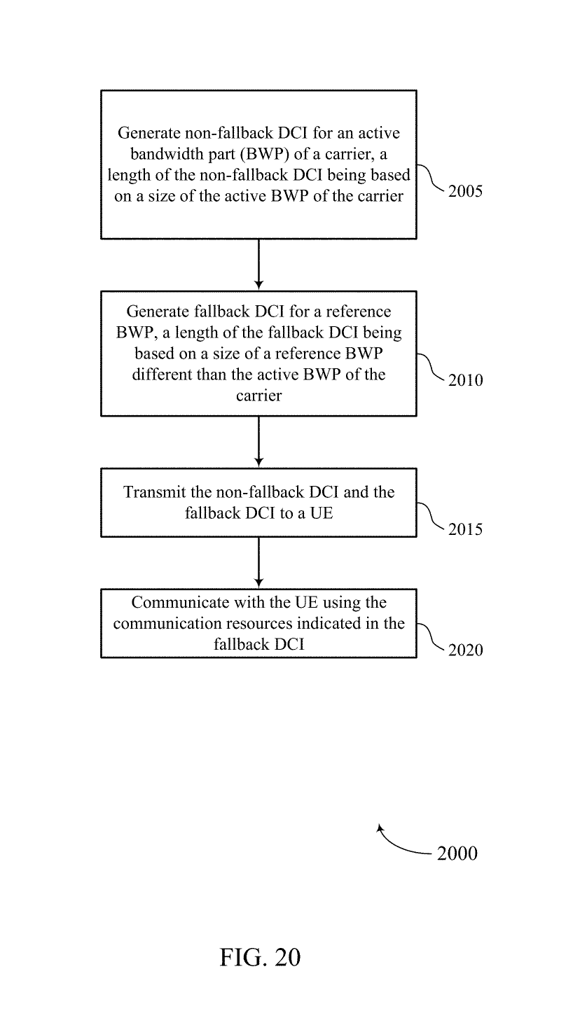

FIG. 20 shows a flowchart illustrating a method 2000 for signaling techniques for bandwidth parts in accordance with aspects of the present disclosure. The operations of method 2000 may be implemented by a base station 105 or its components as described herein. For example, the operations of method 2000 may be performed by a base station bandwidth part manager as described with reference to FIGS. 13 through 16. In some examples, a base station 105 may execute a set of codes to control the functional elements of the device to perform the functions described below. Additionally or alternatively, the base station 105 may perform aspects of the functions described below using special-purpose hardware.

At 2005, the base station 105 may generate non-fallback downlink control information (DCI) for an active bandwidth part (BWP) of a carrier, a length of the non-fallback DCI being based at least in part on a size of the active BWP of the carrier. The operations of 2005 may be performed according to the methods described herein. In certain examples, aspects of the operations of 2005 may be performed by a control information manager as described with reference to FIGS. 13 through 16.

At 2010, the base station 105 may generate fallback DCI for a reference BWP, a length of the fallback DCI being based at least in part on a size of a reference BWP different than the active BWP of the carrier. The operations of 2010 may be performed according to the methods described herein. In certain examples, aspects of the operations of 2010 may be performed by a control information manager as described with reference to FIGS. 13 through 16.

At 2015, the base station 105 may transmit the non-fallback DCI and the fallback DCI to a user equipment (UE) 115. The operations of 2015 may be performed according to the methods described herein. In certain examples, aspects of the operations of 2015 may be performed by a communications manager as described with reference to FIGS. 13 through 16.

At 2020, the base station 105 may communicate with the UE 115 using the communication resources indicated in the fallback DCI. The operations of 2020 may be performed according to the methods described herein. In certain examples, aspects of the operations of 2020 may be performed by a communications manager as described with reference to FIGS. 13 through 16.

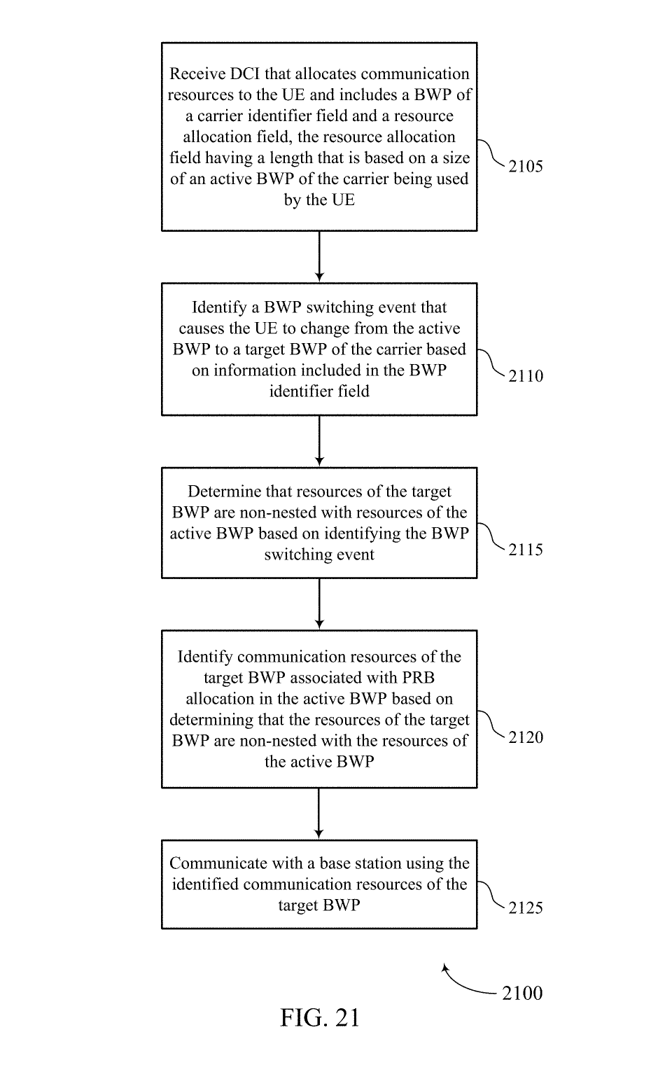

FIG. 21 shows a flowchart illustrating a method 2100 for [title] in accordance with aspects of the present disclosure. The operations of method 2100 may be implemented by a UE 115 or its components as described herein. For example, the operations of method 2100 may be performed by a UE bandwidth part manager as described with reference to FIGS. 9 through 12. In some examples, a UE 115 may execute a set of codes to control the functional elements of the device to perform the functions described below. Additionally or alternatively, the UE 115 may perform aspects of the functions described below using special-purpose hardware.

At 2105, the UE 115 may receive downlink control information (DCI) that allocates communication resources to the UE 115 and includes a bandwidth part (BWP) of a carrier identifier field and a resource allocation field, the resource allocation field having a length that is based at least in part on a size of an active BWP of the carrier being used by the UE 115. The operations of 2105 may be performed according to the methods described herein. In certain examples, aspects of the operations of 2105 may be performed by a communications manager as described with reference to FIGS. 9 through 12.

At 2110, the UE 115 may identify a BWP switching event that causes the UE 115 to change from the active BWP to a target BWP of the carrier based at least in part on information included in the BWP identifier field. The operations of 2110 may be performed according to the methods described herein. In certain examples, aspects of the operations of 2110 may be performed by a switching event manager as described with reference to FIGS. 9 through 12.

At 2115, the UE 115 may determine that resources of the target BWP are non-nested with resources of the active BWP based at least in part on identifying the BWP switching event. The operations of 2115 may be performed according to the methods described herein. In certain examples, aspects of the operations of 2115 may be performed by a switching event manager as described with reference to FIGS. 9 through 12.

At 2120, the UE 115 may identify communication resources of the target BWP associated with a physical resource block (PRB) allocation in the active BWP based at least in part on determining that the resources of the target BWP are non-nested with the resources of the active BWP. The operations of 2120 may be performed according to the methods described herein. In certain examples, aspects of the operations of 2120 may be performed by a resource manager as described with reference to FIGS. 9 through 12.

At 2125, the UE 115 may communicate with a base station 105 using the identified communication resources of the target BWP. The operations of 2125 may be performed according to the methods described herein. In certain examples, aspects of the operations of 2125 may be performed by a communications manager as described with reference to FIGS. 9 through 12.

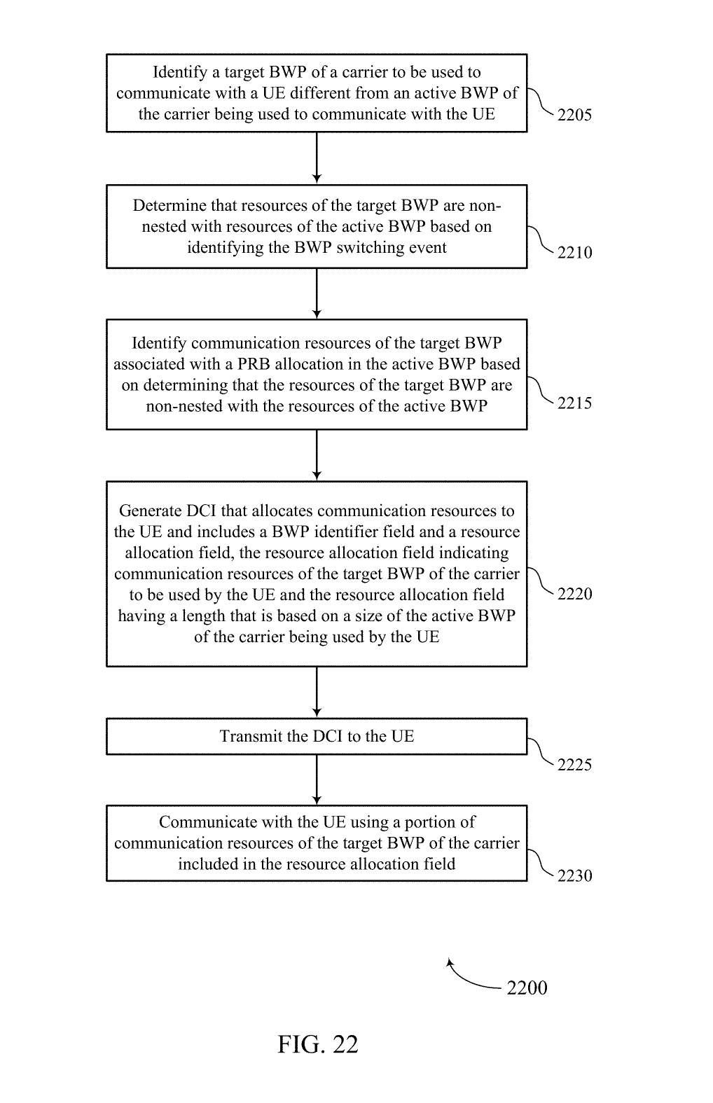

FIG. 22 shows a flowchart illustrating a method 2000 for [title] in accordance with aspects of the present disclosure. The operations of method 2200 may be implemented by a base station 105 or its components as described herein. For example, the operations of method 2200 may be performed by a base station bandwidth part manager as described with reference to FIGS. 13 through 16. In some examples, a base station 105 may execute a set of codes to control the functional elements of the device to perform the functions described below. Additionally or alternatively, the base station 105 may perform aspects of the functions described below using special-purpose hardware.

At 2205, the base station 105 may identify a target bandwidth part (BWP) of a carrier to be used to communicate with a user equipment (UE) 115 different from an active BWP of the carrier being used to communicate with the UE 115. The operations of 2205 may be performed according to the methods described herein. In certain examples, aspects of the operations of 2205 may be performed by a resource manager as described with reference to FIGS. 13 through 16.

At 2210, the base station 105 may determine that resources of the target BWP are non-nested with resources of the active BWP based at least in part on identifying the BWP switching event. The operations of 2210 may be performed according to the methods described herein. In certain examples, aspects of the operations of 2210 may be performed by a resource manager as described with reference to FIGS. 13 through 16.

At 2215, the base station 105 may identify communication resources of the target BWP associated with a physical resource block (PRB) allocation in the active BWP based at least in part on determining that the resources of the target BWP are non-nested with the resources of the active BWP. The operations of 2215 may be performed according to the methods described herein. In certain examples, aspects of the operations of 2215 may be performed by a resource manager as described with reference to FIGS. 13 through 16.

At 2220, the base station 105 may generate downlink control information (DCI) that allocates communication resources to the UE 1151 and includes a BWP identifier field and a resource allocation field, the resource allocation field indicating communication resources of the target BWP of the carrier to be used by the UE 15 and the resource allocation field having a length that is based at least in part on a size of the active BWP of the carrier being used by the UE 115. The operations of 2220 may be performed according to the methods described herein. In certain examples, aspects of the operations of 2220 may be performed by a control information manager as described with reference to FIGS. 13 through 16.

At 2225, the base station 105 may transmit the DCI to the UE 115. The operations of 2225 may be performed according to the methods described herein. In certain examples, aspects of the operations of 2225 may be performed by a communications manager as described with reference to FIGS. 13 through 16.

At 2230, the base station 105 may communicate with the UE 115 using a portion of communication resources of the target BWP of the carrier included in the resource allocation field. The operations of 2230 may be performed according to the methods described herein. In certain examples, aspects of the operations of 2230 may be performed by a communications manager as described with reference to FIGS. 13 through 16.

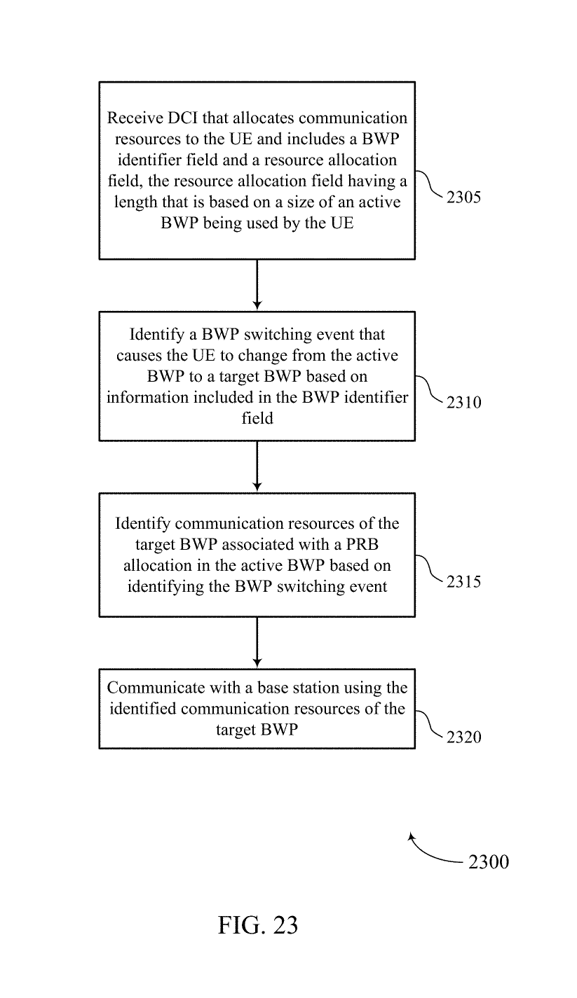

FIG. 23 shows a flowchart illustrating a method 2300 that supports signaling techniques for bandwidth parts in accordance with aspects of the present disclosure. The operations of method 2300 may be implemented by a UE 115 or its components as described herein. For example, the operations of method 2300 may be performed by a bandwidth part manager as described with reference to FIGS. 9 to 12. In some examples, a UE 115 may execute a set of instructions to control the functional elements of the UE 115 to perform the functions described below. Additionally or alternatively, a UE 115 may perform aspects of the functions described below using special-purpose hardware.

At 2305, the UE 115 may receive DCI that allocates communication resources to the UE 115 and includes a BWP identifier field and a resource allocation field, the resource allocation field having a length that is based on a size of an active BWP being used by the UE 115. The operations of 2305 may be performed according to the methods described herein. In some examples, aspects of the operations of 2305 may be performed by a communications manager as described with reference to FIGS. 9 to 12.

At 2310, the UE 115 may identify a BWP switching event that causes the UE 115 to change from the active BWP to a target BWP based on information included in the BWP identifier field. The operations of 2310 may be performed according to the methods described herein. In some examples, aspects of the operations of 2310 may be performed by a switching event manager as described with reference to FIGS. 9 to 12.

At 2315, the UE 115 may identify communication resources of the target BWP associated with a PRB allocation in the active BWP based on identifying the BWP switching event. The operations of 2315 may be performed according to the methods described herein. In some examples, aspects of the operations of 2315 may be performed by a resource manager as described with reference to FIGS. 9 to 12.

At 2320, the UE 115 may communicate with a base station 105 using the identified communication resources of the target BWP. The operations of 2320 may be performed according to the methods described herein. In some examples, aspects of the operations of 2320 may be performed by a communications manager as described with reference to FIGS. 9 to 12.

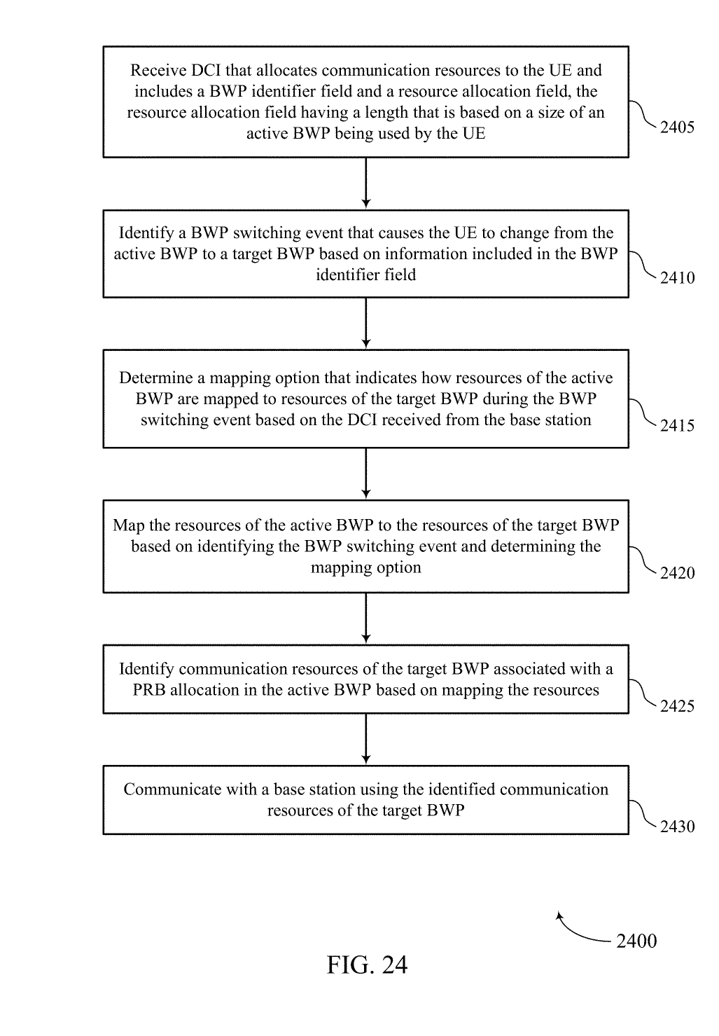

FIG. 24 shows a flowchart illustrating a method 2400 that supports signaling techniques for bandwidth parts in accordance with aspects of the present disclosure. The operations of method 2400 may be implemented by a UE 115 or its components as described herein. For example, the operations of method 2400 may be performed by a bandwidth part manager as described with reference to FIGS. 9 to 12. In some examples, a UE 115 may execute a set of instructions to control the functional elements of the UE to perform the functions described below. Additionally or alternatively, a UE 115 may perform aspects of the functions described below using special-purpose hardware.

At 2405, the UE 115 may receive DCI that allocates communication resources to the UE 115 and includes a BWP identifier field and a resource allocation field, the resource allocation field having a length that is based on a size of an active BWP being used by the UE 115. The operations of 2405 may be performed according to the methods described herein. In some examples, aspects of the operations of 2405 may be performed by a communications manager as described with reference to FIGS. 9 to 12.

At 2410, the UE 115 may identify a BWP switching event that causes the UE 115 to change from the active BWP to a target BWP based on information included in the BWP identifier field. The operations of 2410 may be performed according to the methods described herein. In some examples, aspects of the operations of 2410 may be performed by a switching event manager as described with reference to FIGS. 9 to 12.

At 2415, the UE 15 may determine a mapping option that indicates how resources of the active BWP are mapped to resources of the target BWP during the BWP switching event based on the DCI received from the base station. The operations of 2415 may be performed according to the methods described herein. In some examples, aspects of the operations of 2415 may be performed by a mapping manager as described with reference to FIGS. 9 to 12.

At 2420, the UE 115 may map the resources of the active BWP to the resources of the target BWP based on identifying the BWP switching event and determining the mapping option, where identifying the communication resources of the target BWP associated with the PRB allocation is based on mapping the resources. The operations of 2420 may be performed according to the methods described herein. In some examples, aspects of the operations of 2420 may be performed by a mapping manager as described with reference to FIGS. 9 to 12.

At 2425, the UE 115 may identify communication resources of the target BWP associated with a PRB allocation in the active BWP based on mapping the resources. The operations of 2425 may be performed according to the methods described herein. In some examples, aspects of the operations of 2425 may be performed by a resource manager as described with reference to FIGS. 9 to 12.

At 2430, the UE 115 may communicate with a base station 105 using the identified communication resources of the target BWP. The operations of 2430 may be performed according to the methods described herein. In some examples, aspects of the operations of 2430 may be performed by a communications manager as described with reference to FIGS. 9 to 12.

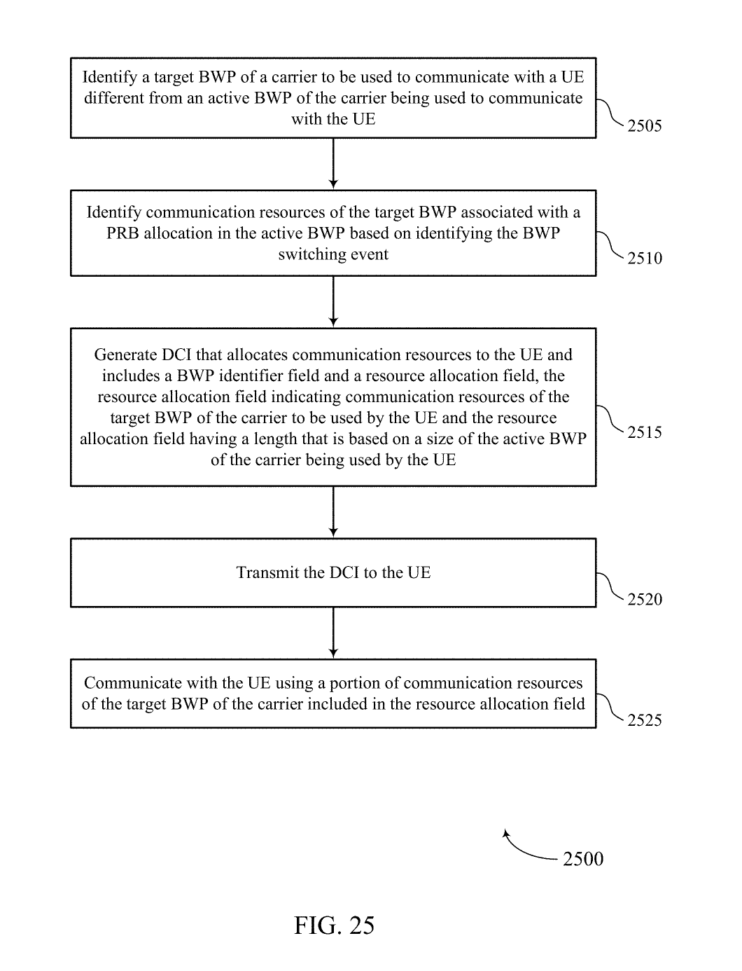

FIG. 25 shows a flowchart illustrating a method 2500 that supports signaling techniques for bandwidth parts in accordance with aspects of the present disclosure. The operations of method 2500 may be implemented by a base station 105 or its components as described herein. For example, the operations of method 2500 may be performed by a bandwidth part manager as described with reference to FIGS. 13 to 16. In some examples, a base station 105 may execute a set of instructions to control the functional elements of the base station 105 to perform the functions described below. Additionally or alternatively, a base station 105 may perform aspects of the functions described below using special-purpose hardware.

At 2505, the base station 105 may identify a target BWP of a carrier to be used to communicate with a UE 115 different from an active BWP of the carrier being used to communicate with the UE 115. The operations of 2505 may be performed according to the methods described herein. In some examples, aspects of the operations of 2505 may be performed by a resource manager as described with reference to FIGS. 13 to 16.

At 2510, the base station 105 may identify communication resources of the target BWP associated with a PRB allocation in the active BWP based on identifying the BWP switching event. The operations of 2510 may be performed according to the methods described herein. In some examples, aspects of the operations of 2510 may be performed by a resource manager as described with reference to FIGS. 13 to 16.

At 2515, the base station 105 may generate DCI that allocates communication resources to the UE 115 and includes a BWP identifier field and a resource allocation field, the resource allocation field indicating communication resources of the target BWP of the carrier to be used by the UE 115 and the resource allocation field having a length that is based on a size of the active BWP of the carrier being used by the UE 115. The operations of 2515 may be performed according to the methods described herein. In some examples, aspects of the operations of 2515 may be performed by a control information manager as described with reference to FIGS. 13 to 16.

At 2520, the base station 105 may transmit the DCI to the UE 115. The operations of 2520 may be performed according to the methods described herein. In some examples, aspects of the operations of 2520 may be performed by a communications manager as described with reference to FIGS. 13 to 16.

At 2525, the base station 105 may communicate with the UE 115 using a portion of communication resources of the target BWP of the carrier included in the resource allocation field. The operations of 2525 may be performed according to the methods described herein. In some examples, aspects of the operations of 2525 may be performed by a communications manager as described with reference to FIGS. 13 to 16.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
receiving downlink control information (DCI) that allocates communication resources to the UE and includes a bandwidth part (BWP) identifier field and a resource allocation field, the resource allocation field having a length that is based at least in part on a size of an active BWP being used by the UE;
identifying a BWP switching event that causes the UE to change from the active BWP to a target BWP based at least in part on information included in the BWP identifier field;
identifying communication resources of the target BWP associated with a physical resource block (PRB) allocation in the active BWP based at least in part on identifying the BWP switching event; and
communicating with a base station using the identified communication resources of the target BWP.

2. The method of claim 1, further comprising:
identifying a reference location of the PRB allocation in the active BWP, wherein identifying the communication resources of the target BWP associated with the PRB allocation is based at least in part on identifying the reference location.

3. The method of claim 2, wherein the reference location is a lowest frequency resource of the active BWP.

4. The method of claim 1, further comprising:
mapping resources of the active BWP to resources of the target BWP based at least in part on identifying the BWP switching event, wherein identifying the communication resources of the target BWP associated with the PRB allocation is based at least in part on mapping the resources.

5. The method of claim 4, further comprising:
determining a mapping option that indicates how the resources of the active BWP are mapped to the resources of the target BWP during the BWP switching event based at least in part on the DCI received from the base station, wherein mapping the resources is based at least in part on determining the mapping option.

6. The method of claim 5, wherein the DCI includes a mapping field indicating the mapping option.

7. The method of claim 1, further comprising:
determining whether a frequency-domain resource allocation field of the target BWP is larger or smaller than a frequency-domain resource allocation field of the active BWP, wherein identifying the communication resources of the target BWP associated with the PRB allocation is based at least in part on determining whether the frequency-domain resource allocation field of the target BWP is larger or smaller than the frequency-domain resource allocation field of the active BWP.

8. The method of claim 7, further comprising:
identifying information based at least in part on a least significant bit of the DCI based at least in part on determining the frequency-domain resource allocation field of the target BWP is smaller than the frequency-domain resource allocation field of the active BWP.

9. The method of claim 7, further comprising:
populating the frequency-domain resource allocation field of the active BWP with a zero padding based at least in part on determining the frequency-domain resource allocation field of the target BWP is larger than the frequency-domain resource allocation field of the active BWP.

10. The method of claim 1, further comprising:
determining that the BWP identifier field of the DCI identifies a BWP different than the active BWP being used by the UE to communicate, wherein identifying the BWP switching event is based at least in part on determining that the BWP identifier field of the DCI identifies the BWP different than the active BWP.

11. The method of claim 1, wherein the length of the resource allocation field for the active BWP is smaller than a second length of a second resource allocation field for the target BWP.

12. The method of claim 1, wherein the length of the resource allocation field for the active BWP is insufficient to allocate all of the communication resources available in the target BWP of the carrier.

13. The method of claim 1, further comprising:
receiving a second DCI that allocates resources for the UE using the target BWP based at least in part on communicating with the base station using a portion of the communication resources of the target BWP, the second DCI including a second resource allocation field having a second length that is based at least in part on a size of the target BWP being used by the UE, the second length being greater than the length of the resource allocation field in the DCI; and
communicating with the base station using all communication resources of the target BWP included in the resource allocation field of the second DCI.

14. The method of claim 1, wherein the DCI is a non-fallback DCI.

15. A method for wireless communication at a base station, comprising: identifying a target bandwidth part (BWP) to be used to communicate with a user equipment (UE) different from an active BWP being used to communicate with the UE;
identifying communication resources of the target BWP associated with a physical resource block (PRB) allocation in the active BWP based at least in part on identifying a BWP switching event;
generating downlink control information (DCI) that allocates communication resources to the UE and includes a BWP identifier field and a resource allocation field, the resource allocation field indicating communication resources of the target BWP to be used by the UE and the resource allocation field having a length that is based at least in part on a size of the active BWP being used by the UE;
transmitting the DCI to the UE; and
communicating with the UE using a portion of communication resources of the target BWP included in the resource allocation field.

16. The method of claim 15, further comprising:
identifying a reference location of the PRB allocation in the active BWP, wherein identifying the communication resources of the target BWP associated with the PRB allocation is based at least in part on identifying the reference location.

17. The method of claim 16, wherein the reference location is a lowest frequency of the active BWP.

18. The method of claim 15, further comprising:
mapping the resources of the active BWP to the resources of the target BWP based at least in part on identifying the BWP switching event, wherein identifying the communication resources of the target BWP associated with the PRB allocation is based at least in part on mapping the resources.

19. The method of claim 18, further comprising:
determining a mapping option that indicates how resources of the active BWP are mapped to resources of the target BWP during the BWP switching event based at least in part on the DCI received from the base station, wherein mapping the resources is based at least in part on determining the mapping option.

20. The method of claim 19, wherein the DCI includes a mapping field indicating the mapping option.

21. The method of claim 15, further comprising:
configuring the UE to determine whether a frequency-domain resource allocation field of the target BWP is larger or smaller than a frequency-domain resource allocation field of the active BWP, wherein identifying the communication resources of the target BWP associated with the PRB allocation is based at least in part on determining whether the frequency-domain resource allocation field of the target BWP is larger or smaller than the frequency-domain resource allocation field of the active BWP.

22. The method of claim 21, further comprising:
configuring the UE to identify information based at least in part on a least significant bit of the DCI based at least in part on determining the frequency-domain resource allocation field of the target BWP is smaller than the frequency-domain resource allocation field of the active BWP.

23. The method of claim 21, further comprising:
configuring the UE to populate the frequency-domain resource allocation field of the active BWP with a zero padding based at least in part on determining the frequency-domain resource allocation field of the target BWP is larger than the frequency-domain resource allocation field of the active BWP.

24. The method of claim 15, wherein the length of the resource allocation field for the active BWP is smaller than a second length of a second resource allocation field for the target BWP.

25. The method of claim 15, wherein the DCI is a non-fallback DCI.

26. A method for wireless communication at a user equipment (UE), comprising:
monitoring for non-fallback downlink control information (DCI) and fallback DCI for an active bandwidth part (BWP) of a carrier, a length of the fallback DCI being based at least in part on a size of a reference BWP different than the active BWP of the carrier;
determining the active BWP of the carrier of the UE is out-of-sync with a base station;
identifying communication resources indicated in the fallback DCI based at least in part on determining the active BWP of the carrier of the UE is out-of-sync with the base station; and
communicating with the base station using the communication resources indicated in the fallback DCI.

27. The method of claim 26, further comprising:
determining that the non-fallback DCI failed to be successfully decoded, wherein determining the active BWP of the carrier of the UE is out-of-sync with the base station is based at least in part on determining that the non-fallback DCI failed to be successfully decoded.

28. The method of claim 26, further comprising:
identifying that a control search space (CSS) of the active BWP of the carrier is identical to a CSS of the reference BWP, wherein identifying the communication resources indicated in the fallback DCI is based at least in part on identifying that the CSS of the active BWP of the carrier is identical to the CSS of the reference BWP.

29. The method of claim 26, further comprising:
determining that a first frequency range of the reference BWP is a subset of a second frequency range of the active BWP of the carrier, wherein identifying the communication resources indicated in the fallback DCI is based at least in part on determining that the first frequency range of the reference BWP is the subset of the second frequency range of the active BWP of the carrier.

30. The method of claim 26, wherein the length of the fallback DCI is independent of a size of the active BWP of the carrier.

31. A method for wireless communication at a base station, comprising:
generating non-fallback downlink control information (DCI) for an active bandwidth part (BWP) of a carrier, a length of the non-fallback DCI being based at least in part on a size of the active BWP of the carrier;
generating fallback DCI for a reference BWP, a length of the fallback DCI being based at least in part on a size of a reference BWP different than the active BWP of the carrier;
transmitting the non-fallback DCI and the fallback DCI to a user equipment (UE); and
communicating with the UE using the communication resources indicated in the fallback DCI.

32. The method of claim 31, further comprising:
determining that the non-fallback DCI failed to be successfully decoded by the UE based at least in part on communicating with the UE using the communication resources indicated in the fallback DCI.

33. The method of claim 31, further comprising:
identifying that a control search space (CSS) of the active BWP of the carrier is identical to a CSS of the reference BWP, wherein generating the fallback DCI is based at least in part on identifying that the CSS of the active BWP of the carrier is identical to the CSS of the reference BWP.

34. The method of claim 31, further comprising:
determining that a first frequency range of the reference BWP is a subset of a second frequency range of the active BWP of the carrier, wherein generating the fallback DCI is based at least in part on determining that the first frequency range of the reference BWP is the subset of the second frequency range of the active BWP of the carrier.

35. The method of claim 31, wherein the length of the fallback DCI is independent of the size of the active BWP of the carrier.

36. An apparatus for wireless communication at a user equipment (UE), comprising:
a processor,
memory in electronic communication with the processor; and
instructions stored in the memory and executable by the processor to cause the apparatus to:
receive downlink control information (DCI) that allocates communication resources to the UE and includes a bandwidth part (BWP) identifier field and a resource allocation field, the resource allocation field having a length that is based at least in part on a size of an active BWP being used by the UE;
identify a BWP switching event that causes the UE to change from the active BWP to a target BWP based at least in part on information included in the BWP identifier field;
identify communication resources of the target BWP associated with a physical resource block (PRB) allocation in the active BWP based at least in part on identifying the BWP switching event; and
communicate with a base station using the identified communication resources of the target BWP.

37. An apparatus for wireless communication at a base station, comprising:
a processor,
memory in electronic communication with the processor; and
instructions stored in the memory and executable by the processor to cause the apparatus to:
identify a target bandwidth part (BWP) to be used to communicate with a user equipment (UE) different from an active BWP being used to communicate with the UE;
identify communication resources of the target BWP associated with a physical resource block (PRB) allocation in the active BWP based at least in part on identifying a BWP switching event;
generate downlink control information (DCI) that allocates communication resources to the UE and includes a BWP identifier field and a resource allocation field, the resource allocation field indicating communication resources of the target BWP to be used by the UE and the resource allocation field having a length that is based at least in part on a size of the active BWP being used by the UE;
transmit the DCI to the UE; and
communicate with the UE using a portion of communication resources of the target BWP of the carrier included in the resource allocation field.

38. An apparatus for wireless communication at a user equipment (UE), comprising:
a processor,
memory in electronic communication with the processor; and
instructions stored in the memory and executable by the processor to cause the apparatus to:
monitor for non-fallback downlink control information (DCI) and fallback DCI for an active bandwidth part (BWP) of a carrier, a length of the fallback DCI being based at least in part on a size of a reference BWP different than the active BWP of the carrier;
determine the active BWP of the carrier of the UE is out-of-sync with a base station;
identify communication resources indicated in the fallback DCI based at least in part on the determining the active BWP of the carrier of the UE is out-of-sync with the base station; and
communicate with the base station using the communication resources indicated in the fallback DCI.

39. An apparatus for wireless communication at a base station, comprising:
a processor,
memory in electronic communication with the processor; and
instructions stored in the memory and executable by the processor to cause the apparatus to:
generate non-fallback downlink control information (DCI) for an active bandwidth part (BWP) of a carrier, a length of the non-fallback DCI being based at least in part on a size of the active BWP of the carrier;
generate fallback DCI for a reference BWP, a length of the fallback DCI being based at least in part on a size of a reference BWP different than the active BWP of the carrier;
transmit the non-fallback DCI and the fallback DCI to a user equipment (UE); and
communicate with the UE using the communication resources indicated in the fallback DCI.
